(19) United States
(12) Patent Application Publication
(10) Pub. No.: US 2023/0107089 A1
(43) Pub. Date: Apr. 6, 2023

(54) PACKAGING CONTAINER, FILLING METHOD OF CONTENTS FOR PACKAGING CONTAINER, AND MANUFACTURING METHOD FOR PACKAGING CONTAINER

(71) Applicant: TOPPAN PRINTING CO., LTD., Tokyo (JP)

(72) Inventor: Noriyuki SASAKI, Tokyo (JP)

(21) Appl. No.: 18/073,499

(22) Filed: Dec. 1, 2022

Related U.S. Application Data
(62) Division of application No. 16/413,096, filed on May 15, 2019, now abandoned.

(30) Foreign Application Priority Data
May 18, 2018 (JP) 2018-096290
Jun. 25, 2018 (JP) 2018-119836
Jun. 25, 2018 (JP) 2018-119838
Aug. 16, 2018 (JP) 2018-153129

(51) Int. Cl. B65D 5/24; B65D 5/32

(52) U.S. Cl. CPC B65D 5/24; B65D 5/32; B31B 2105/00

(57) ABSTRACT

A packaging container includes a first portion and a second portion that are placed on each other. Each of the first portion and the second portion has a projection polygonal surface having a projection polygonal shape, side portion polygonal surfaces extending from respective sides of the projection polygonal surface, a plurality of to-be-folded surfaces provided between the respective adjacent side portion polygonal surfaces, and a peripheral portion extending over an entirety of an outer edge. The first portion and the second portion are connected to each other at the peripheral portions by a side seal portion obtained by sealing the peripheral portions to each other, or by a connection portion obtained by folding the sheet material, and have air-tightness except for an opening.

### CROSS-REFERENCE TO RELATED APPLICATION

This application is a division of U.S. patent application Ser. No. 16/413,096, filed May 15, 2019, which claims priority to Japanese Application Nos: JP 2018-096290 filed on May 18, 2018, JP 2018-119836 filed on Jun. 25, 2018, JP 2018-119838 filed on Jun. 25, 2018, and JP 2018-153129 filed Aug. 16, 2018, the contents of all of which are hereby incorporated by reference in their entireties for all purposes.

### BACKGROUND OF THE INVENTION

### Field of the Invention

The present invention relates to a packaging container, a filling method of contents for a packaging container, and a manufacturing method for a packaging container.

### Description of the Background Art

A packaging container formed by bending a sheet material into a box shape and overlaying and sealing end portions of the sheet material has been known.

For example, Patent Literature 1 (Japanese Laid-Open Patent Publication No. H9-290822) discloses a packaging container (liquid packaging paper container) in which a peelable pull tab is provided at a side seal portion of a container body that is formed by using a sheet material having paper as a base material, and the pull tab is peelably provided via a peeling layer composed of an easy-to-peel tape-like film. The packaging container can be broken down by, as a trigger, pulling the pull tab to peel the side seal portion or pulling a pull tab, which is provided to a side plate, to tear the side plate.

The packaging container of Patent Literature 1 is easily broken down upon disposal, and thus is useful for reduction in volume of garbage. However, the packaging container that has been broken down cannot be assembled and used again.

### SUMMARY OF THE INVENTION

The present invention has been made in view of such a problem, and an object of the present invention is to provide a packaging container that can be transformed between a box state and a flat state and that can be reused by returning the packaging container to the box state even after being once flattened into the flat state.

An aspect of the present invention for solving the above problem is a packaging container formed from a sheet material and transformable between a box state and a flat state, the packaging container comprising a first portion and a second portion that are placed on each other in the flat state, wherein: an opening is formed in the first portion; each of the first portion and the second portion has a projection polygonal surface having a projection polygonal shape, side portion polygonal surfaces extending from respective sides of the projection polygonal surface, a plurality of to-be-folded surfaces provided between the respective adjacent side portion polygonal surfaces, and a peripheral portion extending over an entirety of an outer edge; the first portion and the second portion are connected to each other at the peripheral portions by a side seal portion obtained by sealing the peripheral portions to each other, or by a connection portion obtained by folding the sheet material, and have air-tightness except for the opening; in the flat state, by bending the sheet material at the peripheral portions or further unfolding the sheet material at the connection portion, a cavity is formed between the first portion and the second portion, and an upper surface that is the projection polygonal surface of the first portion including the opening, a lower surface that is the projection polygonal surface of the second portion and that opposes the upper surface, a plurality of side surfaces formed by the side portion polygonal surfaces, and folded pieces obtained by folding the to-be-folded surfaces and the peripheral portions are formed, and the respective folded pieces are overlaid on and along the side surfaces in a predetermined direction, whereby the packaging container can be transformed into the box state; and in the box state, the folded pieces are separated from the side surfaces, the cavity between the first portion and the second portion is eliminated by unfolding the sheet material at the peripheral portions or further folding the sheet material at the unfolded connection portion, and the first portion and the second portion are overlaid on each other, whereby the packaging container can be transformed into the flat state.

According to the present invention, it is possible to provide a packaging container that can be transformed between a box state and a flat state and that can be reused by returning the packaging container to the box state even after being once flattened into the flat state.

### BRIEF DESCRIPTION OF THE DRAWINGS

FIG. 1 is a perspective view of a packaging container in a box state according to a first embodiment of the present invention;

FIG. 2 shows perspective views of the packaging container in a flat state according to the first embodiment of the present invention;

FIG. 3 is a plan view of a blank for the packaging container according to the first embodiment of the present invention;

FIG. 4 illustrates a state of transformation of the packaging container according to the first embodiment of the present invention;

FIG. 5 shows cross-sectional views of ruled lines of the packaging container according to the first embodiment of the present invention;

FIG. 6 illustrates a state of transformation according to a modification of the packaging container;

FIG. 7 shows plan views of packaging containers according to modifications of the present invention;

FIG. 8 illustrates a method for filling contents into the packaging container according to the embodiment of the present invention;

FIG. 9 shows a perspective view and a side view showing a box state of a packaging container according to a second embodiment of the present invention;

FIG. 10 shows perspective views showing a flat state of the packaging container according to the second embodiment of the present invention;

FIG. 11 shows plan views of a blank for the packaging container according to the second embodiment of the present invention;

FIG. 12 is a perspective view showing a box state of a packaging container according to a comparative embodiment;

FIG. 13 is a plan view for explaining the length of a folding ruled line;

FIG. 14 illustrates a transformation procedure for the packaging container according to the second embodiment of the present invention;

FIG. 15 is a plan view showing a modification of the blank;

FIG. 16 is an explanatory perspective view showing a packaging container according to a third embodiment of the present invention;

FIG. 17 is an explanatory perspective view showing another embodiment of the packaging container according to the third embodiment of the present invention;

FIG. 18 is a schematic plan view showing a blank for the packaging container shown in FIG. 16;

FIG. 19 is a schematic plan view showing a blank for the packaging container shown in FIG. 17;

FIG. 20 is a schematic cross-sectional view showing an example of the layer configuration of a laminate used in the packaging container according to the third embodiment of the present invention;

FIG. 21 is an explanatory perspective view showing still another embodiment of the packaging container according to the third embodiment of the present invention;

FIG. 22 is an explanatory perspective view showing still another embodiment of the packaging container according to the third embodiment of the present invention;

FIG. 23 is an explanatory perspective view showing a packaging container according to a fourth embodiment of the present invention;

FIG. 24 is an explanatory perspective view showing another embodiment of the packaging container according to the fourth embodiment of the present invention;

FIG. 25 is a schematic plan view showing a blank for the packaging container shown in FIG. 23;

FIG. 26 is a schematic plan view showing a blank for the packaging container shown in FIG. 24;

FIG. 27 is a schematic cross-sectional view showing an example of the layer configuration of a laminate used in the packaging container according to the fourth embodiment of the present invention;

FIG. 28 is an explanatory perspective view showing another embodiment of the packaging container according to the fourth embodiment of the present invention;

FIG. 29 is a plan view of a top-side sheet of a packaging container according to a fifth embodiment of the present invention

FIG. 30 is a plan view of a bottom-side sheet of the packaging container according to the fifth embodiment of the present invention;

FIG. 31 is a plan view of the packaging container in a flat state according to the fifth embodiment of the present invention;

FIG. 32 is a perspective view of the packaging container in a box state according to the fifth embodiment of the present invention;

FIG. 33 is a plan view according to a first modification of the packaging container according to the fifth embodiment of the present invention in the case where both the top-side sheet and the bottom-side sheet are formed by one sheet;

FIG. 34 is a plan view of a top-side sheet of a second modification of the packaging container according to the fifth embodiment of the present invention;

FIG. 35 is a plan view of a bottom-side sheet of the second modification of the packaging container according to the fifth embodiment of the present invention;

FIG. 36 is a perspective view of the second modification of the packaging container in a box state according to the fifth embodiment of the present invention;

FIG. 37 is a plan view of a top-side sheet of a third modification of the packaging container according to the fifth embodiment of the present invention;

FIG. 38 is a plan view of a bottom-side sheet of the third modification of the packaging container according to the fifth embodiment of the present invention;

FIG. 39 is a perspective view of the third modification of the packaging container in a box state according to the fifth embodiment of the present invention;

FIG. 40 is a plan view of a top-side sheet of a packaging container according to a sixth embodiment of the present invention;

FIG. 41 is a plan view of a bottom-side sheet of the packaging container according to the sixth embodiment of the present invention;

FIG. 42 is a plan view of the packaging container in a flat state according to the sixth embodiment of the present invention;

FIG. 43 is a perspective view of the packaging container in a box state according to the sixth embodiment of the present invention;

FIG. 44 is a plan view according to a first modification of the packaging container according to the sixth embodiment of the present invention in the case where both the top-side sheet and the bottom-side sheet are formed by one sheet;

FIG. 45 is a plan view of a top-side sheet of a second modification of the packaging container according to the sixth embodiment of the present invention;

FIG. 46 is a plan view of a bottom-side sheet of the second modification of the packaging container according to the sixth embodiment of the present invention;

FIG. 47 is a perspective view of the second modification of the packaging container in a box state according to the sixth embodiment of the present invention;

FIG. 48 is a plan view of a top-side sheet of a third modification of the packaging container according to the sixth embodiment of the present invention;

FIG. 49 is a plan view of a bottom-side sheet of the third modification of the packaging container according to the sixth embodiment of the present invention;

FIG. 50 is a perspective view of the third modification of the packaging container in a box state according to the sixth embodiment of the present invention;

FIG. 51 is a perspective view of a spout that can be used in a production method of the present invention;

FIG. 52 is an explanatory perspective view for a spout-equipped first portion production step of the production method of the present invention; and

FIG. 53 is an explanatory perspective view for a fixing step of the production method of the present invention.

### DETAILED DESCRIPTION OF THE INVENTION

Packaging containers, filling methods of contents for the packaging containers, and manufacturing methods for the packaging containers, according to embodiments of the present invention, will be described with reference to the drawings. In addition, in the following description, for the sake of convenience, the up-down direction in a state where a packaging container is erected in a box state is referred to as an up-down direction.

### First Embodiment

A packaging container 1100 according to a first embodiment of the present invention is a container that is formed by overlaying and sealing end portions of a blank obtained by cutting a sheet material into a predetermined shape and that is transformable between a box state and a flat state.

(Box State)

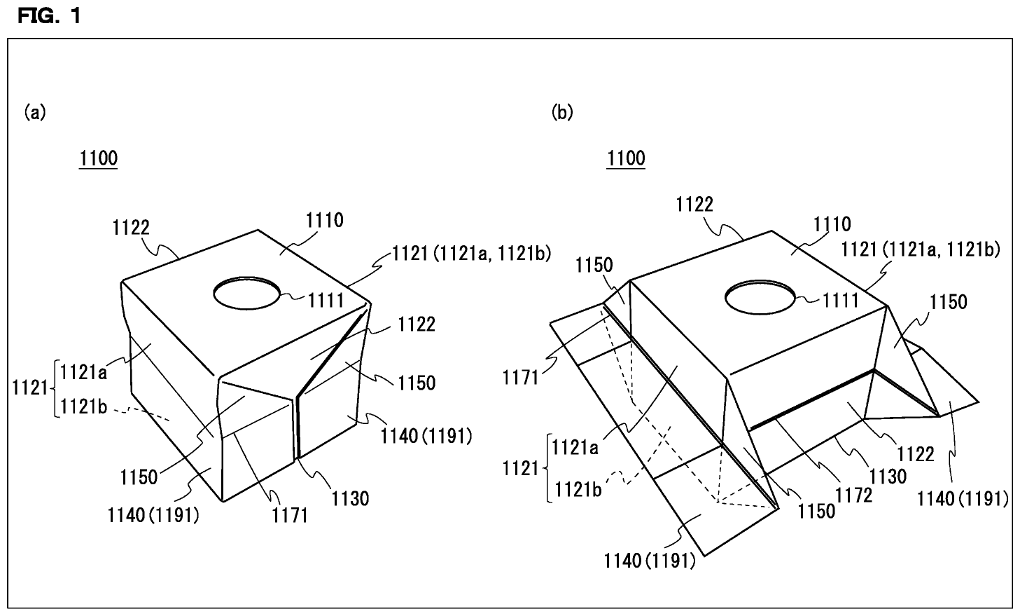

Part (a) of FIG. 1 shows a perspective view of the packaging container 1100 that is erected in the box state. In addition, for clarifying the shape of the packaging container 1100, part (b) of FIG. 1 shows a perspective view of the packaging container 1100 before later-described side seal portions 1140 are bent along a side surface 1120 composed of a pair of opposing first side surfaces 1121 and a pair of opposing second side surfaces 1122.

As shown in part (a) of FIG. 1 and part (b) of FIG. 1, the packaging container 1100 that is in the box state forms a cavity (storage space) by an upper surface 1110 having an opening 1111 formed therein, a lower surface 1130, the pair of opposing first side surfaces 1121, and the pair of opposing second side surfaces 1122. As described later, the packaging container 1100 may be provided with a spout 1112 attached to the opening 1111.

As shown in part (b) of FIG. 1, each first side surface 1121 is formed by two surfaces, that is, an upper first side surface 1121a connected to the upper surface 1110, and a lower first side surface 1121b connected to the lower surface 1130. The heights of the upper first side surface 1121a and the lower first side surface 1121b, which form the first side surfaces 1121, are not particularly limited, but are each suitably not less than 10 mm and not greater than 800 mm. In addition, the heights of the second side surfaces 1122 are not particularly limited, but are each suitably not less than 20 mm and not greater than 800 mm.

Bend pieces 1150 are connected to both side ends of the first side surfaces 1121 and the second side surfaces 1122, respectively, in a state of being bent in a triangular shape such that the bend pieces 1150 can be bent at the boundaries between the bend pieces 1150 and the first side surfaces 1121 and the second side surfaces 1122. The surfaces at the first side surface 1121 side of the bend pieces 1150 are formed so as to be divided into surfaces connected to both side ends of the upper first side surfaces 1121a and surfaces connected to both side ends of the lower first side surfaces 1121b.

The side seal portions 1140 having a predetermined width and formed by sealing the end portions of the sheet material are connected to the centers in the up-down direction of the first side surfaces 1121 and the bend pieces 1150, which are connected to both side ends of the first side surfaces 1121, such that the side seal portions 1140 can be bent at the boundaries between the side seal portions 1140 and the first side surfaces 1121 and the bend pieces 1150.

More specifically, the side seal portions 1140 are formed by sealing, to each other, first seal margins 1191 that have a predetermined width and that extend from the lower ends of the upper first side surfaces 1121a and the bend pieces 1150 connected to both side ends of the upper first side surfaces 1121a and from the upper ends of the lower first side surfaces 1121b and the bend pieces 1150 connected to both side ends of the lower first side surface 1121b, respectively.

A linear first ruled line 1171 is formed on the sheet material between each side seal portion 1140 and each first side surface 1121 and the bend pieces 1150 at both side ends of the first side surface 1121. In addition, a linear second ruled line 1172 is formed on the sheet material at the centers in the up-down direction of each second side surface 1122 and the bend pieces 1150 at both side ends of the second side surface 1122. If it is possible to bend the sheet material at appropriate portions, the first ruled line 1171 and the second ruled line 1172 do not have to be provided.

As shown in part (a) of FIG. 1, in the packaging container 1100 in the box state, the side seal portions 1140 are bent along the first side surfaces 1121 and the second side surfaces 1122 by bending the side seal portions 1140 along the first ruled lines 1171 toward the first side surfaces 1121 and then bending the bend pieces 1150 along the second side surfaces 1122.

(Flat State)

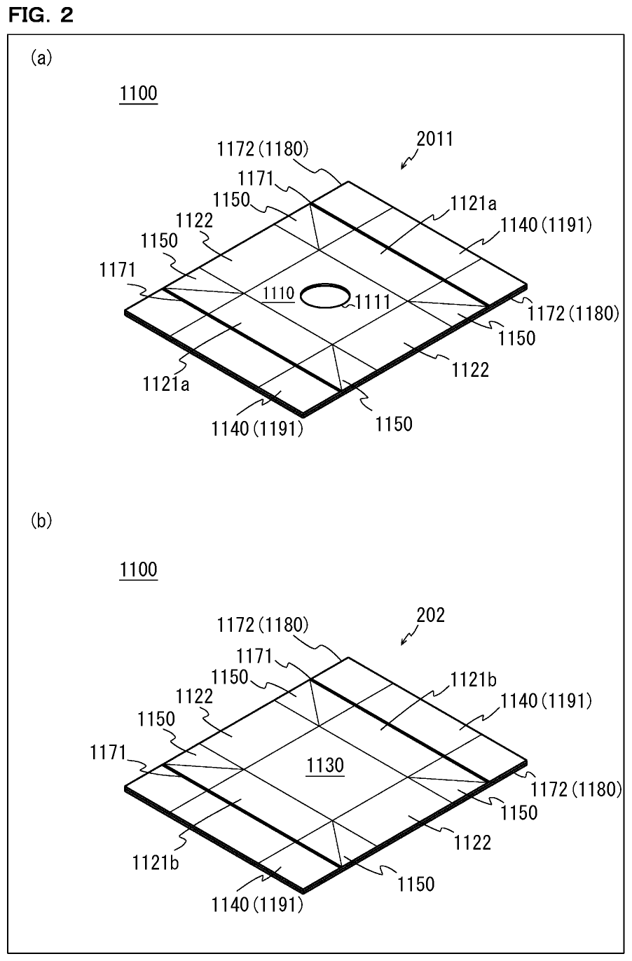

FIG. 2 shows perspective views of the packaging container 1100 that is in the flat state. Part (a) of FIG. 2 is a perspective view showing a state where the upper surface 1110 of the packaging container 1100 that is in the flat state is located at the upper side. Part (b) of FIG. 2 is a perspective view showing a state where the lower surface 1130 of the packaging container 1100 that is in the flat state is located at the upper side.

As shown in FIG. 2, the packaging container 1100 that in the flat state is composed of a rectangular first portion 1201 and a rectangular second portion 1202 that are placed on each other.

The first portion 1201 includes the upper surface 1110 (projection polygonal surface), a pair of the upper first side surfaces 1121a (side portion polygonal surfaces), portions (side portion polygonal surfaces) of the pair of second side surfaces 1122 above the second ruled line 1172, portions of the bend pieces 1150 above the first ruled lines 1171 and the second ruled lines 1172, and the upper surfaces of the first seal margins 1191, which form the side seal portions 1140. These portions each have a rectangular shape as shown in FIG. 2.

In addition, the second portion 1202 includes the lower surface 1130 (projection polygonal surface), a pair of the lower first side surfaces 1121b (side portion polygonal surfaces), portions (side portion polygonal surfaces) of the pair of second side surfaces 1122 below the second ruled lines 1172, portions of the bend pieces 1150 below the first ruled lines 1171 and the second ruled lines 1172, and the lower surfaces of the first seal margins 1191, which form the side seal portions 1140. These portions each have a rectangular shape as shown in FIG. 2.

In each of the first portion 1201 and the second portion 1202, the side seal portions 1140 each obtained by sealing sheet materials to each other are located at opposing edges of the four edges. The first ruled lines 1171 are located on the inner sheet materials of the side seal portions 1140. In addition, folded portions 1180 are formed along the linear second ruled lines 1172 at the other two edges of each of the first portion 1201 and the second portion 1202 by folding the sheet material. The packaging container 1100 formed as described above has air-tightness except for the opening 1111.

(Blank)

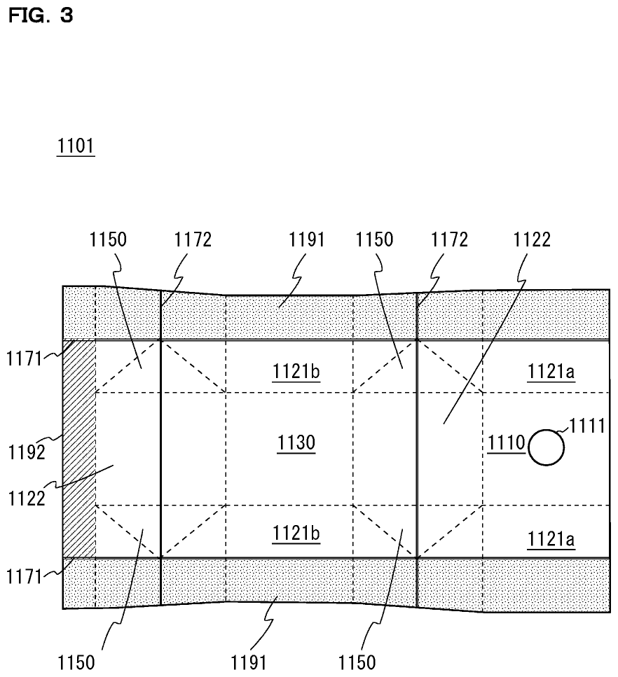

FIG. 3 shows a plan view (development view) of a blank 1101 that is an example of a blank for the packaging container 1100. The blank 1101 is formed by cutting one sheet material into a predetermined shape and partitioning regions for forming each surface and the like in the box state, with ruled lines shown by dotted lines.

The sheet material used for the blank 1101 is not particularly limited, but, for example, a laminated film having a thermoplastic resin layer or a sealant layer layered on a base material layer made of paper can be suitably used. In addition to this, a barrier layer, a functional film, or the like may be added as appropriate according to a required function.

As shown in FIG. 3, in the blank 1101, the pair of second side surfaces 1122 are connected to opposing two edges of the lower surface 1130, and a pair of the lower first side surfaces 1121b are connected to the other two edges of the lower surface 1130. The four bend pieces 1150 are connected between the adjacent second side surfaces 1122 and lower first side surface 1121b.

The upper surface 1110 is connected to the edge, of one of the second side surfaces 1122, which opposes the lower surface 1130. A pair of the upper first side surfaces 1121a are connected to the edges, of the upper surface 1110, which are orthogonal to the edge, of the upper surface 1110, to which the second side surface 1122 is connected.

In addition, a second seal margin 1192 for a top seal portion, for sealing and connecting the other second side surface 1122 and the bend pieces 1150 connected to the other second side surface 1122 to the upper surface 1110 and the upper first side surfaces 1121a connected to the upper surface 1110, is connected over a predetermined width to the edges, of the other second side surface 1122 and the bend pieces 1150 connected to the other second side surface 1122, which oppose the lower surface 1130 and the lower first side surfaces 1121b.

A pair of the first seal margins 1191 for forming the side seal portions 1140 are connected over a predetermined width to the edges, of the bend pieces 1150, the upper first side surfaces 1121a, and the lower first side surfaces 1121b, which oppose the upper surface 1110, the lower surface 1130, and the second side surfaces 1122, and the edges, of the second seal margin 1192 for a top seal portion, which are orthogonal to the edge, of the second seal margin 1192, to which the bend pieces 1150 are connected. In FIG. 3, the first seal margins 1191 and the second seal margin 1192 are shown by hatching. The end portion of the second seal margin 1192 may be subjected to edge protection treatment by skiving and hemming, edge protection tape, or the like.

The above-described linear first ruled lines 1171 are formed between the first seal margins 1191 and the bend pieces 1150, the upper first side surfaces 1121a, the lower first side surfaces 1121b, and the second seal margin 1192. In addition, the above-described linear second ruled lines 1172 passing through the centers of the second side surfaces 1122 and the bend pieces 1150 are each formed on the second side surface 1122, a pair of the bend pieces 1150 connected to the second side surface 1122, and the first seal margins 1191.

On the bend pieces 1150, ruled lines are formed so as to extend diagonally from the points of contact between the edges at the first seal margin 1191 side of the bend pieces 1150 and the second ruled lines 1172 to corners of the upper surface 1110 and the lower surface 1130.

(Transformation Method)

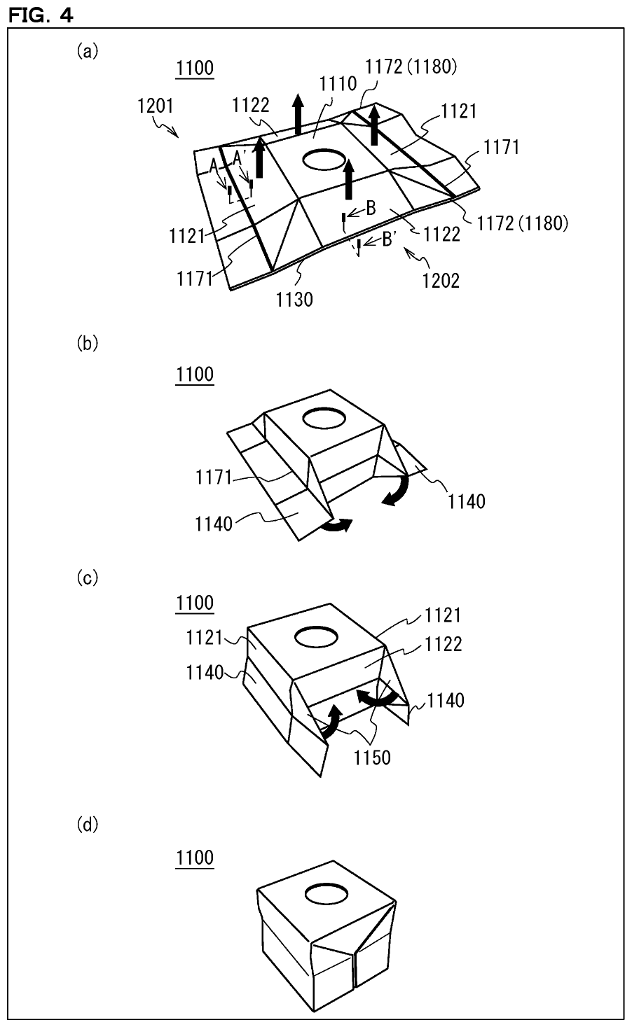

Next, a method for transforming the packaging container 1100 that is in the flat state, into the box state, will be described. Parts (a) to (d) of FIG. 4 illustrate respective procedural steps according to the method for transforming the container body 1100.

First, as shown in part (a) of FIG. 4, the sheet material of the packaging container 1100 that is in the flat state is bent along the first ruled lines 1171, or the folded portions 1180 of the sheet material are unfolded along the second ruled lines 1172, thereby pulling the first portion 1201 and the second portion 1202 apart from each other to form a cavity between the first portion 1201 and the second portion 1202 and forming the upper surface 1110, the lower surface 1130, the first side surfaces 1121, and the second side surfaces 1122. At this time, bending of the sheet material along the first ruled lines 1171 and unfolding of the folded portions 1180 along the second ruled lines 1172 may be simultaneously performed.

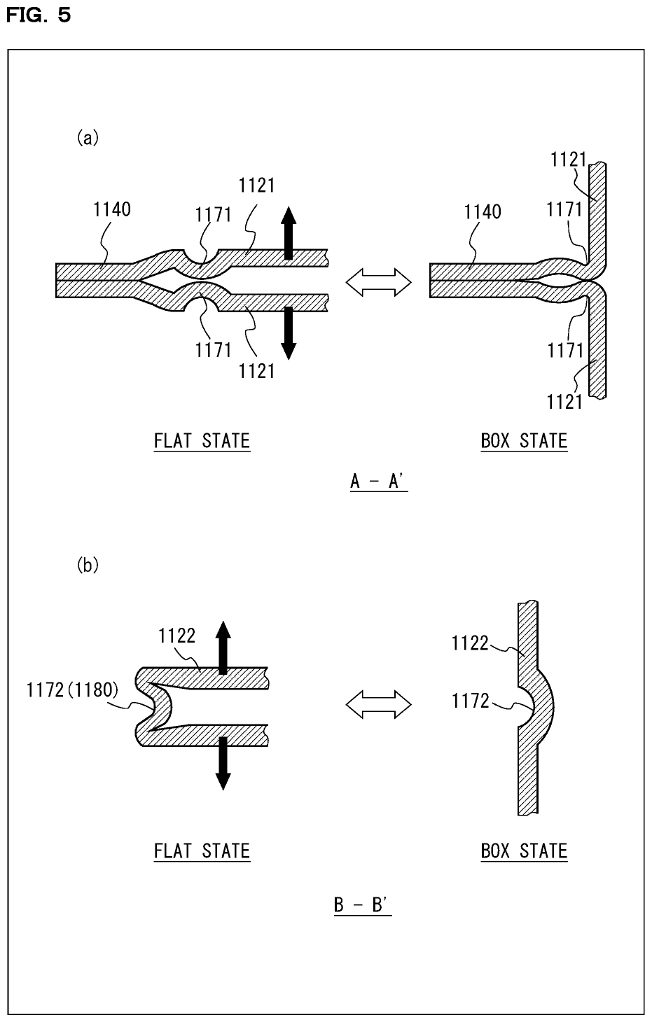

FIG. 5 shows cross-sectional views of areas around the first ruled lines 1171 and the second ruled line 1172 at this time. Part (a) of FIG. 5 shows a cross-section of the area around the first ruled lines 1171, taken along a line A-A′. Part (b) of FIG. 5 shows a cross-section of the area around the second ruled line 1172, taken along a line B-B′.

As shown in part (a) of FIG. 5, the sheet material is bent along the first ruled lines 1171 by transforming the packaging container 1100 from the flat state into the box state. In addition, as shown in part (b) of FIG. 5, each folded portion 1180 of the sheet material is unfolded along the second ruled line 1172 by transforming the packaging container 1100 from the flat state into the box state.

In FIG. 5, the first ruled lines 1171 and the second ruled lines 1172 each have a shape recessed from the front surface toward the back surface of the sheet material. However, the shapes of the first ruled lines 1171 and the second ruled lines 1172 are not limited thereto, and may be, for example, a linear shape projecting toward the back surface.

Next, as shown by black arrows in part (b) of FIG. 4, the side seal portions 1140 are bent upward or downward along the first ruled lines 1171.

Next, as shown by black arrows in part (c) of FIG. 4, the bend pieces 1150 are bent toward the second side surfaces 1122. Accordingly, the side seal portions 1140 can be overlaid on and along the first side surfaces 1121 and the second side surfaces 1122.

At this time, the bend pieces 1150 may be adhered to the second side surfaces 1122. Examples of the method for adhering the bend pieces 1150 to the second side surfaces 1122 include methods using heat-sealing, a hot-melt adhesive, and the like. In addition, when the bend pieces 1150 are adhered to the second side surfaces 1122 by means of attachable/detachable joining members such as hook and loop fasteners and snap buttons, the packaging container 1100 that has been transformed from the box state into the flat state is allowed to be used again in the box state, so that it is possible to reuse the packaging container 1100 that is in the flat state.

Through the above procedure, the packaging container 1100 that is in the flat state can be transformed into the box state as shown in part (d) of FIG. 4.

The packaging container 1100 in the box state can be transformed into the flat state through a procedure opposite to the above procedure.

Specifically, first, the bend pieces 1150 of the packaging container 1100 in the box state are separated from the second side surfaces 1122.

Next, the sheet material is unfolded along the first ruled lines 1171, or the sheet material is folded back along the second ruled lines 1172 (that is, brought from the state in the right drawing to the state of the left drawing in FIG. 5). At this time, unfolding of the sheet material along the first ruled lines 1171 and folding-back of the sheet material along the second ruled lines 1172 may be simultaneously performed.

Next, the cavity between the first portion 1201 and the second portion 1202 is eliminated, and the first portion 1201 and the second portion 1202 are overlaid on each other, whereby the packaging container 1100 can be transformed into the flat state.

(Modification of Transformation Method)

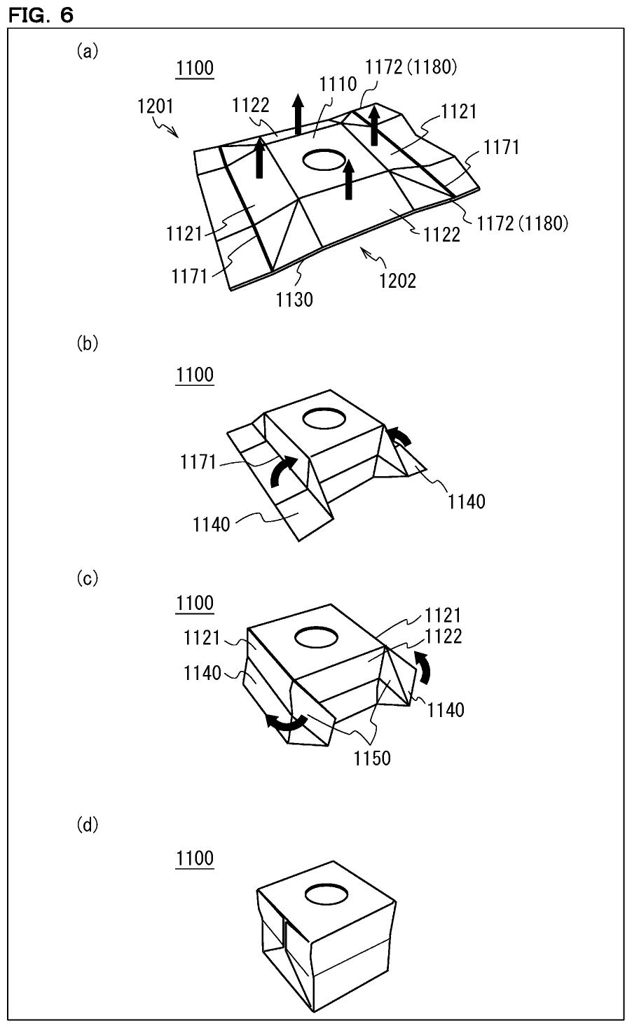

The method for transforming the packaging container 1100 into the box state is not limited to the above method. FIG. 6 shows a transformation method according to a modification. The difference between the transformation method in FIG. 6 and the transformation method in FIG. 4 is the directions in which the side seal portions 1140 are bent and the directions in which the bend pieces 1150 are folded.

As shown in part (b) of FIG. 6, in the transformation method according to the modification, the side seal portions 1140 are bent upward along the first ruled lines 1171 as shown by black arrows. Then, as shown in part (c) of FIG. 6, the bend pieces 1150 are folded toward the first side surfaces 1121.

Accordingly, the packaging container 1100 that is in the flat state can be transformed into a state where the side seal portions 1140 are overlaid on and along the first side surfaces 1121 and the second side surfaces 1122 at the upper side of the side surface 1120 as shown in part (d) of FIG. 6. The packaging container 1100 transformed as described above can also be transformed into the flat state through a procedure opposite to the above procedure.

(Modifications of Packaging Container)

In the packaging container 1100, the side seal portions 1140 are provided at the opposing two edges of the rectangular first portion 1201 and the rectangular second portion 1202, but the number of side seal portions 1140 is not limited to two.

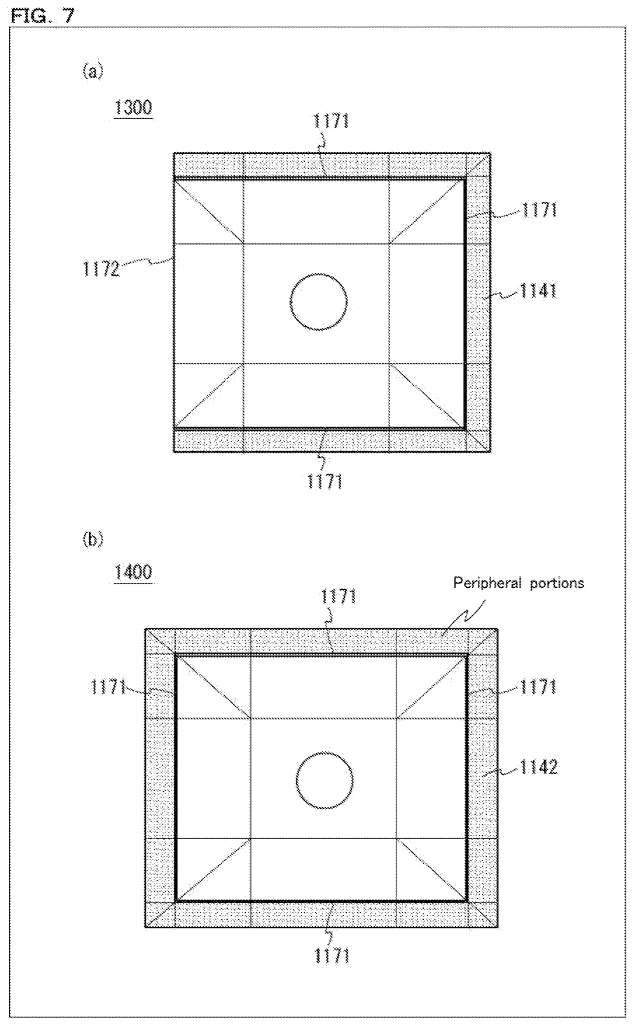

FIG. 7 shows plan views in flat states of a packaging container 1300 and a packaging container 1400 according to modifications. The differences between the packaging container 1100 and the packaging container 1300 and the packaging container 1400 are the positions at which the side seal portions 1140, the first ruled lines 1171, and the second ruled lines 1172 are formed.

As shown in part (a) of FIG. 7, in the packaging container 1300, a side seal portion 1141 shown by hatching is formed over three edges. Linear first ruled lines 1171 are formed at the inner side of the side seal portion 1141, and a second ruled line 1172 is formed at the remaining one edge. For example, similar to the blank 1101, a pair of first seal margins and a pair of second seal margins are provided at opposing edges of one substantially rectangular blank, and the packaging container 1300 can be formed by bending the blank at the center and then sealing the respective seal margins.

In addition, as shown in part (b) of FIG. 7, in the packaging container 1400, a side seal portion 1142 is formed over all of four edges. Linear first ruled lines 1171 are formed at the inner side of the side seal portion 1142. In the packaging container 1400, no second ruled line 1172 is formed. For example, a first portion and a second portion are each formed by a square blank, and the packaging container 1400 can be formed by sealing the entire edges of the first portion and the second portion.

As described above, according to the present invention, it is possible to provide a packaging container that can be transformed between a box state and a flat state and that can be reused by returning the packaging container to the box state even after being once flattened into the flat state.

<Method for Filling Contents>

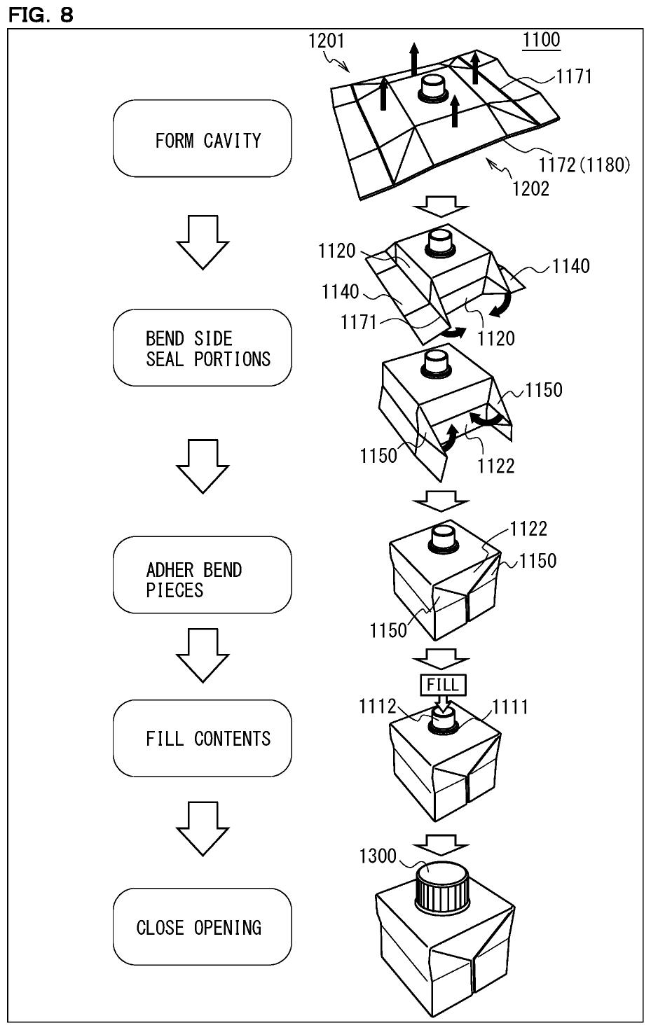

Next, a method for filling contents into the packaging container 1100 (hereinafter, referred to as filling method) will be described with reference to FIG. 8 using the packaging container 1100 having the spout 1112 attached to the opening 1111. The packaging container used in the filling method is not limited to the packaging container 1100, and may be any of the packaging containers 1300 and 1400 according to the modifications. FIG. 8 sequentially illustrates each step of the filling method from the upper side toward the lower side of the sheet surface thereof.

As shown in FIG. 8, the filling method includes: a step of forming a cavity between the first portion 1201 and the second portion 1202; a step of bending the side seal portions 1140 such that the side seal portions 1140 extend along the side surface 1120; a step of adhering the bend pieces 1150 to the second side surfaces 1122; a step of filling contents into the cavity of the packaging container 1100 through the opening 1111; and a step of closing the opening 1111. Hereinafter, each step will be described.

[Formation of Cavity]

First, the first portion 1201 and the second portion 1202 of the packaging container 1100 that is in the flat state are pulled apart from each other to form a cavity between the first portion 1201 and the second portion 1202. Specifically, for example, the sheet material of the packaging container 1100 is bent along the first ruled lines 1171, or the folded portions 1180 of the sheet material are unfolded along the second ruled lines 1172. At this time, bending of the sheet material along the first ruled lines 1171 and unfolding of the folded portions 1180 along the second ruled lines 1172 may be simultaneously performed.

[Bending of Side Seal Portions]

Next, the side seal portions 1140 are bent so as to extend along the side surface 1120. Specifically, the side seal portions 1140 are bent upward or downward along the first ruled lines 1171, and the bend pieces 1150 are bent toward the second side surfaces 1122. In this step, the side seal portions 1140 may be bent by the transformation method according to the modification shown in parts (b) and (c) of FIG. 6. Specifically, the side seal portions 1140 may be bent upward along the first ruled lines 1171, and then the bend pieces 1150 may be bent toward the first side surfaces 1121.

[Adhesion of Bend Pieces]

Next, the bend pieces 1150 are adhered to the second side surfaces 1122. As the adhering method, for example, a known method such as heat-sealing, a hot-melt adhesive, a hook and loop fastener, and a snap button can be used. Accordingly, the packaging container 1100 is brought into the box state.

[Filling of Contents]

Next, the contents are filled into the cavity of the packaging container 1100 through the opening 1111. Specifically, for example, a filling means such as a filling nozzle is inserted into the spout 1112, and then the contents are filled into the cavity of the packaging container 1100 by the filling means.

[Closing of Opening]

Next, the opening 1111 is closed. Specifically, for example, the spout 1112 is hermetically sealed by screwing a cap 1300 to the spout 1112. Accordingly, the packaging container 1100 filled with the contents can be obtained. The method for closing the opening 1111 is not limited to the method with the cap 1300, and, for example, a pump dispenser or the like may be mounted on the spout 1112, or the opening 1111 may be closed by a film or the like.

As long as the filling method includes the step of forming a cavity between the first portion 1201 and the second portion 1202, the step of bending the side seal portions 1140 such that the side seal portions 1140 extend along the side surface 1120, the step of adhering the bend pieces 1150 to the second side surfaces 1122, the step of filling the contents into the cavity of the packaging container 1100 through the opening 1111, and the step of closing the opening 1111, the order of these steps may be partially changed.

For example, a step of filling the contents into the cavity of the packaging container 1100 while forming a cavity between the first portion 1201 and the second portion 1202, or forming a cavity between the first portion 1201 and the second portion 1202 while filling the contents into the cavity of the packaging container 1100, and then bending the side seal portions 1140 such that the side seal portions 1140 extend along the side surface 1120, the step of adhering the bend pieces 1150 to the second side surfaces 1122, and the step of closing the opening 1111 may be performed in this order.

As described above, according to the filling method, the packaging container in which the end portions are sealed and folded into a flat state in advance can be transformed into the box shape, the contents are filled into the packaging container, and then the packaging container is hermetically sealed by a cap or the like. Therefore, a sealing step for ensuring air-tightness in a contents filling line is eliminated, and it is unnecessary to guarantee sealability in the filling line. As a result, a decrease in production efficiency can be inhibited.

Moreover, according to the filling method, the packaging container can be kept in the flat state immediately before the filling line. Thus, the loading efficiency of the packaging container is high, and the transportation and storage costs of the packaging container can be reduced.

Furthermore, the packaging container used in the filling method can be transformed into a rigid box state by bending parts of the sheet material or further unfolding the sheet material. Thus, an apparatus for assembling the packaging container can have a simple structure and lower cost.

Furthermore, when attachable/detachable joining members such as hook and loop fasteners and snap buttons are used for the method for adhering the bend pieces to the side surfaces, the adhered bend pieces can be separated from the side surfaces, and the packaging container can be transformed into the flat state. Thus, it is possible to easily flatten the packaging container after the packaging container is used.

### Second Embodiment

A packaging container 2100 according to a second embodiment of the present invention is a container that is formed by overlaying and sealing end portions of a blank obtained by cutting a sheet material into a predetermined shape and that is transformable between a box state and a flat state.

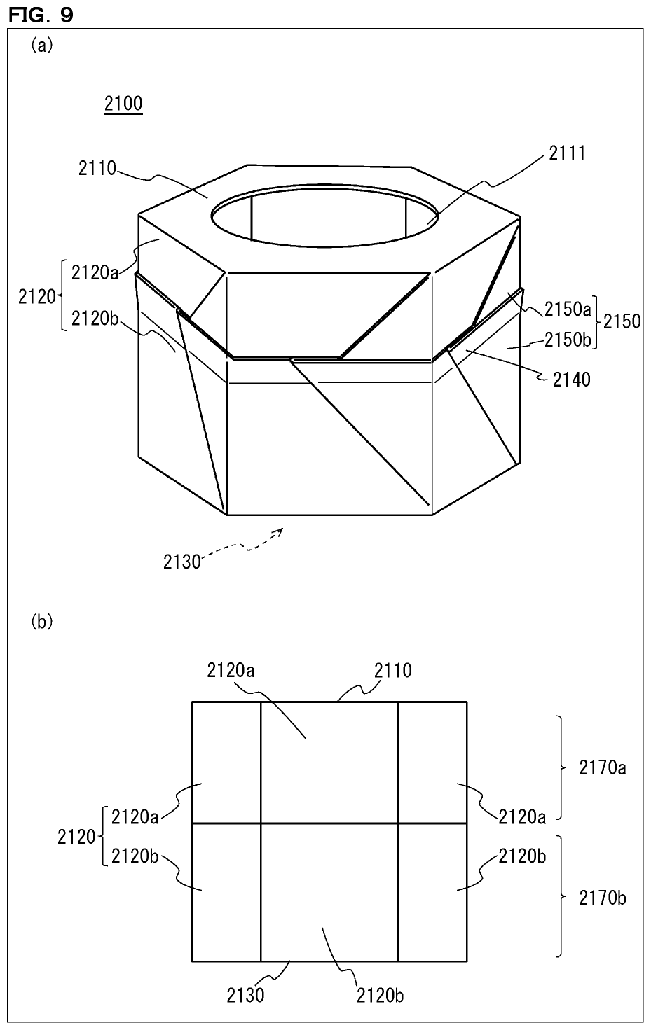

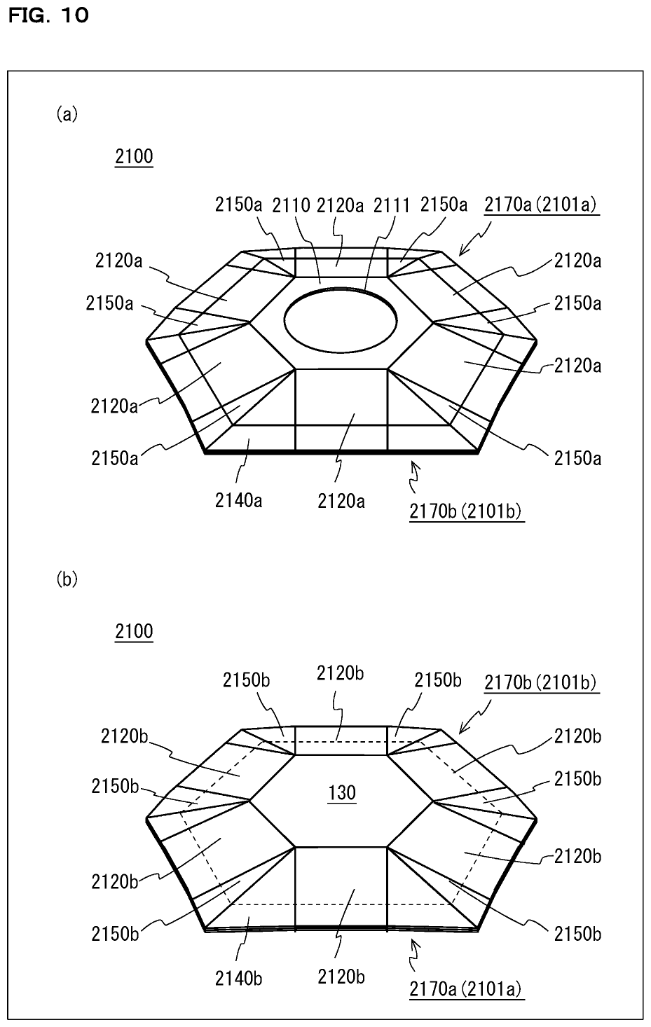

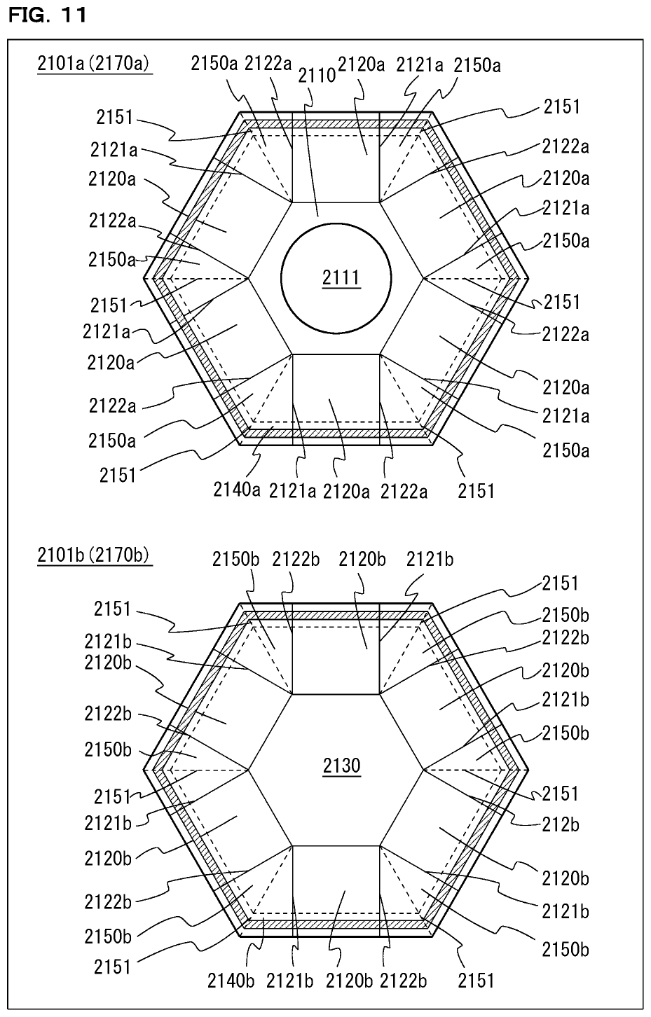

FIG. 9 shows a perspective view (part (a) of FIG. 9) and a side view (part (b) of FIG. 9) of the packaging container 2100 that is in the box state, and FIG. 10 shows perspective views of the packaging container 2100 that is in the flat state. In addition, FIG. 11 shows plan views of an example of a blank for the packaging container 2100. Part (a) of FIG. 10 is a perspective view showing a state where an upper surface 2110 of the packaging container 2100 that is in the flat state is located at the upper side, and part (b) of FIG. 10 is a perspective view showing a state where a lower surface 2130 of the packaging container 2100 that is in the flat state is located at the upper side. In part (b) of FIG. 9, for clarifying the shape of the packaging container 2100, a side seal portion 2140 and folded pieces 2150 shown in part (a) of FIG. 9 are omitted.

(Box State)

As shown in FIG. 9, the packaging container 2100 that is in the box state forms a cavity (storage space) by the upper surface 2110, the lower surface 2130, and a side surface 2120. The side seal portion 2140 and the folded pieces 2150 are provided along an outer peripheral of the side surface 2120. In the packaging container 2100, the example in which the side seal portion 2140 extends along the side surface 2120 in a state where the edge of the side seal portion 2140 faces the upper surface 2110 side is shown, but the side seal portion 2140 may extend along the side surface 2120 in a state where the edge of the side seal portion 2140 faces the lower surface 2130 side.

(Flat State)

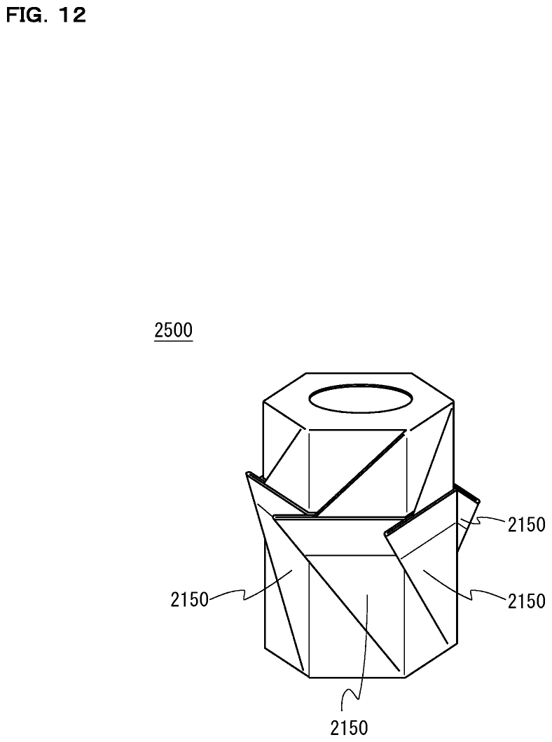

As shown in FIG. 11, the packaging container 2100 that is in the flat state is composed of a first portion 2170a and a second portion 2170b that are placed on each other. As shown in FIG. 12, a blank for forming the packaging container 2100 is composed of a blank 2101a corresponding to the first portion 2170a and a blank 2101b corresponding to the second portion 2170b.

The first portion 2170a includes: the upper surface 2110 (projection polygonal surface); a plurality of upper isosceles trapezoidal surfaces 2120a extending from the respective sides of the upper surface 2110; a plurality of upper to-be-folded surfaces 2150a formed between the adjacent respective upper isosceles trapezoidal surfaces 2120a; and an upper seal margin 2140a that forms a peripheral portion over the entirety of the outer edge of the first portion 2170a along the edges of the upper isosceles trapezoidal surfaces 2120a and the upper to-be-folded surfaces 2150a at the side opposite to the upper surface 2110.

The second portion 2170b includes: the lower surface 2130 (projection polygonal surface); a plurality of lower isosceles trapezoidal surfaces 2120b extending from the respective sides of the lower surface 2130; a plurality of lower to-be-folded surfaces 2150b formed between the adjacent respective lower isosceles trapezoidal surfaces 2120b; and a lower seal margin 2140b that forms a peripheral portion over the entirety of the outer edge of the second portion 2170b along the edges of the lower isosceles trapezoidal surfaces 2120b and the lower to-be-folded surfaces 2150b at the side opposite to the lower surface 2130.

The upper surface 2110 and the lower surface 2130 are projection polygonal surfaces. In the packaging container 2100, as an example, the upper surface 2110 and the lower surface 2130 are formed so as to be congruent to each other. The upper surface 2110 and the lower surface 2130 may have similar shapes with different areas as an example. The shapes of the upper surface 2110 and the lower surface 2130 are not limited as long as the shapes are projection polygonal shapes. As the shapes of the upper surface 2110 and the lower surface 2130, in addition to a hexagon shown in the embodiment, a tetragon is also useful in terms of loading efficiency in the box state, subdivision into components, etc. An opening 2111 is formed in the upper surface 2110.

The plurality of upper isosceles trapezoidal surfaces 2120a and the plurality of lower isosceles trapezoidal surfaces 2120b are surfaces for forming the side surface 2120 of the packaging container 2100 that is in the box state. In the packaging container 2100, as an example, the upper isosceles trapezoidal surfaces 2120a and the lower isosceles trapezoidal surfaces 2120b are rectangular. At least either the upper isosceles trapezoidal surfaces 2120a or the lower isosceles trapezoidal surfaces 2120b may have an isosceles trapezoidal shape that is not rectangular.

The upper isosceles trapezoidal surfaces 2120a extend from the respective sides of the upper surface 2110 (projection polygonal surface) and each have two parallel sides, one of which is the corresponding side of the upper surface 2110. In addition, the lower isosceles trapezoidal surfaces 2120b extend from the respective sides of the lower surface 2130 (projection polygonal surface) and each have two parallel sides, one of which is the corresponding side of the lower surface 2130. Moreover, as shown in part (b) of FIG. 9, the sides at the upper seal margin 2140a side of the upper isosceles trapezoidal surfaces 2120a and the sides at the lower seal margin 2140b side of the lower isosceles trapezoidal surfaces 2120b are formed to have the same length.

The upper to-be-folded surfaces 2150a and the lower to-be-folded surfaces 2150b are surfaces for forming the folded pieces 2150 of the packaging container 2100 that is in the box state, and are surfaces to be folded in a later-described transformation process.

In order to facilitate folding of the upper to-be-folded surfaces 2150a and the lower to-be-folded surfaces 2150b in the transformation process, the upper to-be-folded surfaces 2150a and the lower to-be-folded surfaces 2150b include folding ruled lines 2151 that extend from the respective vertexes of the upper surface 2110 and the lower surface 2130 toward the peripheral portions of the first portion 2170a and the second portion 2170b, as shown by dotted lines in FIG. 11.

As shown in FIG. 11, each of the folding ruled lines 2151 formed on the upper to-be-folded surfaces 2150a extends so as to bisect the angle formed by a first lateral side 2121a and a second lateral side 2122a shared by the upper to-be-folded surface 2150a and the upper isosceles trapezoidal surfaces 2120a adjacent to the upper to-be-folded surface 2150a. In addition, similarly, each of the folding ruled lines 2151 formed on the lower to-be-folded surfaces 2150b extends so as to bisect the angle formed by a first lateral side 2121b and a second lateral side 2122b shared by the lower to-be-folded surface 2150b and the lower isosceles trapezoidal surfaces 2120b adjacent to the lower to-be-folded surface 2150b.

The upper seal margin 2140a and the lower seal margin 2140b are band-like surfaces provided for connecting the first portion 2170a and the second portion 2170b at the peripheral portions thereof. When connecting the first portion 2170a and the second portion 2170b, the first portion 2170a and the second portion 2170b are overlaid on each other, and surfaces thereof at which the upper seal margin 2140a and the lower seal margin 2140b oppose each other are sealed or bonded to each other, for example, whereby the side seal portion 2140 is formed. The shapes of the upper seal margin 2140a and the lower seal margin 2140b only need to allow the seal margins to be placed on each other in order to overlay the seal margins on each other and form the side seal portion 2140, and can be optionally set.

The width of the side seal portion 2140, that is, the widths of the upper seal margin 2140a and the lower seal margin 2140b, may be uniform or may not be uniform, as long as the first portion 2170a and the second portion 2170b can be connected to each other, or the edges thereof may not be linear. For example, the widths of the upper seal margin 2140a and the lower seal margin 2140b may be set such that the upper seal margin 2140a and the lower seal margin 2140b spread outward at predetermined angles toward the folding ruled lines 2151 at the outer sides of the upper to-be-folded surfaces 2150a and the lower to-be-folded surfaces 2150b. By so setting, when the plurality of upper isosceles trapezoidal surfaces 2120a and the plurality of lower isosceles trapezoidal surfaces 2120b each have a shape that is not rectangular, and the packaging container 2100 in which the side surface 2120 is tapered is transformed into the box state as described later, the peripheral portion can be formed on and along straight lines parallel to the respective sides of the upper surface 2110 and the lower surface 2130, so that the design quality can be improved.

The regions to be sealed can be, for example, band-like regions having a predetermined width as shown by hatching in FIG. 11. The packaging container 2100 formed as described above has air-tightness except for the opening 2111.

Each of the blanks 2101a and 2101b can be formed, for example, by cutting a sheet material into a predetermined shape and providing ruled lines as shown by thin lines and dotted lines in FIG. 11 to partition regions for forming each surface.

The sheet material used for the blanks 2101a and 2101b is not particularly limited, but, for example, a laminated film having a thermoplastic resin layer or a sealant layer layered on a base material layer made of paper can be suitably used. In addition to this, a barrier layer, a functional film, or the like may be added as appropriate according to a required function.

(Lengths of Folding Ruled Lines)

In the packaging container 2100, when the folding ruled lines 2151 are longer than a predetermined length, ends of the folded pieces 2150 may protrude from the sides from which the folded pieces 2150 adjacent thereto extend. FIG. 12 shows a perspective view of a packaging container 2500 according to a comparative embodiment in which ends of folded pieces 2150 protrude from sides from which the folded pieces 2150 adjacent thereto extend. When the folded pieces 2150 protrude as shown, the appearance of the packaging container 2100 is deteriorated. In addition, even when the protruding folded pieces 2150 are bent so as to extend along the surfaces of the folded pieces 2150, the thickness of the packaging container 2100 increases and thus the appearance of the packaging container 2100 is not good. Furthermore, when the sheet material is thick, it may also be difficult to overlay a plurality of the folded pieces 2150 on each other.

In order to prevent this, in the packaging container 2100, the folding ruled lines 2151 are set as described below. Specifically, each of the folding ruled lines 2151 is set such that, when the packaging container 2100 is in the flat state, the folding ruled line 2151 is shorter than a line that is obtained by axis-symmetrically reversing the folding ruled line 2151 about, as an axis side, a lateral side adjacent thereto in a predetermined direction of the first lateral sides 2121a or 2121b and the second lateral sides 2122a or 2122b and that is extended until intersecting a straight line including the side, opposite to the axis side, of the upper isosceles trapezoidal surface 2120a or the lower isosceles trapezoidal surface 2120b adjacent thereto in the predetermined direction.

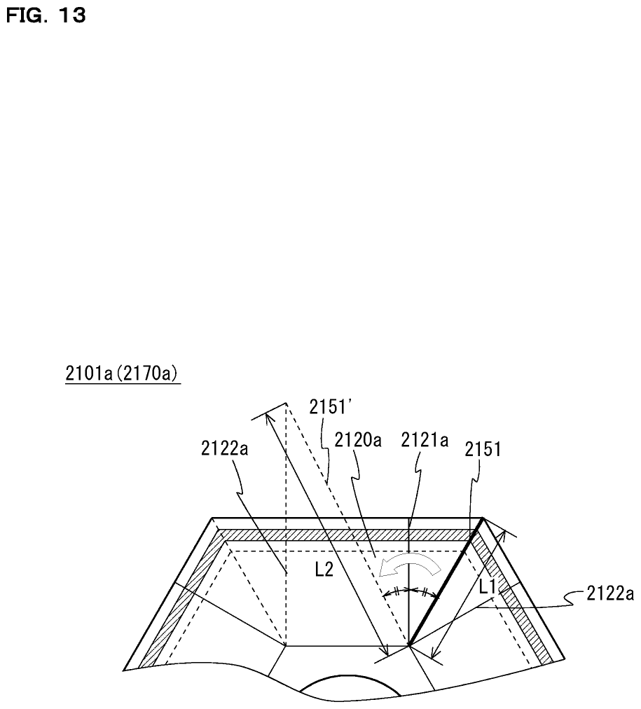

The lengths of the folding ruled lines 2151 will be specifically described using the blank 2101a. FIG. 13 shows a partially enlarged view of the blank 2101a for the packaging container 2100.

A description will be given with the folding ruled line 2151 having a length L1 shown by a thick line in FIG. 13. First, a line segment is assumed which is obtained by axis-symmetrically reversing the folding ruled line 2151 about, as an axis side, a lateral side (first lateral side 2121a) adjacent thereto in a predetermined direction (as an example, in FIG. 13, the direction to the first lateral side 2121a), as shown by a white arrow. Then, a line segment 2151′ having a length L2 is obtained by extending the line segment obtained by the reversion until the line segment intersects a straight line including the side (second lateral side 2122a), opposite to the axis side, of the upper isosceles trapezoidal surface 2120a adjacent thereto in the above predetermined direction. The dimensions of each portion of the packaging container 2100 are determined such that the relationship of the length L2 of the line segment 2151′ obtained as a result of this and the length L1 of the folding ruled line 2151 satisfies L1<L2.

In the above description, the “predetermined direction” is set to be the direction to the first lateral side 2121a (the left side in the surface of the sheet of FIG. 13) as seen from the folding ruled line 151, but the direction to the second lateral side 2122a (the right side in the surface of the sheet of FIG. 13), which is opposite to the above direction, may be set as the “predetermined direction”.

In order to make the length L1 of the folding ruled lines 2151 shorter than the length L2 of the line segment 2151′, specifically, for example, the lengths of the respective sides of the upper surface 2110 and the lower surface 2130 are set to be longer, and the heights of the upper isosceles trapezoidal surfaces 2120a and the lower isosceles trapezoidal surfaces 2120b (the length in the up-down direction of the packaging container 2100) are set to be lower. Accordingly, while the capacity of the packaging container 2100 is kept constant, the ends of the folded pieces 2150 can be prevented from protruding from the sides from which the folded pieces 2150 adjacent thereto extends. Accordingly, it is possible to eliminate the area of a region in which the folded pieces 2150 overlap each other. Thus, the amount of the blanks 2101a and 2101b that is required for producing the packaging container 2100 can be reduced while the capacity of the packaging container 2100 is kept constant.

(Transformation Method)

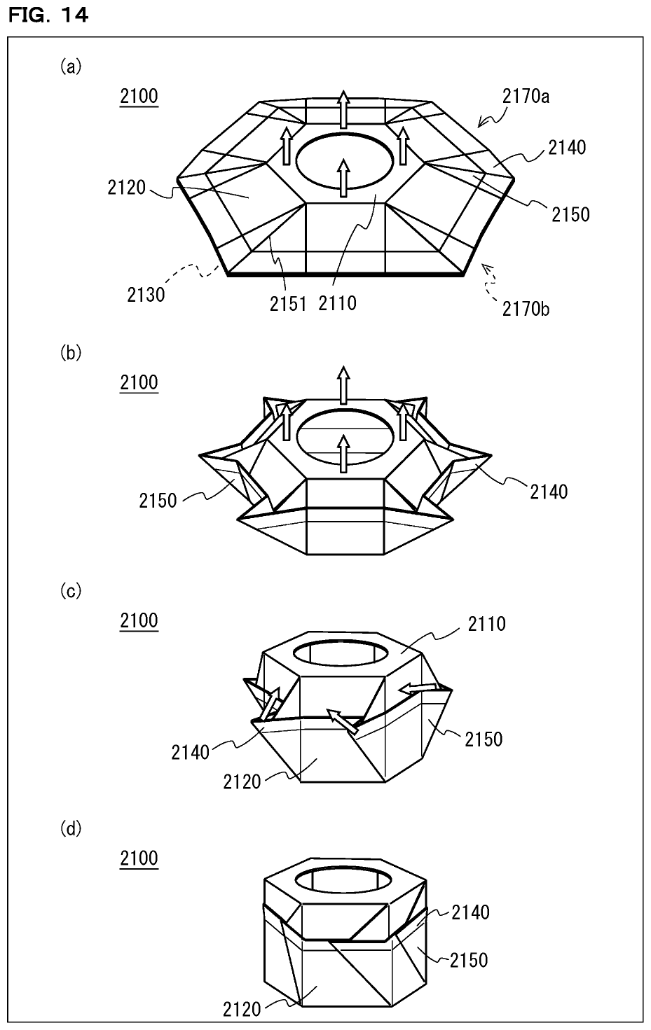

Next, an example of the method for transforming the packaging container that is in the flat state into the box state will be described using the packaging container 2100. Parts (a) to (d) of FIG. 14 illustrate an example of the method for transforming the container body 2100.

First, as shown in part (a) of FIG. 14, the first portion 2170a and the second portion 2170b of the packaging container 2100 that is in the flat state are bent at the peripheral portions thereof (specifically, along the ruled lines between the side seal portion 2140 and the upper isosceles trapezoidal surfaces 2120a and the lower isosceles trapezoidal surfaces 2120b) to pull the first portion 2170a and the second portion 2170b apart from each other. Accordingly, a cavity is formed between the first portion 2170a and the second portion 2170b, and the upper surface 2110, the lower surface 2130, and the side surface 2120 are formed. Simultaneously, the sides shared by the upper to-be-folded surfaces 2150a and the lower to-be-folded surfaces 2150b and the upper isosceles trapezoidal surfaces 2120a and the lower isosceles trapezoidal surfaces 2120b adjacent thereto (the first lateral sides 2121a and 2121b and the second lateral sides 2122a and 2122b) come closer to each other. Accordingly, the upper to-be-folded surfaces 2150a and the lower to-be-folded surfaces 2150b are folded such that the folding ruled lines 2151 extend outward of the cavity, thereby forming the folded pieces 2150.

Next, as shown in part (b) of FIG. 14, the side seal portion 2140 is caused to extend along the side surface 2120 so as to be directed toward the upper surface 2110. The side seal portion 2140 may be caused to extend along the side surface 2120 so as to be directed toward the lower surface 2130.

Next, as shown in part (c) of FIG. 14, the folded pieces 2150 are caused to extend along the outer peripheral of the side surface 2120. The direction along which the folded pieces 2150 are caused to extend is tot limited, and the plurality of folded pieces 2150 may be caused to extend toward the same direction along the circumferential direction of the side surface 2120 as shown in part (c) of FIG. 14, or the folded pieces 2150 may be caused to extend toward different directions.

At this time, the folded pieces 2150 may be adhered to the side surface 2120. Examples of the method for adhering the folded pieces 2150 to the side surface 2120 include methods using heat-sealing, a hot-melt adhesive, and the like. In addition, when the folded pieces 2150 are adhered to the side surface 2120 by means of attachable/detachable joining members such as hook and loop fasters and snap buttons, the packaging container 2100 that has been transformed from the box state into the flat state is allowed to be used again in the box state, so that it is possible to reuse the packaging container 2100 that is in the flat state.

Through the above procedure, the packaging container 2100 that is in the flat state can be transformed into the box state as shown in part (d) of FIG. 14.

The packaging container 2100 in the box state can be transformed into the flat state through a procedure opposite to the above procedure.

Specifically, first, the folded pieces 2150 of the packaging container 2100 are separated from the side surface 2120.

Next, the first portion 2170a and the second portion 2170b are unfolded at the peripheral portions thereof (specifically, along the ruled line between the side seal portion 2140 and the side surface 2120).

Next, the cavity between the first portion 2170a and the second portion 2170b is eliminated, and the first portion 2170a and the second portion 2170b are overlaid on each other, whereby the packaging container 2100 can be transformed into the flat state.

<Modifications>

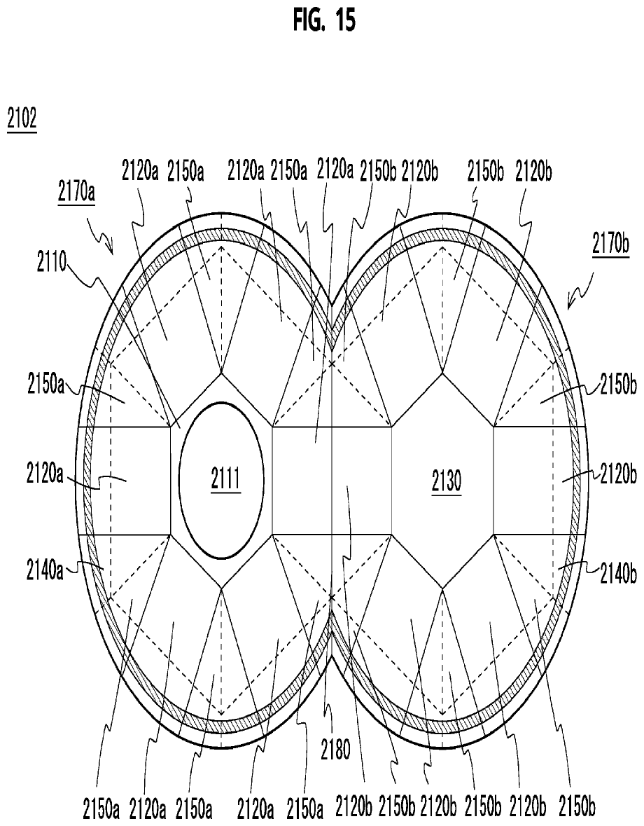

In the above embodiment, the example in which the packaging container is formed using the two blanks 2101a and 2101b corresponding to the first portion 2170a and the second portion 2170b has been shown, but these blanks may be integrally formed. FIG. 15 shows a blank 2102 according to a modification. In the blank 2102, as shown in FIG. 15, parts of peripheral portions of blanks corresponding to the first portion 2170a and the second portion 2170b are connected to each other by a connection portion 2180.

When forming the packaging container 2100 using the blank 2102, for example, the first portion 2170a and the second portion 2170b having peripheral portions formed in a circular shape are overlaid on each other by folding the blank 2102 at the connection portion 2180, and then the upper seal margin 2140a and the lower seal margin 2140b are sealed to each other. By integrally forming the blank as described above, for example, many blanks are allowed to be stamped from one sheet material when forming blanks by stamping the sheet material. Thus, the packaging container can be produced at lower cost.

When transforming the packaging container 2100, which is formed using the blank 2102, into the box state by pulling the first portion 2170a and the second portion 2170b of the packaging container 2100 apart from each other, the connection portion 2180 is unfolded. In addition, when transforming the packaging container 2100 into the flat state, the connection portion 2180 is folded.

Moreover, in the above embodiment and modification, at least either the upper isosceles trapezoidal surfaces 2120a or the lower isosceles trapezoidal surfaces 2120b may be formed as isosceles trapezoidal surfaces that are not rectangular. By forming the upper isosceles trapezoidal surfaces 2120a and the lower isosceles trapezoidal surfaces 2120b as described above, at least any of side surfaces, above and below the side seal portion 2140, of the side surface 2120 of the packaging container that is in the box state can have a forward tapered or reverse tapered shape. Accordingly, it is possible to provide a packaging container having a shape with high design quality.

Furthermore, a spout may be attached to the opening 2111 of the packaging container of the present invention. When a spout on which a cap can be mounted is attached to the opening 2111, it is easy to hermetically seal the opening 2111. In addition, when the spout is attached, for example, the opening 2111 can be hermetically sealed using a cap or the like after the packaging container folded into the flat state is transformed into the box shape and contents such as a liquid are filled thereinto. Thus, for example, a sealing step for ensuring air-tightness in a contents filling line is eliminated, and it is unnecessary to guarantee sealability in the filling line. Therefore, when the packaging container of the present invention is used, it is possible to efficiently fill the contents into the packaging container.

Moreover, according to the packaging container of the present invention, the packaging container can be transported in the flat state. Thus, the loading efficiency of the packaging container is high, and the transportation and storage costs of the packaging container can be reduced.

### Third Embodiment

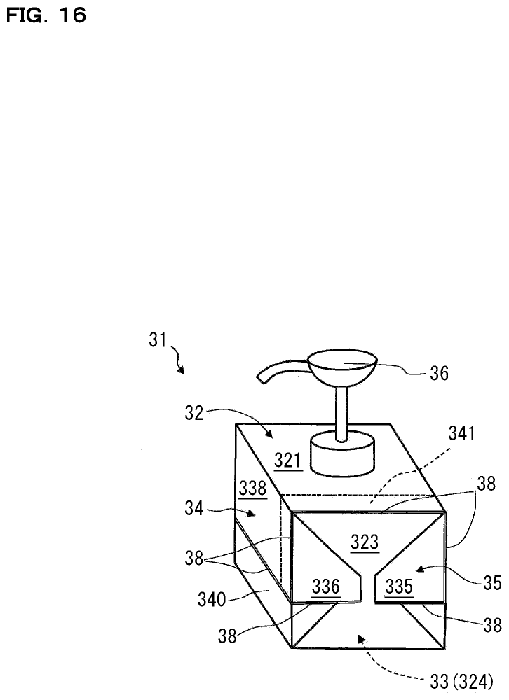

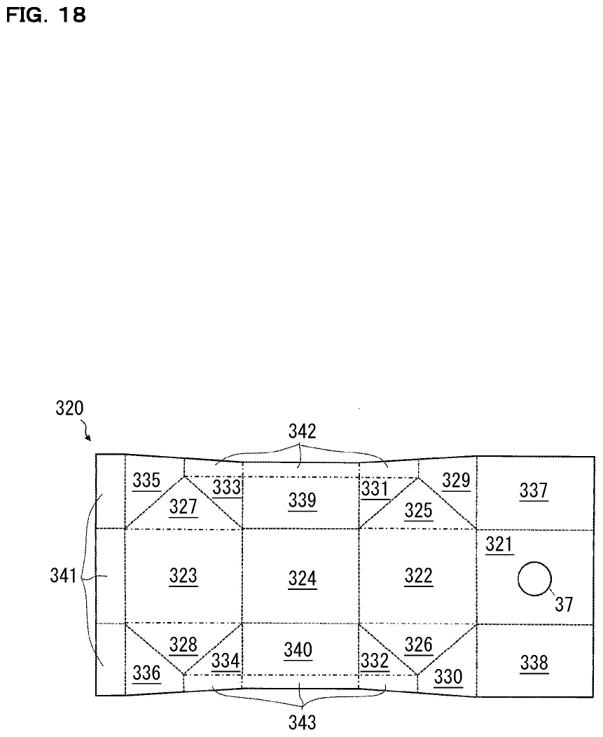

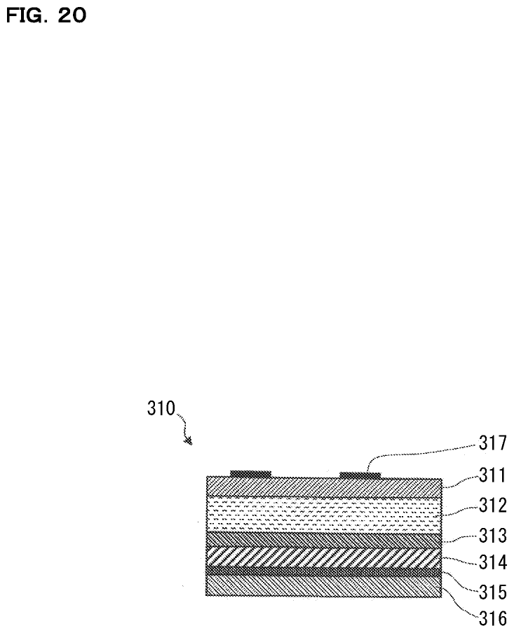

Hereinafter, a packaging container according to a third embodiment of the present invention will be described in detail with reference to the drawings. FIG. 16 is an explanatory perspective view showing the packaging container 31 according to the third embodiment of the present invention. In addition, FIG. 20 is a schematic cross-sectional view showing an example of the layer configuration of a laminate 310 used in the packaging container according to the present invention. Moreover, FIG. 18 is a schematic plan view showing a blank 320 for the packaging container shown in FIG. 16.

The packaging container 31 according to the third embodiment of the present invention is a packaging container obtained by shaping the laminate (sheet material) 310 having water-resistant synthetic resin films 311 and 316 attached to a front surface and a back surface of a paper layer 312, and is characterized by having a spout 36 on a top surface 32 and in that an end surface 38 of the laminate 310 is not present within a height of 3 mm from a bottom surface 33. In FIG. 16, the end surface 38 of the laminate 310 is represented by a double line.

In the example shown in FIG. 16, the actual height from the bottom surface 33 to the top surface 32 is 85 mm, and the height from the bottom surface 33 to the end surface 38 of the laminate 310 at a side surface is 25 mm. According to an experiment, it is found that, if the end surface of the laminate 310 is not present within a height of 3 mm from the bottom surface 33, even when the packaging container 31 is left at a wet place, permeation of water from the end surface of the laminate 310 is avoided.

Regarding the distance from the bottom surface 33 to the end surface of the laminate 310, a better result is obtained when the distance is ideally not less than 5 mm.

The shape of the packaging container 31 is not limited to a rectangular parallelepiped shape as in this example, and may be an optional shape such as a cube shape, a square column shape, and the shapes described above in the first and second embodiments and the modifications thereof.

In the example shown in FIG. 16, the spout 36 provided on the top surface 32 is a constant-discharge pump, and is capable of discharging a constant amount of contents by pushing an upper portion thereof once. The spout 36 is not limited to such a pump, and a general internal spout, external spout, spray spout, or the like is optionally selectable as the spout 36. In addition, in the case of a pump, a threaded flange is attached to the packaging container 31 side and the pump is attached thereto such that the pump is detachable therefrom, thereby allowing only the pump to be repeatedly used.

The laminate 310 used in the packaging container 31 preferably includes at least the front-surface synthetic resin film 311 on the front surface of the paper layer 312, and the back-surface synthetic resin film 316. In the example shown in FIG. 20, between the paper layer 312 and the back-surface synthetic resin film 316, the laminate 310 further includes a barrier layer 314, and includes a polyolefin resin layer 313 for bonding the paper layer 312 and the barrier layer 314, and an adhesive layer 315 for bonding the barrier layer 314 and the back-surface synthetic resin film 316. In addition, printing with ink 317 is performed on the front-surface synthetic resin film 311.

As the paper layer 312, thick paper such as milk carton base paper, card base paper, and various cardboards can be used. The paper appropriately has a basis weight of about 200 g/m² to 500 g/m² and a density of about 0.6 g/cm³ to 1.1 g/cm³. As the front-surface synthetic resin film 311, a low-density polyethylene resin (LDPE) and a linear low-density polyethylene resin (LLDPE) are preferable. Such a resin can be extruded and laminated onto the front surface of the paper layer 312. Corona treatment is preferably performed on the extruded surface in order to improve the adhesion of the ink when the printing is performed.

In the case of using the barrier layer 314, volatilization of contents is prevented, and the storage stability and the durability as a paper container are improved. As the barrier layer 314, a polyethylene terephthalate (PET) film having alumina, silica, aluminum, or the like vapor-deposited thereon is suitably used in addition to aluminum foil. The deposited layer preferably has a thickness of 5 nm to 100 nm, and the PET film preferably has a thickness of about 6 to 25 μm. In the case of using aluminum foil, the aluminum foil preferably has a thickness of about 5 to 15 μm.

As the method for bonding the paper layer 312 and an inner layer film including the barrier layer 314, the adhesive resin layer 313 is used in this example. As materials used for this purpose, a high-density polyethylene resin (HDPE), a low-density polyethylene resin (LDPE), a medium-density polyethylene resin (MDPE), a linear low-density polyethylene resin (LLDPE), an ethylene methacrylic acid copolymer resin (EMAA), an ethylene acrylic acid copolymer resin (EAA), an ionomer, a polypropylene resin (PP), and the like can be used.

The adhesive resin layer 313 preferably has a thickness of 10 μm to 60 μm. If the thickness is less than 10 μm, sufficient strength is generally not obtained. In order to enhance the adhesive strength, corona treatment, ozone treatment, or anchor coating treatment may be performed on the paper surface or the film surface to be bonded.

The back-surface synthetic resin film 316 is generally a layer called sealant layer, and a HDPE, a LDPE, a MDPE, and a LLDPE can be used therefor, but a LLDPE is most preferable. In particular, those having a density of 0.925 or less and a melt index of 4 or greater are preferable. There may be a layer partially containing polybutene. The back-surface synthetic resin film 316 appropriately has a thickness of 30 μm to 100 μm, and is formed by a T-die method or an inflation method.

The barrier layer 314 and the back-surface synthetic resin film 316 may be attached together in advance to form an interior film. As the attaching method in this case, a dry laminate adhesive or a non-solvent laminate adhesive is used. An application amount of the adhesive is 0.5 to 7.0 g/m². The barrier layer 314 and the back-surface synthetic resin film 316 may be attached together by extrusion using the adhesive resin layer described above.

Each of the front-surface and back-surface synthetic plastic resin films 311 and 316 is not limited to a single layer, and may be composed of a plurality of layers, and the material of the frontmost surface and the material of the backmost surface thereof are desirably the same or similar to each other such that, when shaping the packaging container 31, these surfaces are heated and welded.

A method for shaping the packaging container 31 will be described with reference to FIG. 18. FIG. 18 shows a state of the blank for the packaging container 31 shown in FIG. 16, as seen from the front surface side (outer surface side). In the drawing, dotted lines represent mountain fold ruled lines, and alternate long and short dash lines represent valley fold ruled lines.

Describing the blank 320 shown in FIG. 18, a top surface plate 321 having a spout attachment hole 37, a side surface plate 322, a bottom surface plate 324, a side surface plate 323, and a gluing margin 341 are continuously provided with mountain fold ruled lines interposed therebetween. Side surface rectangular plates 337 and 338 are continuously provided on the left and right of the top surface plate 321 with mountain fold ruled lines interposed therebetween, and side surface rectangular plates 339 and 340 are continuously provided on the left and right of the bottom surface plate 324.

Side surface triangular plates 325 and 326 and side surface triangular plates 327 and 328 are continuously provided on the left and right of the side surface plates 322 and 323, respectively, with valley fold ruled lines interposed therebetween. Side surface to-be-folded plates 329 to 336 are continuously provided on respective sides, of the side surface triangular plates 325 to 328, which are not in contact with the side surface plates, with mountain fold ruled lines interposed therebetween.

A side surface gluing margin 342 is continuously provided to the side surface to-be-folded plates 331 and 333 and the side surface rectangular plate 339 with a valley fold ruled line interposed therebetween, and a side surface gluing margin 343 is continuously provided to the side surface to-be-folded plates 332 and 334 and the side surface rectangular plate 340 with a valley fold ruled line interposed therebetween.

To shape the packaging container 31 shown in FIG. 16 from the blank 320 shown in FIG. 18, first, a mountain fold is made at all the ruled lines in the vertical direction, the gluing margin 341 is heat-sealed to the back surfaces of the top surface plate 321 and the side surface rectangular plates 337 and 338 to form a square column shape. Next, the side surface gluing margin 342 is brought into contact with and heat-sealed to the side surface rectangular plate 337 and the side surface to-be-folded plates 329 and 335 opposing the side surface gluing margin 342. Folding is performed such that a mountain fold is made at all the ruled lines on the outer peripheries of the side surface triangular plates 325 and 327, and heat-sealing is performed to form a folded side surface 35. Next, for the side surface gluing margin 343 at the opposite side, shaping is performed and a folded side surface 35 is formed in the same manner.

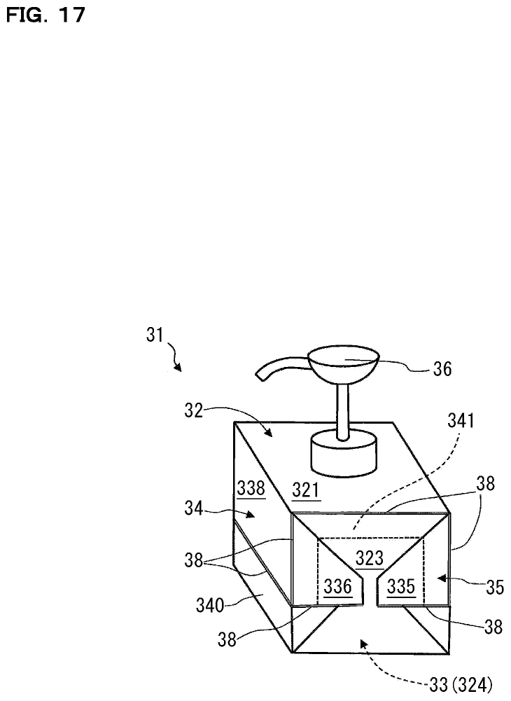

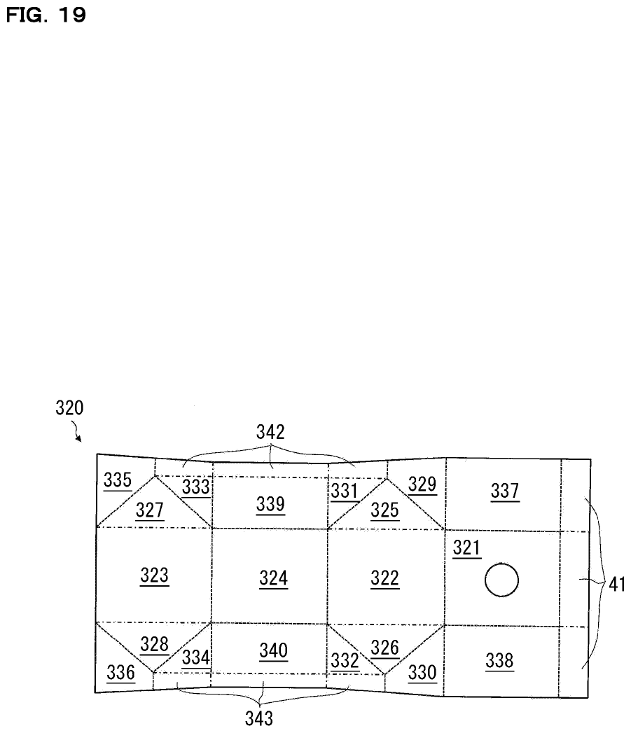

FIG. 17 is an explanatory perspective view showing another embodiment of the packaging container 31 according to the present invention. The packaging container 31 shown in FIG. 17 is a packaging container shaped from a blank 320 shown in FIG. 19. In FIG. 17 as well, the end surface of the laminate 310 is represented by a double line. The difference from the packaging container 31 shown in FIG. 16 is that, whereas the gluing margin 341 is folded under the top surface plate 321 in the example in FIG. 16, the gluing margin 341 is folded under the side surface plate 323 in the example in FIG. 17.

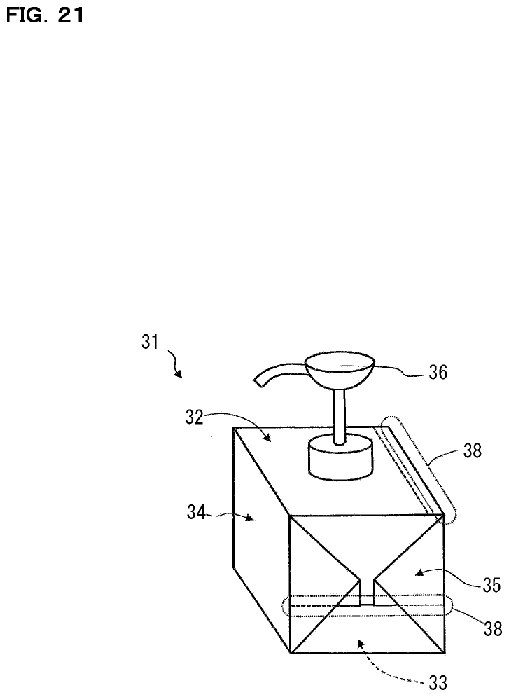

FIG. 21 is an explanatory perspective view showing still another embodiment of the packaging container 31 according to the present invention. In this example, the side surface to-be-folded plates 329 to 336, which are folded to the folded side surfaces 35 of the packaging container 31 shown in FIG. 16, are folded to side surfaces 34.

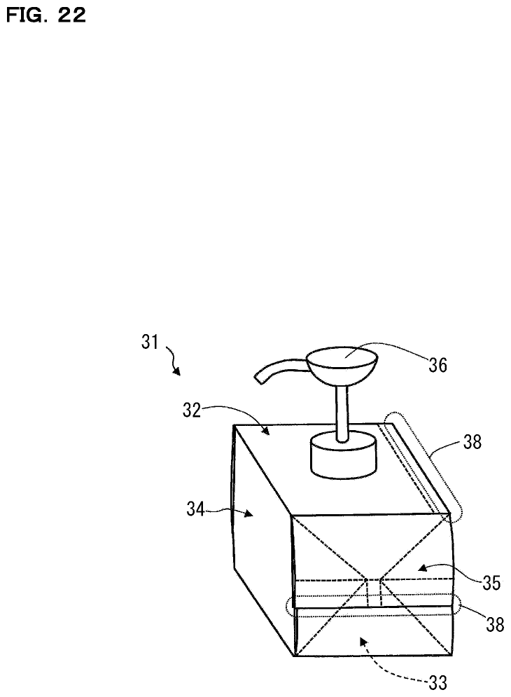

FIG. 22 is an explanatory perspective view showing still another embodiment of the packaging container 31 according to the present invention. In this example, the arrangement of the top surface plate 321, the side surface plates 322 and 323, and the bottom surface plate 324 is not changed, but a valley fold is made at the two sides, of each of the side surface triangular plates 325 to 328, which are not in contact with the side surface plate 322 or 323, and the side surface triangular plates 325 to 328 are folded under the side surface rectangular plates 337 to 340.

As described above, the container shape of the packaging container according to the present invention is not particularly limited, and the purpose thereof can be achieved as long as the end surface of the laminate 310 after shaping is located at a height greater than 3 mm from the bottom surface 33.

As described above, the packaging container 31 includes the water-resistant layers on the front and back surfaces of the paper, and the end surface of the paper is not present within a height of 3 mm from the bottom surface. Thus, even when the packaging container 31 is put at a location at which the packaging container 31 gets wet, water does not soak into the packaging container 31 through the front and back surfaces and the end surface of the paper. Thus, the packaging container 31 can be used in applications such as use in a bathroom.

Moreover, no special components other than the spout are used for the packaging container 31, and thus the packaging container 31 is excellent in cost. Thus, when the contents are used up, the packaging container 31 can be thrown away, so that time and effort for refilling can be omitted. In addition, the packaging container 31 has all the advantages of a paper container such as being able to be discarded or recycled as a paper container when the use of the packaging container 31 ceases.

Furthermore, when the shape of the packaging container 31 is a rectangular parallelepiped shape, it is also easy to shape the container itself, and there are effects such as saving a space for placing the packaging container 31 in use.

Furthermore, when the packaging container 31 includes a pump as the spout, the packaging container 31 can be used in many applications such as shampoos, conditioners, and body soaps used in a bathroom.

Furthermore, when the laminate 310 used in the packaging container 31 includes a barrier layer that prevents permeation of water vapor and oxygen, the long-term storage stability and the durability are improved in the stage of a product or the stage of use.

### Fourth Embodiment

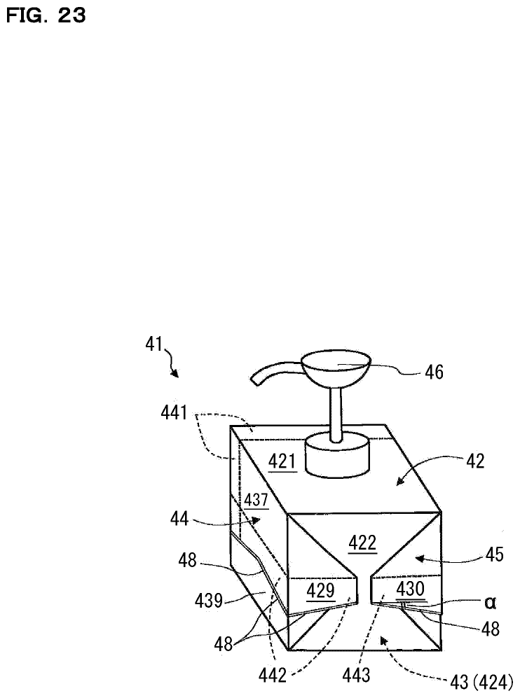

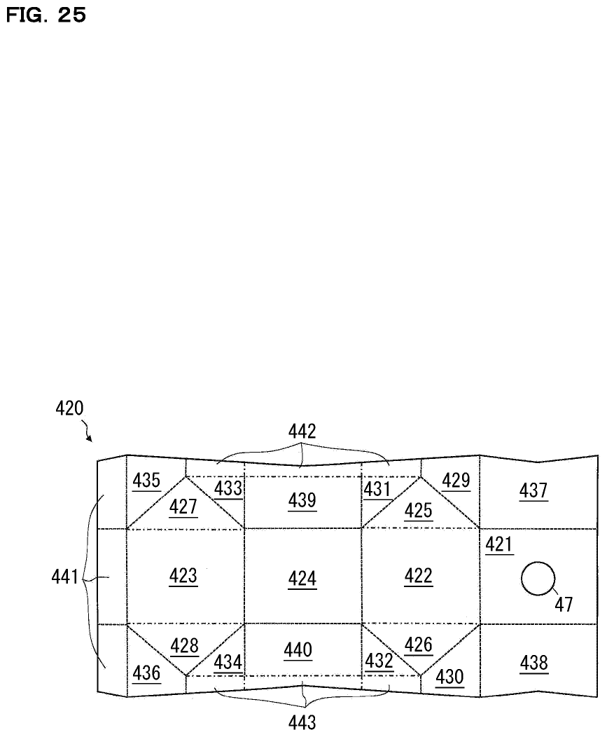

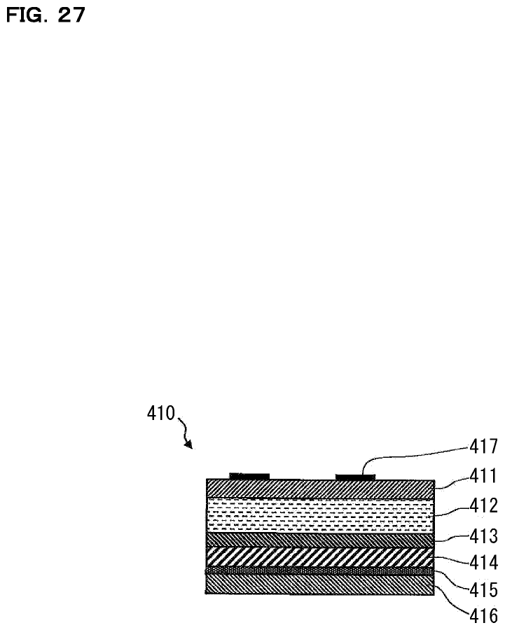

Hereinafter, a packaging container according to a fourth embodiment of the present invention will be described in detail with reference to the drawings. FIG. 23 is an explanatory perspective view showing the packaging container 41 according to the fourth embodiment of the present invention. In addition, FIG. 27 is a schematic cross-sectional view showing an example of the layer configuration of a laminate 410 used in the packaging container according to the present invention. Moreover, FIG. 25 is a schematic plan view showing a blank 420 for the packaging container shown in FIG. 23.

The packaging container 41 according to the fourth embodiment of the present invention is a packaging container obtained by shaping the laminate (sheet material) 410 having water-resistant synthetic resin films 411 and 416 attached to a front surface and a back surface of a paper layer 412, and is characterized by having a spout 46 on a top surface 42 and in that an end surface 48 of the laminate 410 is not present within a height of 3 mm from a bottom surface 43 and the end surface of the laminate 410 has a portion inclined relative to the bottom surface 43. In FIG. 23, the inclined end surface 48 of the laminate 410 is represented by a double line.

In the example shown in FIG. 23, the actual height from the bottom surface 43 to the top surface 42 is 85 mm, and the height from the bottom surface 43 to the end surface 48 of the laminate 410 at a side surface is 25 mm. According to an experiment, it is found that, if the end surface of the laminate 410 is not present within a height of 3 mm from the bottom surface 43, even when the packaging container 41 is left at a wet place, permeation of water from the end surface of the laminate 410 is avoided.

Regarding the distance from the bottom surface 43 to the end surface of the laminate 410, a better result is obtained when the distance is ideally not less than 5 mm.

In the example shown in FIG. 23, the entire end surface of the laminate 410 is inclined relative to the bottom surface 43, and the angle (a) thereof relative to the bottom surface 43 is about 3°.

The shape of the packaging container 41 is not limited to a rectangular parallelepiped shape as in this example, and may be an optional shape such as a cube shape, a square column shape, and the shapes described above in the first and second embodiments and the modifications thereof.

In the example shown in FIG. 23, the spout 46 provided on the top surface 42 is a constant-discharge pump, and is capable of discharging a constant amount of contents by pushing an upper portion thereof once. The spout 46 is not limited to such a pump, and a general internal spout, external spout, spray spout, or the like is optionally selectable as the spout 46. In addition, in the case of a pump, a threaded flange is attached to the packaging container 41 side and the pump is attached thereto such that the pump is detachable therefrom, thereby allowing only the pump to be repeatedly used.

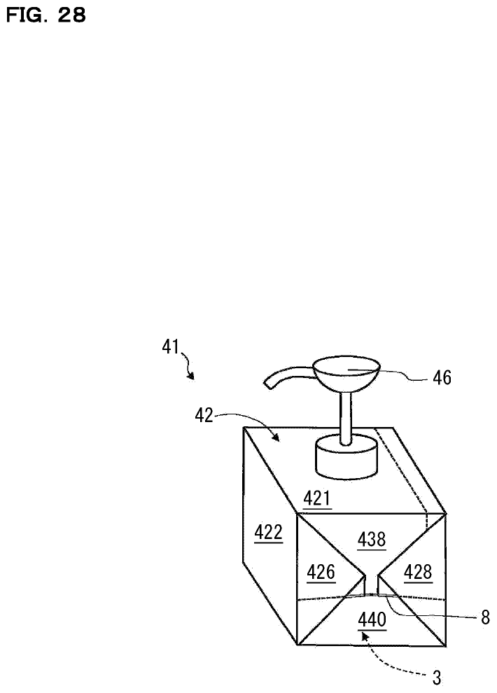

The laminate 410 used in the packaging container 41 preferably includes at least the front-surface synthetic resin film 411 on the front surface of the paper layer 412, and the back-surface synthetic resin film 416. In the example shown in FIG. 28, between the paper layer 412 and the back-surface synthetic resin film 416, the laminate 410 further includes a barrier layer 414, and includes a polyolefin resin layer 413 for bonding the paper layer 412 and the barrier layer 414, and an adhesive layer 415 for bonding the barrier layer 414 and the back-surface synthetic resin film 416. In addition, printing with ink 417 is performed on the front-surface synthetic resin film 411.

As the paper layer 412, thick paper such as milk carton base paper, card base paper, and various cardboards can be used. The paper appropriately has a basis weight of about 200 g/m² to 500 g/m² and a density of about 0.6 g/cm³ to 1.1 g/cm³. As the front-surface synthetic resin film 411, a low-density polyethylene resin (LDPE) and a linear low-density polyethylene resin (LLDPE) are preferable. Such a resin can be extruded and laminated onto the front surface of the paper layer 412. Corona treatment is preferably performed on the extruded surface in order to improve the adhesion of the ink when the printing is performed.

In the case of using the barrier layer 414, volatilization of contents is prevented, and the storage stability and the durability as a paper container are improved. As the barrier layer 414, a polyethylene terephthalate (PET) film having alumina, silica, aluminum, or the like vapor-deposited thereon is suitably used in addition to aluminum foil. The deposited layer preferably has a thickness of 5 nm to 100 nm, and the PET film preferably has a thickness of about 6 to 25 μm. In the case of using aluminum foil, the aluminum foil preferably has a thickness of about 5 to 15 μm.

As the method for bonding the paper layer 412 and an inner layer film including the barrier layer 414, the adhesive resin layer 413 is used in this example. As materials used for this purpose, a high-density polyethylene resin (HDPE), a low-density polyethylene resin (LDPE), a medium-density polyethylene resin (MDPE), a linear low-density polyethylene resin (LLDPE), an ethylene methacrylic acid copolymer resin (EMAA), an ethylene acrylic acid copolymer resin (EAA), an ionomer, a polypropylene resin (PP), and the like can be used.

The adhesive resin layer 413 preferably has a thickness of 10 μm to 60 μm. If the thickness is less than 10 μm, sufficient strength is generally not obtained. In order to enhance the adhesive strength, corona treatment, ozone treatment, or anchor coating treatment may be performed on the paper surface or the film surface to be bonded.

The back-surface synthetic resin film 416 is generally a layer called sealant layer, and a HDPE, a LDPE, a MDPE, and a LLDPE can be used therefor, but a LLDPE is most preferable. In particular, those having a density of 0.925 or less and a melt index of 4 or greater are preferable. There may be a layer partially containing polybutene. The back-surface synthetic resin film 416 appropriately has a thickness of 30 μm to 100 μm, and is formed by a T-die method or an inflation method.

The barrier layer 414 and the back-surface synthetic resin film 416 may be attached together in advance to form an interior film. As the attaching method in this case, a dry laminate adhesive or a non-solvent laminate adhesive is used. An application amount of the adhesive is 0.5 to 7.0 g/m². The barrier layer 414 and the back-surface synthetic resin film 416 may be attached together by extrusion using the adhesive resin layer described above.

Each of the front-surface and back-surface synthetic plastic resin films 411 and 416 is not limited to a single layer, and may be composed of a plurality of layers, and the material of the frontmost surface and the material of the backmost surface thereof are desirably the same or similar to each other such that, when shaping the packaging container 41, these surfaces are heated and welded.

A method for shaping the paper container will be described with reference to FIG. 25. FIG. 25 shows a state of the blank for the packaging container shown in FIG. 23, as seen from the front surface side (outer surface side). In the drawing, dotted lines represent mountain fold ruled lines, and alternate long and short dash lines represent valley fold ruled lines.

Describing the blank 420 shown in FIG. 25, a top surface plate 421 having a spout attachment hole 47, a side surface plate 422, a bottom surface plate 424, a side surface plate 423, and a gluing margin 441 are continuously provided with mountain fold ruled lines interposed therebetween. Side surface rectangular plates 437 and 438 are continuously provided on the left and right of the frontal plate 421 with mountain fold ruled lines interposed therebetween, and side surface rectangular plates 439 and 440 are continuously provided on the left and right of the bottom surface plate 424.

Side surface triangular plates 425 and 426 and side surface triangular plates 427 and 428 are continuously provided on the left and right of the side surface plates 422 and 423, respectively, with valley fold ruled lines interposed therebetween. Side surface to-be-folded plates 429 to 436 are continuously provided on respective sides, of the side surface triangular plates 425 to 428, which are not in contact with the side surface plates, with mountain fold ruled lines interposed therebetween.

A side surface gluing margin 442 is continuously provided to the side surface to-be-folded plates 431 and 433 and the side surface rectangular plate 439 with a valley fold ruled line interposed therebetween, and a side surface gluing margin 443 is continuously provided to the side surface to-be-folded plates 432 and 434 and the side surface rectangular plate 440 with a valley fold ruled line interposed therebetween.

To shape the packaging container 41 shown in FIG. 23 from the blank 420 shown in FIG. 25, first, a mountain fold is made at all the ruled lines in the vertical direction, the gluing margin 441 is heat-sealed to the back surfaces of the top surface plate 421 and the side surface rectangular plates 437 and 438 to form a square column shape. Next, the side surface gluing margin 442 is brought into contact with and heat-sealed to the side surface rectangular plate 437 and the side surface to-be-folded plates 429 and 435 opposing the side surface gluing margin 442. Folding is performed such that a mountain fold is made at all the ruled lines on the outer peripheries of the side surface triangular plates 425 and 427, and heat-sealing is performed to form a folded side surface 45. Next, for the side surface gluing margin 443 at the opposite side, shaping is performed and a folded side surface 45 is formed in the same manner.

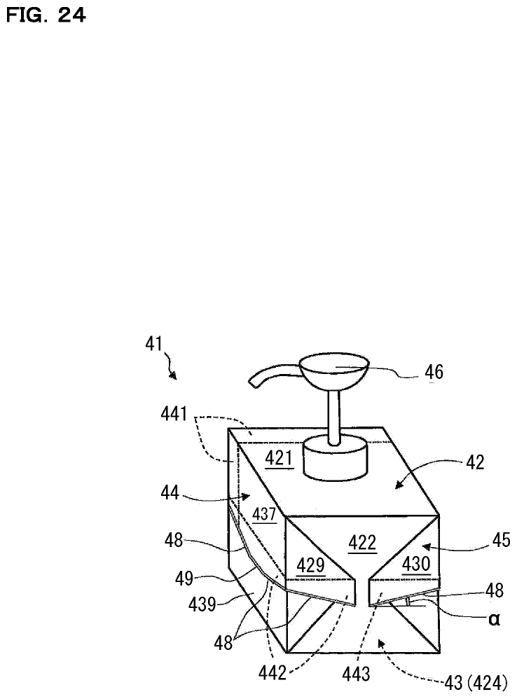

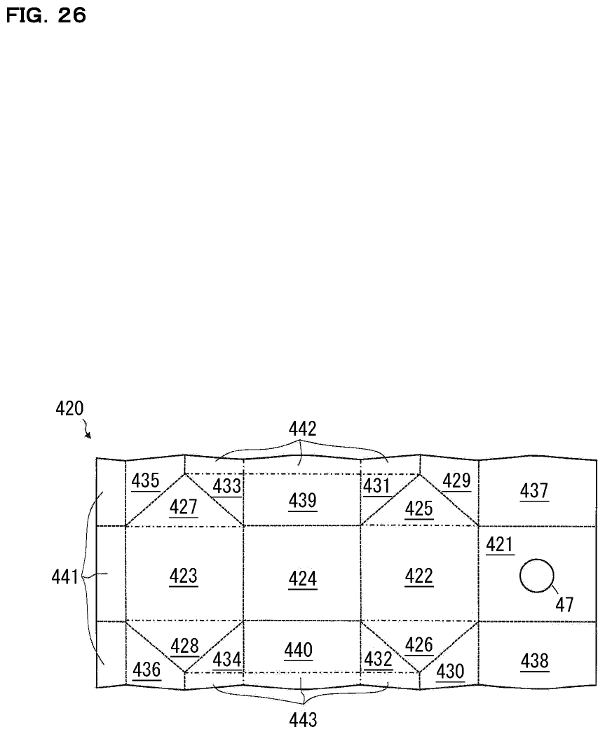

FIG. 24 is an explanatory perspective view showing another embodiment of the packaging container 41 according to the present invention. The packaging container 41 shown in FIG. 24 is a packaging container shaped from a blank 420 shown in FIG. 26. In FIG. 24 as well, the end surface of the laminate 410 is represented by a double line. In the packaging container 41 shown in FIG. 24, most of the end surface of the laminate 410 is inclined relative to the bottom surface 43, and the end surface of the laminate 410 includes a horizontal portion 49. In addition, the direction in which the end surface of the laminate 410 is inclined is opposite to that in the example shown in FIG. 23. Moreover, the angle (a) of inclination is 5°.

When the horizontal portion is left in the end surface of the laminate 410 as described above, the horizontal portion desirably has a length of 15 mm or less.

The folding structure of the laminate 410 of the packaging container 41 according to the fourth embodiment of the present invention is not particularly limited. For example, in an example shown in FIG. 28, the side surface to-be-folded plates 429 and 430, which are folded toward the folded side surfaces 45 in the packaging container 41 shown in FIG. 23, are folded to the side surface 44 side. In the example shown in FIG. 28, a side surface plate 422 on which no end surface is exposed and no fold is made is obtained.

As described above, the packaging container 41 includes the water-resistant layers on the front and back surfaces of the laminate 410, and the end surface of the paper is not present within a height of 3 mm from the bottom surface. Thus, even when the packaging container 41 is put at a location at which the packaging container 41 gets wet, water does not soak into the packaging container 41 through the front and back surfaces and the end surface of the paper. Thus, the packaging container 41 can be used in applications such as use in a bathroom.

Moreover, since the end surface of the laminate 410 has portions inclined relative to the bottom surface, even if water is splashed onto the container from above, the water that has reached the end surface of the paper flows along the inclined end surface and does not accumulate at the end surface. Thus, there is no concern that the end surface of the paper is exposed to water for a long period of time.

Moreover, no special components other than the spout are used for the packaging container 41, and thus the packaging container 41 is excellent in cost. Thus, when the contents are used up, the packaging container 41 can be thrown away, so that time and effort for refilling can be omitted. In addition, the packaging container 41 has all the advantages of a paper container such as being able to be discarded or recycled as a paper container when the use of the packaging container 41 ceases.

Moreover, when the entirety of the end surface of the laminate 410 is inclined relative to the bottom surface, accumulation of water at the end surface of the paper is minimized, and the water drainage is good.

Furthermore, when the shape of the container 41 is a rectangular parallelepiped shape, it is also easy to shape the container itself, and there are effects such as saving a space for placing the container 41 in use.

When the packaging container 41 includes a pump at the spout, the packaging container 41 can be used in many applications such as shampoos, conditioners, and body soaps used in a bathroom.

### Fifth Embodiment

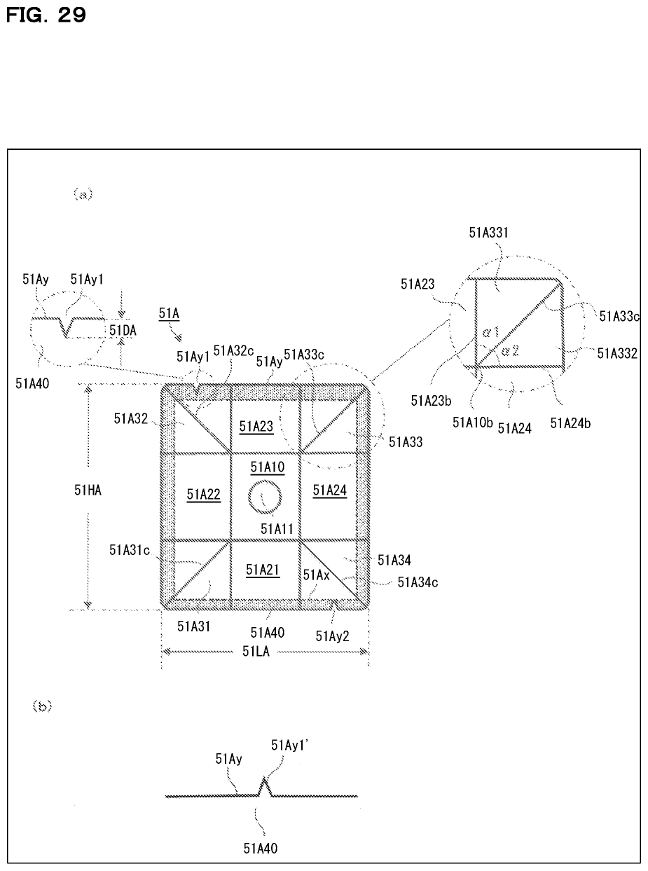

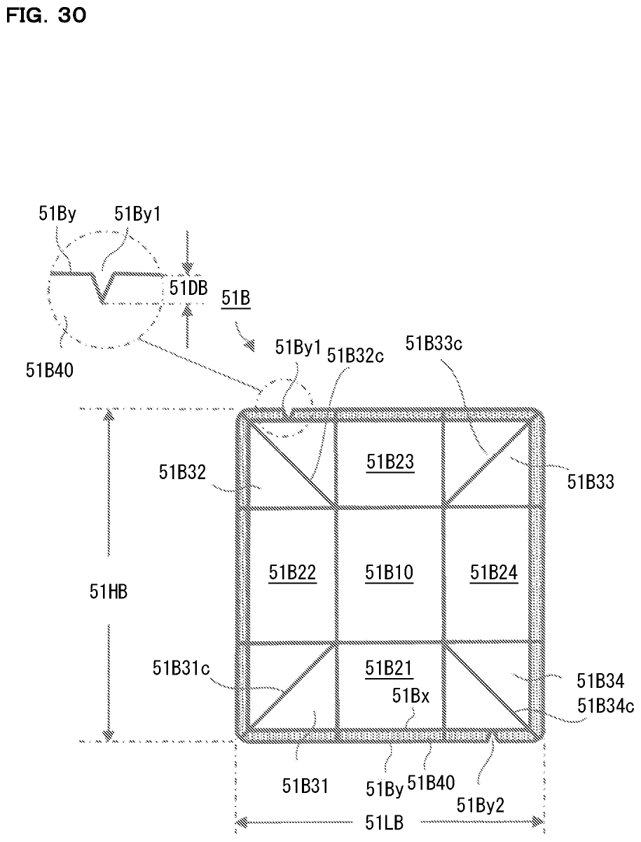

Hereinafter, a packaging container according to a fifth embodiment of the present invention will be described with reference to the drawings. FIGS. 29 to 32 are diagrams showing the packaging container 51 according to the fifth embodiment of the present invention and sheet materials for forming the packaging container 51, and FIG. 29 and FIG. 30 show a top-side sheet 51A and a bottom-side sheet 51B, respectively.

First, the top-side sheet 51A has a polygonal top surface 51A10 at the center thereof. In this example, the top surface 51A10 is rectangular. An opening 51A11 is provided in the top surface 51A10. A plug can be mounted on the opening 51A11 in advance.

Next, the top-side sheet 51A has tetragonal top-side side surfaces 51A21 to 51A24 each having one side that is one of the sides of the top surface 51A10, with each side of the polygonal top surface 51A10 as a bending ruled line. The number of the top-side side surfaces 51A21 to 51A24 is equal to the number of the sides of the polygonal top surface 51A10. In this example, since the top surface 51A10 has a tetragonal shape, the number of the sides of the tetragonal top surface 51A10 is four, and the number of the sides of each of the top-side side surfaces 51A21 to 51A24 is also four.

In addition, the top-side sheet 51A has, between the respective top-side side surfaces adjacent to each other, top-side connection pieces 51A31 to 51A34 that connect the top-side side surfaces 51A21 to 51A24 to each other. That is, the top-side side surface 51A21 and the top-side side surface 51A22 are connected to each other by the top-side connection piece 51A31. In addition, the top-side side surface 51A22 and the top-side side surface 51A23 are connected to each other by the top-side connection piece 51A32. The same applies to the other top-side side surfaces. Bending ruled lines are provided between the respective top-side side surfaces 51A21 to 51A24 and the respective top-side connection pieces 51A31 to 51A34.

The gaps between the top-side side surfaces 51A21 to 51A24 are closed by the top-side connection pieces 51A31 to 51A34. As shown, in this example, the outer shape of a portion obtained by combining the top-side side surfaces 51A21 to 51A24 with the top-side connection pieces 51A31 to 51A34 is a rectangle, and the respective top-side connection pieces 51A31 to 51A34 are located at the corners of the rectangle and close the gaps between the top-side side surfaces 51A21 to 51A24. For example, the gap between the top-side side surface 51A21 and the top-side side surface 51A22 is closed by the top-side connection piece 51A31.

The top-side connection pieces 51A31 to 51A34 have top-side double-folding ruled lines that extend from the respective vertexes of the top surface 51A10 so as to bisect the top-side connection pieces 51A31 to 51A34. That is, as shown in FIG. 29 in an enlarged manner, for example, the top-side side surface 51A23 and the top-side side surface 51A24 share a vertex 51A10b of the top surface 51A10. Of the sides that form the top-side side surface 51A23, the side that shares the vertex 51A10b of the top surface 51A10 is designated by reference character 51A23b. In addition, of the sides that form the top-side side surface 51A24, the side that shares the vertex 51A10b of the top surface 51A10 is designated by reference character 51A24b. A top-side double-folding ruled line 51A33c that bisects the angle formed by the side 51A23b and the side 51A24b is provided. That is, in the drawing, the angle α1 formed by the side 51A23b and the double-folding ruled line 51A33c is equal to the angle α2 formed by the side 51A24b and the top-side double-folding ruled line 51A33c. Although the top-side double-folding ruled line 51A33c has been described above with the top-side connection piece 51A33 as an example, top-side double-folding ruled lines 51A31c, 51A32c, and 51A34c are also similarly provided on the other top-side connection pieces 51A31, 51A32, and 51A34.

Next, the top-side sheet 51A has, at the outer side of the rectangular portion obtained by combining the top-side side surfaces 51A21 to 51A24 with the top-side connection pieces 51A31 to 51A34, a top-side fixing portion 51A40 at which the top-side sheet 51A is to be fixed to the bottom-side sheet 51B. In this example, the top-side fixing portion 51A40 is formed as a heat-seal region over the entire periphery. When both the top-side sheet 51A and the bottom-side sheet 51B are formed by one sheet as in a later-described modification, a part of the top-side fixing portion 51A40 can be formed as a bending ruled line 51AB that partitions the top-side sheet 51A and the bottom-side sheet 51B.

As seen from the drawing, an edge 51Ay of the top-side fixing portion 51A40 forms the contour line of the top-side fixing portion 51A40 and also forms the edge (contour line) of the top-side sheet 51A. In this example, the shape of the edge 51Ay of the top-side sheet 51A is substantially a rectangle, and the corners thereof are chamfered to remove sharp portions.

For alignment when overlaying with the bottom-side sheet 51B, alignment marks 51Ay1 and 51Ay2 are provided at two locations on the edge 51Ay of the top-side fixing portion 51A40. Each of the alignment marks 51Ay1 and 51Ay2 is formed by a recess that is recessed inward from the edge 51Ay, and the depth 51DA thereof needs to be not less than 0.5 mm. When the depth 51DA of any one of the alignment marks 51Ay1 and 51Ay2 is less than 0.5 mm, alignment cannot be ensured, and thus distortion easily occurs in the packaging container 51 that is brought into the box state, as seen from later-described examples. Each of the depths 51DA of the alignment marks 51Ay1 and 51Ay2 is desirably not less than 1.0 mm.

Each of the alignment marks 51Ay1 and 51Ay2 can be formed by a projection that projects outward from the edge 51Ay. In this case, the height of the projection needs to be not less than 0.5 mm. The height of the projection is desirably not less than 1.0 mm.

One of at least the two alignment marks 51Ay1 and 51Ay2 can be formed by a recess, and the other mark can be formed by a projection. In addition, as a matter of course, three or more alignment marks may be provided.

In FIG. 29, for convenience of explanation, the top-side fixing portion 51A40 is shown by hatching, and the boundaries between the top-side fixing portion 51A40 and the top-side side surfaces 51A21 to 51A24 and the boundaries between the top-side fixing portion 51A40 and the top-side connection pieces 51A31 to 51A34 are shown by a broken line 51Ax. Unlike a boundary 51Bx between a bottom-side fixing portion 51B40 and bottom-side side surfaces 51B21 to 51B24 of the bottom-side sheet 51B described later, no bending ruled line is present at the boundaries between the top-side fixing portion 51A40 and the top-side side surfaces 51A21 to 51A24. Also, no bending ruled line is present at the boundaries between the top-side fixing portion 51A40 and the top-side connection pieces 51A31 to 51A34.

Next, the bottom-side sheet 51B has the same structure as the top-side sheet 51A. Specifically, the bottom-side sheet 51B has a polygonal bottom surface 51B10 at the center thereof. The polygonal bottom surface 51B10 has the same shape and the same size as (is congruent to) the top surface 51A10.

Moreover, the bottom-side sheet 51B has the tetragonal bottom-side side surfaces 51B21 to 51B24 each having one side that is one of the sides of the polygonal bottom surface 51B10, with each side of the bottom surface 51B10 as a bending ruled line, and the number of the bottom-side side surfaces 51B21 to 51B24 is equal to the number of the sides of the polygonal bottom surface 51B10. These bottom-side side surfaces 51B21 to 51B24 also have the same shape and the same size as the top-side side surfaces 51A21 to 51A24, respectively.

Furthermore, the bottom-side sheet 51B has, between the respective bottom-side side surfaces 51B21 to 51B24 adjacent to each other, bottom-side connection pieces 51B31 to 51B34 that connect the bottom-side side surfaces 51B21 to 51B24 to each other and also close the gaps therebetween. These bottom-side connection pieces 51B31 to 51B34 have the same shape and the same size as the top-side connection pieces 51A31 to 51A34.

Furthermore, bending ruled lines are provided between the respective bottom-side side surfaces 51B21 to 51B24 and the respective bottom-side connection pieces 51B31 to 51B34. In addition, bottom-side double-folding ruled lines 51B31c to 51B34c that extend from the respective vertexes of the bottom surface 51B10 so as to bisect the bottom-side connection pieces 51B31 to 51B34 are provided on the respective bottom-side connection pieces 51B31 to 51B34.

Next, the bottom-side sheet 51B has, at the outer side of a rectangular portion obtained by combining the bottom-side side surfaces 51B21 to 51B24 with the bottom-side connection pieces 51B31 to 51B34, the bottom-side fixing portion 51B40 at which the bottom-side sheet 51B is to be fixed to the top-side sheet 51A. In this example, the bottom-side fixing portion 51B40 is a heat-seal region over the entire periphery.

As seen from the drawing, a contour line 51By of the bottom-side fixing portion 51B40 forms the contour line of the bottom-side fixing portion 51B40 and also forms the edge (contour line) of the bottom-side sheet 51B. In this example, the outer shape of the bottom-side fixing portion 51B40 is substantially a rectangle.

The outer shape of the bottom-side sheet 51B is formed so as to be smaller than the outer shape of the top-side sheet 51A, as an example.

In FIG. 29, reference character 51LA denotes the length in the horizontal direction of the top-side sheet 51A, and in FIG. 30, reference character 51LB denotes the length in the horizontal direction of the bottom-side sheet 51B. The difference therebetween, that is, the difference between the length 51LA in the horizontal direction of the top-side sheet 51A and the length 51LB in the horizontal direction of the bottom-side sheet 51B, is desirably not less than 0.6 mm. When the top-side sheet 51A and the bottom-side sheet 51B are aligned with and overlaid on each other as described later, if the difference between the length 51LA in the horizontal direction of the top-side sheet 51A and the length 51LB in the horizontal direction of the bottom-side sheet 51B is not less than 0.6 mm, both sheets 51A and 51B are arranged such that the edges thereof are displaced relative to each other by 0.3 mm or greater. Accordingly, the edge 51By of the bottom-side sheet 51B is covered with the top-side sheet 51A, and thus is not exposed. Even when a slight positional displacement occurs between the top-side sheet 51A and the bottom-side sheet 51B, the edge 51By of the bottom-side sheet 51B does not become exposed. The difference between the length 51LA in the horizontal direction of the top-side sheet 51A and the length 51LB in the horizontal direction of the bottom-side sheet 51B is desirably not less than 1.0 mm.

Moreover, in FIG. 29, reference character 51HA denotes the length in the vertical direction of the top-side sheet 51A, and in FIG. 30, reference character 51HB denotes the length in the vertical direction of the bottom-side sheet 51B. The difference therebetween, that is, the difference between the length 51HA in the vertical direction of the top-side sheet 51A and the length 51HB in the vertical direction of the bottom-side sheet 51B, is also desirably not less than 0.6 mm. This difference is also desirably not less than 1.0 mm.

When the length of the top-side sheet 51A is longer than the length of the bottom-side sheet 51B in both the vertical direction and the horizontal direction, the length of the top-side sheet 51A is longer than the length of the bottom-side sheet 51B in any direction. Thus, even when a slight positional displacement occurs at any position on the entire periphery, the edge 51BY of the bottom-side sheet 51B does not become exposed.

A bending ruled line 51Bx is provided at the boundaries between the bottom-side fixing portion 51B40 and the bottom-side side surfaces 51B21 to 51B24 of the bottom-side sheet 51B and the boundaries between the bottom-side fixing portion 51B40 and the bottom-side connection pieces 51B31 to 51B34. Since no bending ruled line is present at the boundary of the top-side fixing portion 51A40 of the top-side sheet 51A, when both sheets 51A and 51B are overlaid on and fixed to each other and brought into a box state, both fixing portions 51A40 and 51B40 fixed to each other are bent toward the bottom-side sheet 51B side due to the bending ruled line 51Bx, and the outer side thereof is covered with the top-side sheet 51A. Thus, also, in the box state, the edge 51By of the bottom-side sheet 51B is not exposed on the outer surface of the packaging container 51.

Meanwhile, for alignment when overlaying with the top-side sheet 51A, alignment marks 51By1 and 51By2 are provided at two locations on the edge 51By of the bottom-side fixing portion 51B40.

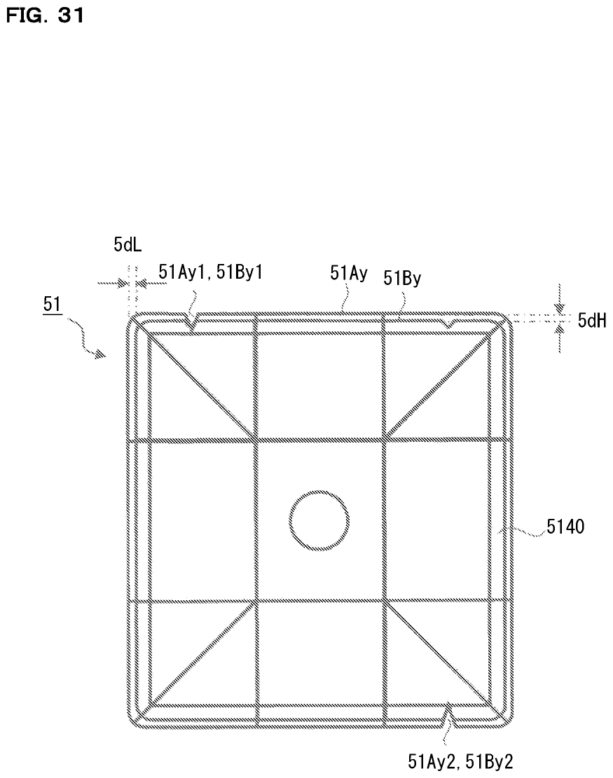

The two alignment marks 51By1 and 51By2 need to be located at positions corresponding to the alignment marks 51Ay1 and 51Ay2 of the top-side sheet 51A. That is, both alignment marks 51Ay1 and 51Ay2 and both alignment marks 51By1 and 51By2 are located at the same positions when the top-side sheet 51A and the bottom-side sheet 51B are accurately aligned with and overlaid on each other. In this example, since the outer shape of the bottom-side sheet 51B is formed so as to be smaller than the outer shape of the top-side sheet 51A, when the bottom-side sheet 51B is overlaid on the top-side sheet 51A, the two alignment marks 51Ay1 and 51Ay2 of the top-side sheet 51A are seen at the outer side of the edge 51By of the bottom-side sheet 51B as shown in FIG. 31. As a matter of course, the two alignment marks 51By1 and 51By2 of the bottom-side sheet 51B are seen, and thus it is easy to align both alignment marks 51Ay1 and 51Ay2 and both alignment marks 51By1 and 51By2 with each other. Then, by aligning both alignment marks 51Ay1 and 51Ay2 and both alignment marks 51By1 and 51By2 with each other, the top-side sheet 51A and the bottom-side sheet 51B can be accurately aligned with each other.

Similar to the alignment marks 51Ay1 and 51Ay2, each of the alignment marks 51By1 and 51By2 can be formed by a recess that is recessed inward from the edge 51By, or by a projection that projects outward from the edge 51Ay. When each of the alignment marks 51By1 and 51By2 is formed by a recess, each of the depths 51DB of the alignment marks 51By1 and 51By2 needs to be not less than 0.5 mm, and is desirably not less than 1 mm, similar to the alignment marks 51Ay1 and 51Ay2. When each of the alignment marks 51By1 and 51By2 is formed by a projection, the height of the projection needs to be not less than 0.5 mm and is desirably not less than 1 mm. One of the alignment marks 51By1 and 51By2 may be formed by a recess, and the other alignment mark may be formed by a projection, or three or more alignment marks may be provided.

The packaging container 51 can be produced as described below.

Specifically, first, the packaging container 51 in the flat state can be produced by aligning and overlaying the top-side sheet 51A and the bottom-side sheet 51B on each other and heat-sealing both fixing portions 51A40 and 51B40 to each other (see FIG. 31). Since the width of the bottom-side fixing portion 51B40 is smaller than that of the top-side fixing portion 51A40, the fixing portions 51A40 and 51B40 does not need to be heat-sealed over the entire width, but are desirably heat-sealed such that the fixing portions 51A40 and 51B40 are fixed to each other over the entire periphery. Hereinafter, a portion formed by heat-sealing both fixing portions 51A40 and 51B40 to each other is referred to as a container fixed portion 5140.

When overlaying and aligning the top-side sheet 51A and the bottom-side sheet 51B with each other, the bottom-side sheet 51B having a smaller outer shape is desirably overlaid on the top-side sheet 51A having a larger outer shape. By overlaying the bottom-side sheet 51B having a smaller outer shape as the upper side as described above, the alignment marks 51Ay1 and 51Ay2 of the top-side sheet 51A are seen to protrude outside the edge 51By of the bottom-side sheet 51B. Thus, by aligning both alignment marks 51Ay1 and 51Ay2 and both alignment marks 51By1 and 51By2 with each other, it is easy to accurately align the top-side sheet 51A and the bottom-side sheet 51B with each other.

Since the top surface 51A10 and the bottom surface 51B10 have the same shape and the same size, and the top-side side surfaces 51A21 to 51A24 also have the same shape and the same size as the bottom-side side surfaces 51B21 to 51B24, when the top-side sheet 51A and the bottom-side sheet 51B are accurately aligned with and overlaid on each other, these surfaces are exactly overlaid on each other. In addition, since the top-side connection pieces 51A31 to 51A34 and the bottom-side connection pieces 51B31 to 51B34 have the same shape and the same size, these pieces are exactly placed on each other. The top-side double-folding ruled lines 51A31c to 51A34c, which are provided on the top-side connection pieces 51A31 to 51A34, are exactly placed on the bottom-side double-folding ruled lines 51B31c to 51B34c, which are provided on the bottom-side connection pieces 51B31 to 51B34, and the boundary 51Ax of the top-side fixing portion 51A40 in the top-side sheet 51A and the boundary 51Bx of the bottom-side fixing portion 51B40 in the bottom-side sheet 51B are also exactly placed on each other. Since the top surface 51A10 and the bottom surface 51B10 are exactly placed on each other, the top-side side surfaces 51A21 to 51A24 and the bottom-side side surfaces 51B21 to 51B24 are exactly placed on each other, the top-side connection pieces 51A31 to 51A34 and the bottom-side connection pieces 51B31 to 51B34 are exactly placed on each other, and the boundary 51Ax of the top-side fixing portion 51A40 in the top-side sheet 51A and the boundary 51Bx of the bottom-side fixing portion 51B40 in the bottom-side sheet 51B are exactly placed on each other as described above, also when the packaging container 51 is brought into the box state, distortion does not occurs in the packaging container 51, and the packaging container 51 can be obtained as designed.

As a matter of course, since the edge (contour line) 51Ay of the top-side sheet 51A is formed so as to be larger than the edge (contour line) 51By of the bottom-side sheet 51B, the positions of both edges 51Ay and 51By do not coincide with each other, and the edge 51Ay of the top-side sheet 51A is located outside the edge 51By of the bottom-side sheet 51B. In this example, since the difference between the length 51LA in the horizontal direction of the top-side sheet 51A and the length 51LB in the horizontal direction of the bottom-side sheet 51B is not less than 0.6 mm, the distance 5dL in the horizontal direction between the edge 51Ay of the top-side sheet 51A and the edge 51By of the bottom-side sheet 51B is not less than 0.3 mm. In addition, since the difference between the length 51HA in the vertical direction of the top-side sheet 51A and the length 51HB in the vertical direction of the bottom-side sheet 51B is also not less than 0.6 mm, the distance 5dH in the vertical direction between the edge 51Ay of the top-side sheet 51A and the edge 51By of the bottom-side sheet 51B is also not less than 0.3 mm, and the edge 51Ay of the top-side sheet 51A and the edge 51By of the bottom-side sheet 51B are formed so as to be displaced relative to each other by 0.3 mm or greater over the entire periphery excluding the alignment mark portions.

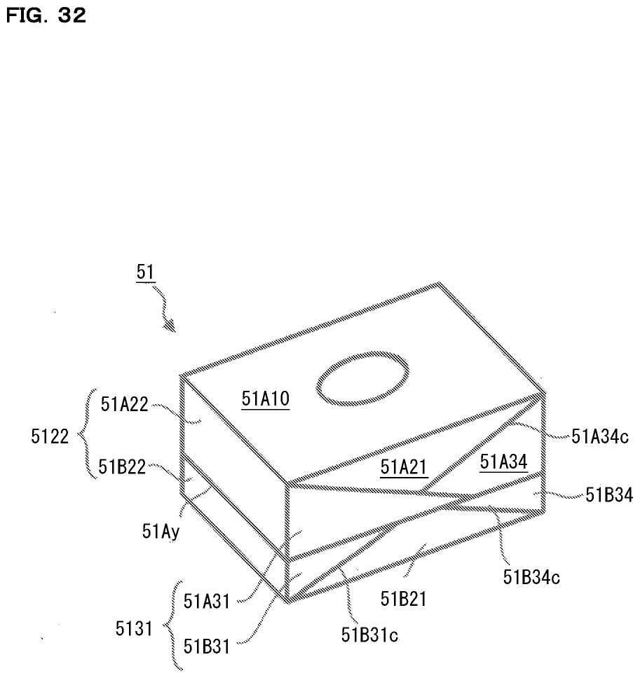

Next, a method for transforming the packaging container 51 in the flat state into the box state will be described. FIG. 32 shows the packaging container 51 in a state where the packaging container 51 is transformed into the box state and the respective connection pieces 51A31 to 51A34 and 51B31 to 51B34 are bent onto the outer surface.

To transform the packaging container 51 in the flat state into the box state, the top-side connection pieces 51A31 to 51A34 and the bottom-side connection pieces 51B31 to 51B34 may be folded double such that a mountain fold is made with respect to the container outer surface at each of the top-side double-folding ruled lines 51A31c to 51A34c and the bottom-side double-folding ruled lines 51B31c to 51B34c, which are located at the centers of the top-side connection pieces 51A31 to 51A34 and the bottom-side connection pieces 51B31 to 51B34. As a result of the double folding, the sides forming the side surfaces adjacent to each other, among the top-side side surfaces 51A21 to 51A24 of the top-side sheet 51A, are placed on each other. Describing the top-side connection piece 51A33 with reference to the enlarged view of FIG. 29, by folding double the top-side connection piece 51A33 at the top-side double-folding ruled line 51A33c, the side 51A23b of the top-side side surface 51A23 and the side 51A24b of the top-side side surface 51A24, which are located at both sides of the top-side connection piece 51A33, are placed on each other.

Meanwhile, in the packaging container 51 in the flat state, the top-side connection piece 51A33 of the top-side sheet 51A and the bottom-side connection piece 51B33 of the bottom-side sheet 51B are exactly placed on each other, and the top-side double-folding ruled line 51A33c and the bottom-side double-folding ruled line 51B33c thereof are also exactly placed on each other. Thus, when the top-side connection piece 51A33 of the top-side sheet 51A is folded double at the top-side double-folding ruled line 51A33c, the bottom-side connection piece 51B33 of the bottom-side sheet 51B is also folded double at the bottom-side double-folding ruled line 51B33c. Therefore, the side 51B23b of the bottom-side side surface 51B23 and the side 51B24b of the bottom-side side surface 51B24, which are located at both sides of the bottom-side connection piece 51B33, are also exactly placed on each other.

Since the top-side side surface 51A23 of the top-side sheet 51A and the bottom-side side surface 51B23 of the bottom-side sheet 51B are contiguous to each other via the container fixed portion 5140, a side surface 5123 of the packaging container 51 in the box state is formed by both side surfaces 51A23 and 51B23.

Moreover, since the top-side connection piece 51A33 of the top-side sheet 51A and the bottom-side connection piece 51B33 of the bottom-side sheet 51B are also contiguous to each other via the container fixed portion 5140, when a portion composed of both connection pieces 51A33 and 51B33 is referred to as a container connection piece 5133, the above side surfaces are connected to each other and also closed by the container connection piece 5133. That is, the side surface 5123 composed of the top-side side surface 51A23 and the bottom-side side surface 51B23 and a side surface 5124 composed of the top-side side surface 51A24 and the bottom-side side surface 51B24 are connected to each other and further closed by the container connection piece 5133 without any gap being formed therebetween.

Although the case of folding double the container connection piece 5133 composed of the top-side connection piece 51A33 and the bottom-side connection piece 51B33 has been described above as an example, the same applies to the other connection pieces. Specifically, a side surface 5121 composed of the top-side side surface 51A21 and the bottom-side side surface 51B21 and a side surface 5122 composed of the top-side side surface 51A22 and the bottom-side side surface 51B22 are formed by folding double a container connection piece 5131, composed of the top-side connection piece 51A31 and the bottom-side connection piece 51B31, such that a mountain fold is made with respect to the container outer surface at each of the top-side double-folding ruled line 51A31c and the bottom-side double-folding ruled line 51B31c, which are located at the centers of the top-side connection piece 51A31 and the bottom-side connection piece 51B31, and the side surface 5121 and the side surface 5122 are connected to each other and closed by the container connection piece 5131. In addition, the side surface 5122 composed of the top-side side surface 51A22 and the bottom-side side surface 51B22 and the side surface 5123 composed of the top-side side surface 51A23 and the bottom-side side surface 51B23 are formed by folding double a container connection piece 5132, composed of the top-side connection piece 51A32 and the bottom-side connection piece 51B32, such that a mountain fold is made with respect to the container outer surface at each of the top-side double-folding ruled line 51A32c and the bottom-side double-folding ruled line 51B32c, which are located at the centers of the top-side connection piece 51A32 and the bottom-side connection piece 51B32, and the side surface 5122 and the side surface 5123 are connected to each other and closed by the container connection piece 5132. Moreover, a side surface 5124 composed of the top-side side surface 51A24 and the bottom-side side surface 51B24 and the side surface 5121 composed of the top-side side surface 51A21 and the bottom-side side surface 51B21 are formed by folding double a connection piece 5134, composed of the top-side connection piece 51A34 and the bottom-side connection piece 51B34, such that a mountain fold is made with respect to the container outer surface at each of the top-side double-folding ruled line 51A34c and the bottom-side double-folding ruled line 51B34c, which are located at the centers of the top-side connection piece 51A34 and the bottom-side connection piece 51B34, and the side surface 5124 and the side surface 5121 are connected to each other and closed by the container connection piece 5134.

By folding double all the container connection pieces 5131 to 5134, the respective side surfaces 5121 to 5124 are formed. Accordingly, bending is performed at predetermined bending ruled lines, so that the packaging container 51 in the box state can be produced. The packaging container 51 in the box state has the top surface 51A10 and the bottom surface 51B10, the side surfaces 5121 to 5124 are provided at the peripheries thereof, and the gaps between the side surfaces 5121 to 5124 are closed by the container connection pieces 5131 to 5134. Thus, the packaging container 51 is in a hermetically sealed state except for the opening 51A11.

The bending ruled line is provided at the boundary 51Bx of the bottom-side fixing portion 51B40 of the bottom-side sheet 51B, and no bending ruled line is provided at the boundary 51Ax of the top-side fixing portion 51A40 of the top-side sheet 51A. Thus, the container fixed portion 5140, which is formed by heat-sealing both fixing portions 51A40 and 51B40, is bent toward the bottom-side sheet 51B. That is, the bottom-side fixing portion 51B40 is bent toward the bottom-side sheet 51B at the bending ruled line provided at the boundary 51Bx, and the top-side fixing portion 51A40 of the top-side sheet 51A is overlaid on the outer surface side of the bottom-side fixing portion 51B40 of the bottom-side sheet 51B without being bent at the boundary 51Ax. Therefore, the edge 51By of the bottom-side sheet 51B is covered with the top-side fixing portion 51A40 of the top-side sheet 51A and is not exposed on the outer surface.

When folding double the connection pieces 5131 to 5134 to produce the packaging container 51 in the box state as described above, the connection pieces 5131 to 5134 are desirably folded double while air or the like is blown in through the opening 511.

Next, in a state of being transformed into the box state as described above, the double-folded connection pieces 5131 to 5134 protrude on the outer surface of the packaging container 51. Therefore, the appearance of the packaging container 51 is desirably made neat by bending and overlaying the connection pieces 5131 to 5134 onto the respective side surfaces 5121 to 5124 of the packaging container 51. FIG. 32 shows the packaging container 51 in a state where the connection pieces 5131 to 5134 are bent and overlaid on the respective side surfaces 5121 to 5124 of the packaging container 1 as described above. The connection pieces 5131 to 5134 can be detachably fixed to the respective side surfaces 5121 to 5124 by means of an adhesive, an adhesive tape, or a joining member such as a hook and loop fastener and a snap button. Alternatively, when a heat-sealable rein is layered on the surface of each sheet in advance, the connection pieces 5131 to 5134 can be detachably fixed to the respective side surfaces 5121 to 5124 by the heat of hot air or the like and application of pressure. Still alternatively, it is possible to bend and overlay the connection pieces 5131 to 5134 onto the respective side surfaces 5121 to 5124 of the packaging container 51 by covering the packaging container 51 in the box state with a tubular sleeve.

Next, to transform the packaging container 51 in the box state into the flat state, the container fixed portion 5140 may be held and pulled outward of the packaging container 51. By pulling the container fixed portion 5140 outward, the double-folded connection pieces 5131 to 5134 are unfolded, and the packaging container 51 is transformed into the flat state.

The packaging container 51 can be used as described below.

Specifically, first, desirably, the packaging container 51 is produced in the flat state, stored in this state, and transferred to a contents filling step. Then, in the contents filling step, the packaging container 51 is transformed into the box state, then contents are filled thereinto through the opening 51A11, and the opening 51A11 is closed, whereby a package containing the contents can be prepared.

The package in the box state containing the contents as described above can be returned to the flat state again after the contents are discharged. It is possible to repeatedly transform the package between the box state and the flat state as described above.

As the top-side sheet 51A or the bottom-side sheet 51B, for example, a laminated film having a thermoplastic resin layer or a sealant layer layered on a base material layer made of paper can be suitably used. In addition to this, a barrier layer, a functional film, or the like may be added as appropriate according to a required function. Moreover, the end surface of the end portion of the top-side sheet 51A or the bottom-side sheet 51B may be protected by a known method.

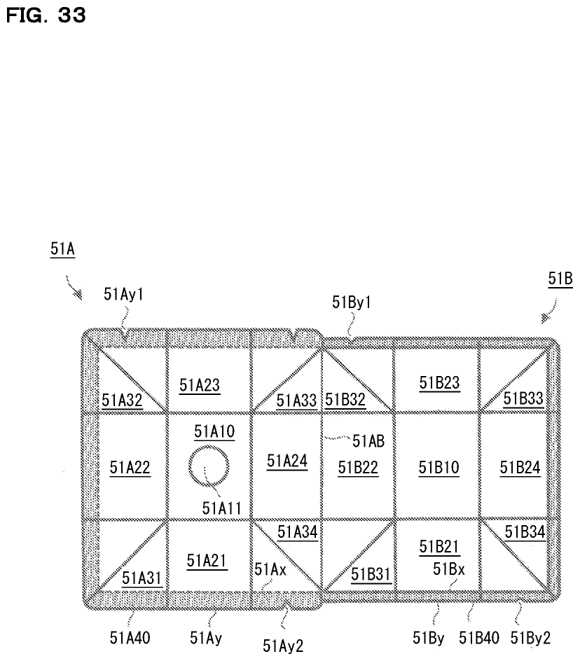

Next, a first modification of the packaging container 51 will be described with reference to FIG. 33. In the packaging container 51, both the top-side sheet 51A and the bottom-side sheet 51B are formed by one sheet, and the top-side sheet 51A and the bottom-side sheet 51B are partitioned by the bending ruled line 51AB, and the others are the same as the first example. Thus, the top-side fixing portion of the top-side sheet 51A is composed of the bending ruled line 51AB and a heat-seal region and configured to surround the entire periphery of the top-side sheet 51A with a combination of the bending ruled line 51AB and the heat-seal region. Similarly, the bottom-side fixing portion of the bottom-side sheet 51B is composed of the bending ruled line 51AB and a heat-seal region and configured to surround the entire periphery of the bottom-side sheet 51B with a combination of the bending ruled line 51AB and the heat-seal region. By bending at the bending ruled line 51AB, the top-side sheet 51A and the bottom-side sheet 51B can be overlaid on each other.

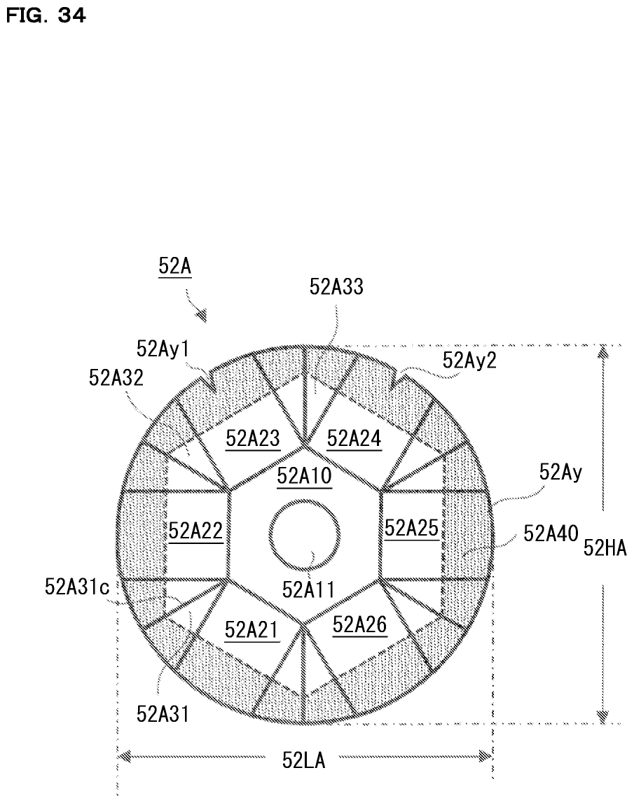

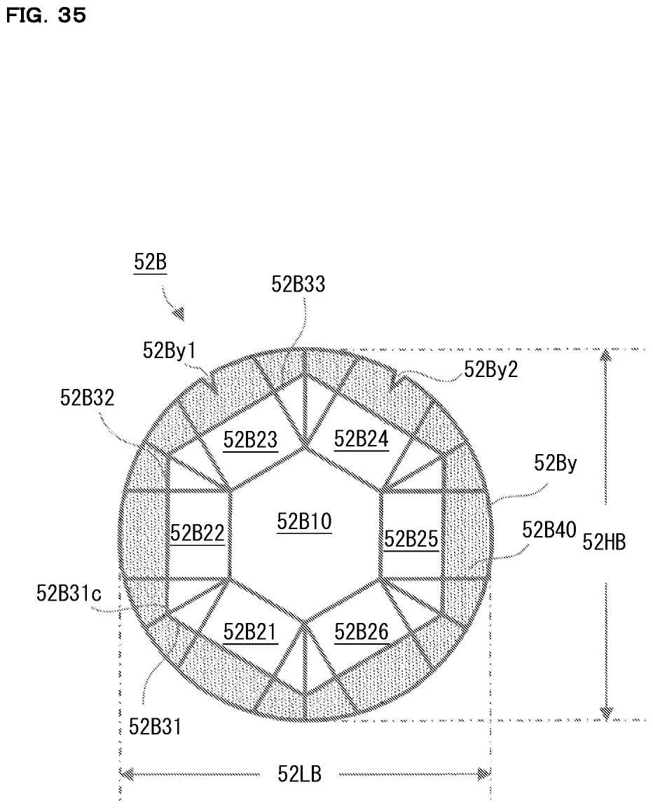

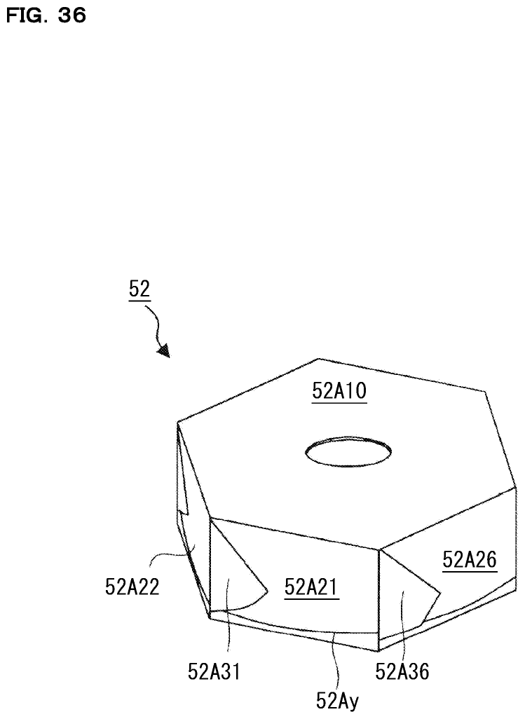

Next, a second modification will be described with reference to FIG. 34 to FIG. 36. In a packaging container 52 thereof, a top surface 52A10 of a top-side sheet 52A is formed in a regular hexagon shape, and a bottom surface 52B10 of a bottom-side sheet 52B is formed in a regular hexagon shape that is the same in shape and size as that of the top surface 52A10. Two or more alignment marks formed by recesses 52Ay1 and 52Ay2 or 52By1 and 52By2 having a depth of 0.5 mm or greater are provided at each of an edge 52Ay of the top-side sheet 52A and an edge 52By of the bottom-side sheet 52B. Each of the edge 52Ay of the top-side sheet 52A and the edge 52By of the bottom-side sheet 52B is circular, a length 52LA in the horizontal direction of the top-side sheet 52A is longer than a length 52LB in the horizontal direction of the bottom-side sheet 52B, and the difference therebetween is not less than 0.3 mm. In addition, a length 52HA in the vertical direction of the top-side sheet 52A is also longer than a length 52HB in the vertical direction of the bottom-side sheet 52B, and the difference therebetween is also not less than 0.3 mm. Thus, the length of the top-side sheet 52A is longer than the length of the bottom-side sheet 52B in any direction by 0.3 mm or greater. Therefore, when the packaging container 52 is in any of the box state and the flat state, the edge 52By of the bottom-side sheet 52B is covered with the top-side sheet 52A and is not exposed. The packaging container 52 can also be repeatedly transformed between the box state and the flat state by the same method as in the first modification.

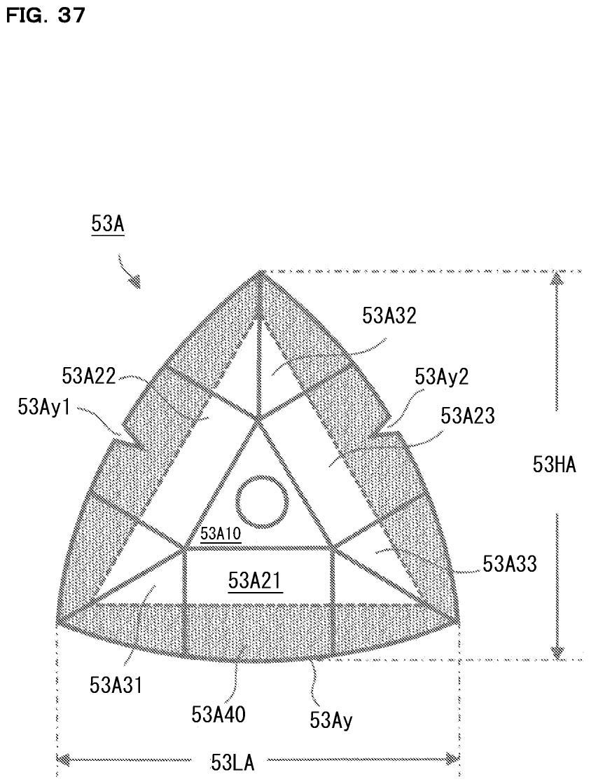

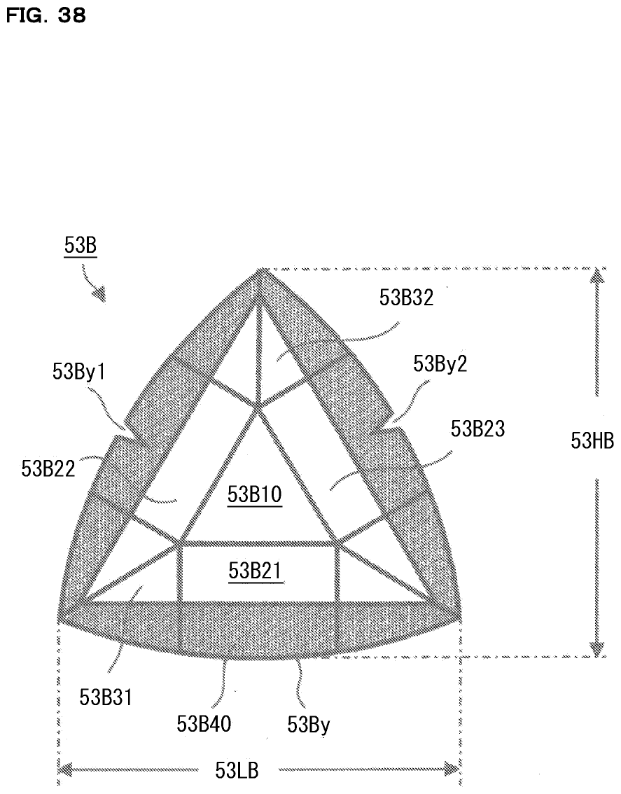

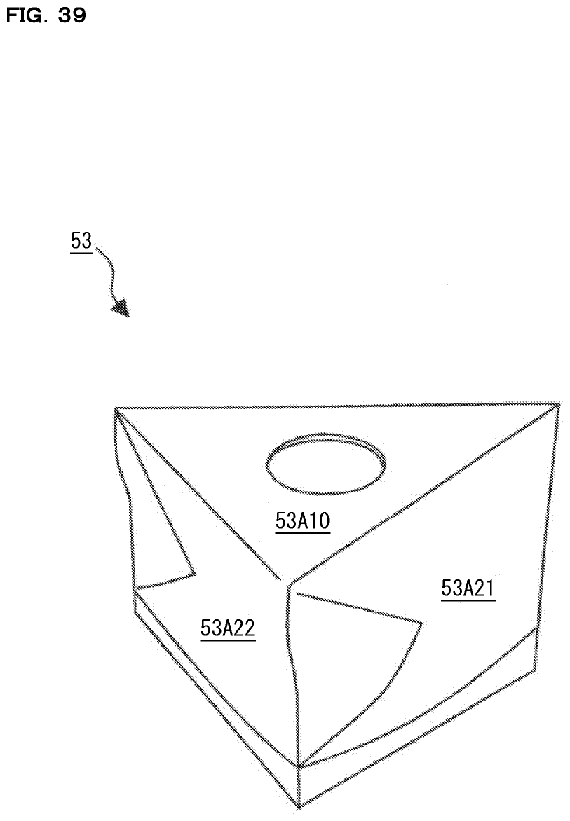

Next, a third modification will be described with reference to FIG. 37 to FIG. 39. In a packaging container 53 thereof, a top surface 53A10 of a top-side sheet 53A is formed in a regular triangle shape, and a bottom surface 53B10 of a bottom-side sheet 53B is formed in a regular triangle shape that is the same in shape and size as that of the top surface 53A10. Two or more alignment marks formed by recesses 53Ay1 and 53Ay2 or 53By1 and 53By2 having a depth of 0.5 mm or greater are provided at each of an edge 53Ay of the top-side sheet 53A and an edge 53By of the bottom-side sheet 53B. Each of the contour line 53Ay of the top-side sheet 53A and the edge 53By of the bottom-side sheet 53B is formed by connecting three circular arcs, a length 53LA in the horizontal direction of the top-side sheet 53A is longer than a length 53LB in the horizontal direction of the bottom-side sheet 53B, and the difference therebetween is not less than 0.3 mm. Therefore, the length of the top-side sheet 53A is longer than the length of the bottom-side sheet 53B in any direction by 0.3 mm or greater, and, when the packaging container 53 is in any of the box state and the flat state, the edge 53By of the bottom-side sheet 53B is covered with the top-side sheet 53A and is not exposed. The packaging container 53 can also be repeatedly transformed between the box state and the flat state by the same method as in the first modification and the second modification.

### EXAMPLES

### Example 5-1

The top-side sheet 51A and the bottom-side sheet 51B, which are substantially rectangular as shown in FIG. 29 and FIG. 30, were used. The top-side sheet 51A has, at two locations on the edge 51Ay thereof, alignment marks 51Ay1 and 51Ay2 formed by recesses that are recessed inward, and each of the depths 51DA of the alignment marks 51Ay1 and 51Ay2 is 5.0 mm. In addition, the bottom-side sheet 51B has, at the positions, on the edge 51By, corresponding to the alignment marks 51Ay1 and 51Ay2, two alignment marks 51By1 and 51By2 formed by recesses that are recessed inward. Each of the depths 51DB of the alignment marks 51By1 and 51By2 is 3.5 mm.

The length 51LA in the horizontal direction of the top-side sheet 51A is 180.0 mm, and the length 51HA in the vertical direction of the top-side sheet 51A is 200.0 mm. In addition, the length 51LB in the horizontal direction of the bottom-side sheet 51B is 177.0 mm, and the length 51HB in the vertical direction of the bottom-side sheet 51B is 197.0 mm. The top-side sheet 51A is longer than the bottom-side sheet 51B by 3.0 mm in any of the vertical direction and the horizontal direction. Thus, when both sheets 51A and 51B are accurately overlaid on each other without being positionally displaced relative to each other, the distance between the edge 51Ay of the top-side sheet 51A and the edge 51By of the bottom-side sheet 51B is 1.5 mm.

Then, the top-side sheet 51A and the bottom-side sheet 51B described above were overlaid and aligned with each other using the alignment marks 51Ay1, 51Ay2, 51By1, and 51By2, and then the fixing portions 51A40 and 51B40 at the peripheries were heat-sealed to each other, thereby producing a packaging container 51 in a flat state.

Subsequently, a packaging container 51 in a box state is produced by folding double all the connection pieces 5131 to 5134. Finally, the connection pieces 5131 to 5134 are bent and overlaid onto the respective side surfaces 5121 to 5124 of the packaging container 51.

A total of ten packaging containers 51 in a box state were produced, and presence/absence of a positional displacement between the top-side sheet 51A and the bottom-side sheet 51B and presence/absence of distortion of each packaging container 51 in the box state were checked. Regarding presence/absence of a positional displacement, when a positional displacement of 0.5 mm or greater was present between the top-side sheet 51A and the bottom-side sheet 51B, “presence of a positional displacement” was determined. The number of packaging containers 51 having “presence of a positional displacement” was counted. In addition, regarding presence/absence of distortion, the number of packaging containers 51 in which distortion had occurred was counted. The results are shown in Table 1.

### Example 5-2

Packaging containers 51 in a box state were produced in the same manner as Example 5-1, except that, of the two alignment marks 51Ay1 and 51Ay2 of the top-side sheet 51A, the alignment mark 51A1 was formed by a recess that is recessed inward, and the alignment mark 51Ay2 was formed by a projection that projects outward, and, of the two alignment marks 51By1 and 51By2 of the bottom-side sheet 51B, the alignment mark 51By1 was formed as a projection that projects outward, and the alignment mark 51By2 was formed by a recess that is recessed inward. Finally, the connection pieces 5131 to 5134 were bent and overlaid onto the respective side surfaces 5121 to 5124 of the packaging container 51. The alignment mark 51By1 corresponds to the alignment mark 51Ay1, and the alignment mark 51By2 corresponds to the alignment mark 51Ay2. In addition, each of the depths of the alignment marks 51Ay1 and 51By2 formed by the recesses is 3.5 mm, and each of the heights of the alignment marks 51Ay2 and 51By1 formed by the projections is 5.0 mm.

The results of checking presence/absence of a positional displacement and presence/absence of distortion of each packaging container 51 in the same manner as in Example 5-1 are shown in Table 1.

### Example 5-3

No alignment marks were provided on any of the top-side sheet 51A and the bottom-side sheet 51B. The others are the same as in Example 5-1. The results of presence/absence of a positional displacement and presence/absence of distortion of each packaging container 51 are shown in Table 1.

### Example 5-4

This example is an example in which the two alignment marks 51Ay1 and 51Ay2 of the top-side sheet 51A and the two alignment marks 51By1 and 51By2 of the bottom-side sheet 51B were formed by recesses that are recessed inward, but each of the depths of some of the alignment marks was less than 0.5 mm.

Specifically, each of the depths of the alignment marks 51Ay1 and 51By2 was 0.6 mm, but each of the depths of the alignment marks 51Ay2 and 51By1 was 0.3 mm. The others are the same as in Example 5-1. The results of presence/absence of a positional displacement and presence/absence of distortion of each packaging container 51 are shown in Table 1.

### Example 5-5

This example is an example in which only one alignment mark was provided on each of the top-side sheet 51A and the bottom-side sheet 51B. The alignment mark of the top-side sheet 51A was formed by a recess having a depth of 5.0 mm. In addition, the alignment mark of the bottom-side sheet 51B was formed by a recess having a depth of 3.5 mm. The others are the same as in Example 5-1. The results of presence/absence of a positional displacement and presence/absence of distortion of each packaging container 51 are shown in Table 1.

TABLE 1

| | Number of | |
|---|---|---|
| | occurrences of | Number of |
| | positional | occurrences |
| | displacement | of distortion |
| Example 5-1 | 0/10 | 0/10 |
| Example 5-2 | 0/10 | 0/10 |
| Example 5-3 | 10/10 | 10/10 |
| Example 5-4 | 9/10 | 9/10 |
| Example 5-5 | 7/10 | 7/10 |

When no alignment mark is provided (Example 5-3), each container exhibits a positional displacement of 0.5 mm or greater between the top-side sheet 51A and the bottom-side sheet 51B. Accordingly, when the packaging container 51 is brought into the box state, the functions as a packaging container are not deteriorated, but distortion in the shape thereof occurs.

When alignment marks are provided, a positional displacement and distortion are reduced. However, when each of the depths of some of the alignment marks is less than 0.5 mm (Example 5-4), or when only one alignment mark is provided (Example 5-5), a positional displacement occurs in some containers. Accordingly, when the packaging container 51 is brought into the box state, the functions as a packaging container are not deteriorated, but distortion in the shape thereof occurs.

On the other hand, when two or more alignment marks are provided on each of the edge of the top-side sheet and the edge of the bottom-side sheet and the depth or the height of each alignment mark is not less than 0.5 mm (Examples 5-1 and 5-2), a positional displacement of 0.5 mm or greater does not occur, and distortion does not occur in the packaging container 51 in the box state.

From the results, the following is found.

Specifically, first, the cause of occurrence of distortion in the shape of the packaging container when the packaging container is brought into the box state is that a positional displacement of 0.5 mm or greater is present between the top-side sheet and the bottom-side sheet. Unless a positional displacement of 0.5 mm or greater is present between the top-side sheet and the bottom-side sheet, distortion does not occur in the packaging container in the box state.

By providing two or more alignment marks each having a depth or a height of 0.5 mm or greater on each of the edges of both sheets, the positional displacement of 0.5 mm or greater between the top-side sheet and the bottom-side sheet can be prevented. Accordingly, it is possible to prevent the distortion.

Since two or more alignment marks are provided on each of the top-side sheet 51A and the bottom-side sheet 51B, each alignment mark is formed by a recess that is recessed from the edge or by a projection that projects from the edge, and the depth or height of each alignment mark is not less than 0.5 mm, each alignment mark is seen at the end portion. Therefore, it is possible to easily and accurately align these sheet materials with each other. As a result, when the packaging container 51 is brought into the box state, distortion does not occur in the packaging container 51.

Although the description has been given above using the packaging container 51 in which the outer shape of the bottom-side sheet 51B is formed so as to be smaller than the outer shape of the top-side sheet 51A, the outer shape of the top-side sheet 51A and the outer shape of the bottom-side sheet 51B may be the same as long as the alignment marks 51Ay1, 51Ay2, 51By1, and 51By2 are provided.

### Sixth Embodiment

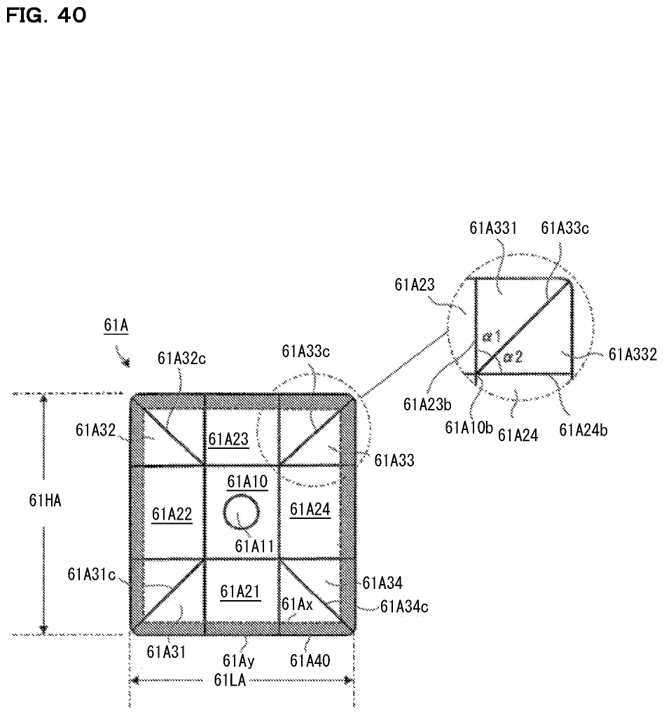

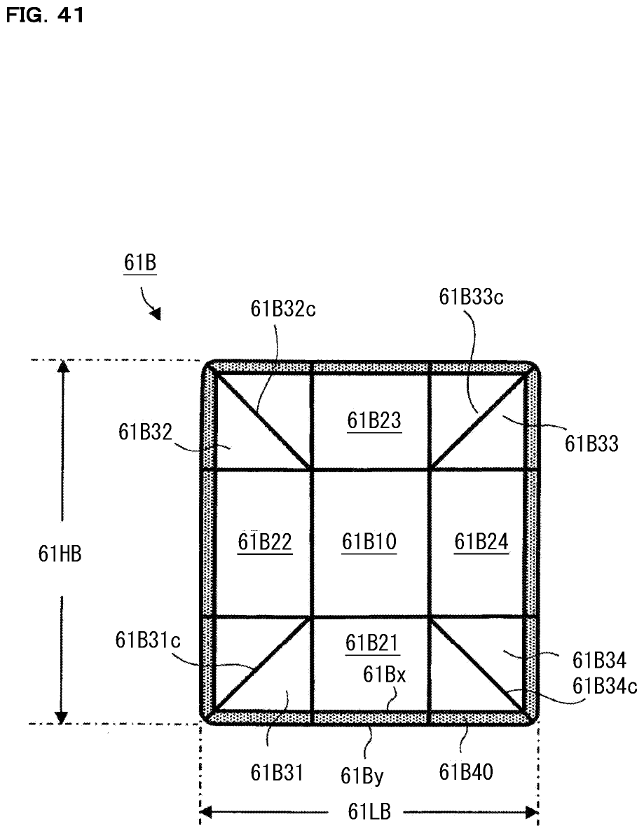

Hereinafter, a packaging container according to a sixth embodiment of the present invention will be described with reference to the drawings. FIGS. 40 to 43 are diagrams showing the packaging container 61 according to the sixth embodiment of the present invention and sheet materials for forming the packaging container 61, and FIG. 40 and FIG. 41 show a top-side sheet 61A and a bottom-side sheet 61B, respectively.

First, the top-side sheet 61A has a polygonal top surface 61A10 at the center thereof. In this example, the top surface 61A10 is rectangular. An opening 61A11 is provided in the top surface 61A10. A plug can be mounted on the opening 61A11 in advance.

Next, the top-side sheet 61A has tetragonal top-side side surfaces 61A21 to 61A24 each having one side that is one of the sides of the top surface 61A10, with each side of the polygonal top surface 61A10 as a bending ruled line. The number of the top-side side surfaces 61A21 to 61A24 is equal to the number of the sides of the polygonal top surface 61A10. In this example, since the top surface 61A10 has a tetragonal shape, the number of the sides of the tetragonal top surface 61A10 is four, and the number of the sides of each of the top-side side surfaces 61A21 to 61A24 is also four.

In addition, the top-side sheet 61A has, between the respective top-side side surfaces adjacent to each other, top-side connection pieces 61A31 to 61A34 that connect the top-side side surfaces 61A21 to 61A24 to each other. That is, the top-side side surface 61A21 and the top-side side surface 61A22 are connected to each other by the top-side connection piece 61A31. In addition, the top-side side surface 61A22 and the top-side side surface 61A23 are connected to each other by the top-side connection piece 61A32. The same applies to the other top-side side surfaces. Bending ruled lines are provided between the respective top-side side surfaces 61A21 to 61A24 and the respective top-side connection pieces 61A31 to 61A34.

The gaps between the top-side side surfaces 61A21 to 61A24 are closed by the top-side connection pieces 61A31 to 61A34. As shown, in this example, the outer shape of a portion obtained by combining the top-side side surfaces 61A21 to 61A24 with the top-side connection pieces 61A31 to 61A34 is a rectangle, and the respective top-side connection pieces 61A31 to 61A34 are located at the corners of the rectangle and close the gaps between the top-side side surfaces 61A21 to 61A24. For example, the gap between the top-side side surface 61A21 and the top-side side surface 61A22 is closed by the top-side connection piece 61A31.

The top-side connection pieces 61A31 to 61A34 have top-side double-folding ruled lines that extend from the respective vertexes of the top surface 61A10 so as to bisect the top-side connection pieces 61A31 to 61A34. That is, as shown in FIG. 40 in an enlarged manner, for example, the top-side side surface 61A23 and the top-side side surface 61A24 share a vertex 61A10b of the top surface 61A10. Of the sides that form the top-side side surface 61A23, the side that shares the vertex 61A10b of the top surface 61A10 is designated by reference character 61A23b. In addition, the sides that form the top-side side surface 61A24, the side that shares the vertex 61A10b of the top surface 61A10 is designated by reference character 61A24b. A top-side double-folding ruled line 61A33c that bisects the angle formed by the side 61A23b and the side 61A24b is provided. That is, in the drawing, the angle α1 formed by the side 61A23b and the double-folding ruled line 61A33c is equal to the angle α2 formed by the side 61A24b and the top-side double-folding ruled line 61A33c. Although the top-side double-folding ruled line 61A33c has been described above with the top-side connection piece 61A33 as an example, top-side double-folding ruled lines 61A31c, 61A32c, and 61A34c are also similarly provided on the other top-side connection pieces 61A31, 61A32, and 61A34.

Next, the top-side sheet 61A has, at the outer side of the rectangular portion obtained by combining the top-side side surfaces 61A21 to 61A24 with the top-side connection pieces 61A31 to 61A34, a top-side fixing portion 61A40 at which the top-side sheet 61A is to be fixed to the bottom-side sheet 61B. In this example, the top-side fixing portion 61A40 is formed as a heat-seal region over the entire periphery. When both the top-side sheet 61A and the bottom-side sheet 61B are formed by one sheet as in a later-described modification, a part of the top-side fixing portion 61A40 can be formed as a bending ruled line 61AB that partitions the top-side sheet 61A and the bottom-side sheet 61B.

As seen from the drawing, an edge 61Ay of the top-side fixing portion 61A40 forms the contour line of the top-side fixing portion 61A40 and also forms the edge (contour line) of the top-side sheet 61A. In this example, the shape of the edge 61Ay of the top-side sheet 61A is substantially a rectangle, and the corners thereof are chamfered to remove sharp portions.

In FIG. 40, for convenience of explanation, the top-side fixing portion 61A40 is shown by hatching, and the boundaries between the top-side fixing portion 61A40 and the top-side side surfaces 61A21 to 61A24 and the boundaries between the top-side fixing portion 61A40 and the top-side connection pieces 61A31 to 61A34 are shown by a broken line 61Ax. Unlike a boundary 61Bx between a bottom-side fixing portion 61B40 and bottom-side side surfaces 61B21 to 61B24 of the bottom-side sheet 61B described later, no bending ruled line is present at the boundaries between the top-side fixing portion 61A40 and the top-side side surfaces 61A21 to 61A24. Also, no bending ruled line is present at the boundaries between the top-side fixing portion 61A40 and the top-side connection pieces 61A31 to 61A34.

Next, the bottom side sheet 61B has the same structure as the top-side sheet 61A. Specifically, the bottom side sheet 61B has a polygonal bottom surface 61B10 at the center thereof. The polygonal bottom surface 61B10 has the same shape and the same size as the top surface 61A10.

Moreover, the bottom side sheet 61B has the tetragonal bottom-side side surfaces 61B21 to 61B24 each having one side that is one of the sides of the polygonal bottom surface 61B10, with each side of the bottom surface 61B10 as a bending ruled line, and the number of the bottom-side side surfaces 61B21 to 61B24 is equal to the number of the sides of the polygonal bottom surface 61B10. These bottom-side side surfaces 61B21 to 61B24 also have the same shape and the same size as the top-side side surfaces 61A21 to 61A24, respectively.

Furthermore, the bottom side sheet 61B has, between the respective bottom-side side surfaces 61B21 to 61B24 adjacent to each other, bottom-side connection pieces 61B31 to 61B34 that connect the bottom-side side surfaces 61B21 to 61B24 to each other and also close the gaps therebetween. These bottom-side connection pieces 61B31 to 61B34 have the same shape and the same size as the top-side connection pieces 61A31 to 61A34.

Furthermore, bending ruled lines are provided between the respective bottom-side side surfaces 61B21 to 61B24 and the respective bottom-side connection pieces 61B31 to 61B34. In addition, bottom-side double-folding ruled lines 61B31c to 61B34c that extend from the respective vertexes of the bottom surface 61B10 so as to bisect the bottom-side connection pieces 61B31 to 61B34 are provided on the respective bottom-side connection pieces 61B31c to 61B34c.

Next, the bottom-side sheet 61B has, at the outer side of a rectangular portion obtained by combining the bottom-side side surfaces 61B21 to 61B24 with the bottom-side connection pieces 61B31 to 61B34, the bottom-side fixing portion 61B40 at which the bottom-side sheet 61B is to be fixed to the top-side sheet 61A. In this example, the bottom-side fixing portion 61B40 is a heat-seal region over the entire periphery.

As seen from the drawing, a contour line 61By of the bottom-side fixing portion 61B40 forms the contour line of the bottom-side fixing portion 61B40 and also forms the edge (contour line) of the bottom-side sheet 61B. In this example, the outer shape of the bottom-side fixing portion 61B40 is substantially a rectangle.

The outer shape of the bottom-side sheet 61B is formed so as to be smaller than the outer shape of the top-side sheet 61A.

In FIG. 40, reference character 61LA denotes the length in the horizontal direction of the top-side sheet 61A, and in FIG. 41, reference character 61LB denotes the length in the horizontal direction of the bottom-side sheet 61B. The difference therebetween, that is, the difference between the length 61LA in the horizontal direction of the top-side sheet 61A and the length 61LB in the horizontal direction of the bottom-side sheet 61B, is desirably not less than 0.6 mm. When the top-side sheet 61A and the bottom-side sheet 61B are aligned with and overlaid on each other as described later, if the difference between the length 61LA in the horizontal direction of the top-side sheet 61A and the length 61LB in the horizontal direction of the bottom-side sheet 61B is not less than 0.6 mm, both sheets 61A and 61B are arranged such that the edges thereof are displaced relative to each other by 0.3 mm or greater. Accordingly, even when a slight positional displacement occurs between both sheets 61A and 61B, the edge 61By of the bottom-side sheet 61B is covered with the top-side sheet 61A and thus does not become exposed. As seen from later-described examples, the difference between the length 61LA in the horizontal direction of the top-side sheet 61A and the length 61LB in the horizontal direction of the bottom-side sheet 61B is desirably not less than 1.0 mm.

Moreover, in FIG. 40, reference character 61HA denotes the length in the vertical direction of the top-side sheet 61A, and in FIG. 41, reference character 61HB denotes the length in the vertical direction of the bottom-side sheet 61B. The difference therebetween, that is, the difference between the length 61HA in the vertical direction of the top-side sheet 61A and the length 61HB in the vertical direction of the bottom-side sheet 61B, is also desirably not less than 0.6 mm. This difference is also desirably not less than 1.0 mm.

When the length of the top-side sheet 61A is longer than the length of the bottom-side sheet 61B in both the vertical direction and the horizontal direction, the length of the top-side sheet 61A is longer than the length of the bottom-side sheet 61B in any direction. Thus, even when a slight positional displacement occurs between both sheets 61A and 61B, the edge 61BY of the bottom-side sheet 61B does not become exposed at any position on the entire periphery.

A bending ruled line 61Bx is provided at the boundaries between the bottom-side fixing portion 61B40 and the bottom-side side surfaces 61B21 to 61B24 of the bottom-side sheet 61B and the boundaries between the bottom-side fixing portion 61B40 and the bottom-side connection pieces 61B31 to 61B34. Since no bending ruled line is present at the boundary of the top-side fixing portion 61A40 of the top-side sheet 61A, when both sheets 61A and 61B are overlaid on and fixed to each other and brought into a box state, both fixing portions 61A40 and 61B40 fixed to each other are bent toward the bottom-side sheet 61B side due to the bending ruled line 61Bx, and the outer side thereof is covered with the top-side sheet 61A. Thus, also in the box state, the edge 61By of the bottom-side sheet 61B is not exposed on the outer surface of the packaging container 61.

The packaging container 61 can be produced as described below.

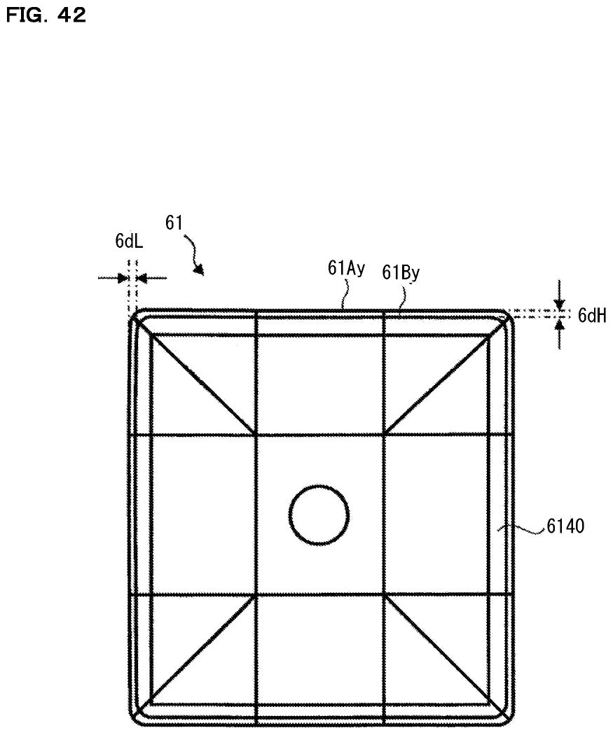

Specifically, first, the packaging container 61 in the flat state can be produced by aligning and overlaying the top-side sheet 61A and the bottom-side sheet 61B on each other and heat-sealing both fixing portions 61A40 and 61B40 to each other (see FIG. 42). Since the width of the bottom-side fixing portion 61B40 is smaller than that of the top-side fixing portion 61A40, the fixing portions 61A40 and 61B40 does not need to be heat-sealed over the entire width, but are desirably heat-sealed such that the fixing portions 61A40 and 61B40 are fixed to each other over the entire periphery. Hereinafter, a portion formed by heat-sealing both fixing portions 61A40 and 61B40 to each other is referred to as a container fixed portion 6140.

Since the top surface 61A10 and the bottom surface 61B10 have the same shape and the same size, and the top-side side surfaces 61A21 to 61A24 also have the same shape and the same size as the bottom-side side surfaces 61B21 to 61B24, when the top-side sheet 61A and the bottom-side sheet 61B are aligned with and overlaid on each other, these surfaces are exactly overlaid on each other. In addition, since the top-side connection pieces 61A31 to 61A34 and the bottom-side connection pieces 61B31 to 61B34 have the same shape and the same size, these pieces are exactly placed on each other. The top-side double-folding ruled lines 61A31c to 61A34c, which are provided on the top-side connection pieces 61A31 to 61A34, are exactly laid on the bottom-side double-folding ruled lines 61B31c to 61B34c, which are provided on the bottom-side connection pieces 61B31 to 61B34, and the boundary 61Ax of the top-side fixing portion 61A40 in the top-side sheet 61A and the boundary 61Bx of the bottom-side fixing portion 61B40 in the bottom-side sheet 61B are also exactly placed on each other. However, since the edge (contour line) 61Ay of the top-side sheet 61A is formed so as to be larger than the edge (contour line) 61By of the bottom-side sheet 61B, the positions of both edges 61Ay and 61By do not coincide with each other, and the edge 61Ay of the top-side sheet 61A is located outside the edge 61By of the bottom-side sheet 61B. In this example, since the difference between the length 61LA in the horizontal direction of the top-side sheet 61A and the length 61LB in the horizontal direction of the bottom-side sheet 61B is not less than 0.6 mm, the distance 6dL in the horizontal direction between the edge 61Ay of the top-side sheet 61A and the edge 61By of the bottom-side sheet 61B is not less than 0.3 mm. In addition, since the difference between the length 61HA in the vertical direction of the top-side sheet 61A and the length 61HB in the vertical direction of the bottom-side sheet 61B is also not less than 0.6 mm, the distance 6dH in the vertical direction between the edge 61Ay of the top-side sheet 61A and the edge 61By of the bottom-side sheet 61B is also not less than 0.3 mm, and the edge 61Ay of the top-side sheet 61A and the edge 61By of the bottom-side sheet 61B are formed so as to be displaced relative to each other by 0.3 mm or greater over the entire periphery.

If the top-side sheet 61A and the bottom-side sheet 61B cannot be accurately aligned with each other and a displacement occurs therebetween, a displacement also occurs between the positions of the top surface 61A10 and the bottom surface 61B10 with this displacement, and displacements also occur between the top-side side surfaces 61A21 to 61A24 and the bottom-side side surfaces 61B21 to 61B24, between the top-side connection pieces 61A31 to 61A34 and the bottom-side connection pieces 61B31 to 61B34, between the top-side double-folding ruled lines 61A31c to 61A34c and the bottom-side double-folding ruled lines 61B31c to 61B34c, and between the boundary 61Ax of the top-side fixing portion 61A40 and the boundary 61Bx of the bottom-side fixing portion 61B40, respectively. In addition, the distance between the edge 61Ay of the top-side sheet 61A and the edge 61By of the bottom-side sheet 61B becomes larger or smaller than a design value in accordance with the direction of the displacement. However, when the displacement between the top-side sheet 61A and the bottom-side sheet 61B is a slight displacement and the magnitude of the displacement is within 0.3 mm, the edge 61By of the bottom-side sheet 61B does not protrude outside the edge 61Ay of the top-side sheet 61A. When a positional displacement between the top surface 61A10 and the bottom surface 61B10 or a positional displacement between the top-side side surfaces 61A21 to 61A24 and the bottom-side side surfaces 61B21 to 61B24 is also within 0.3 mm, such a positional displacement does not become an obstacle to transformation of the packaging container 61 into the box state. As described above, the above distance is desirably not less than 0.5 mm.

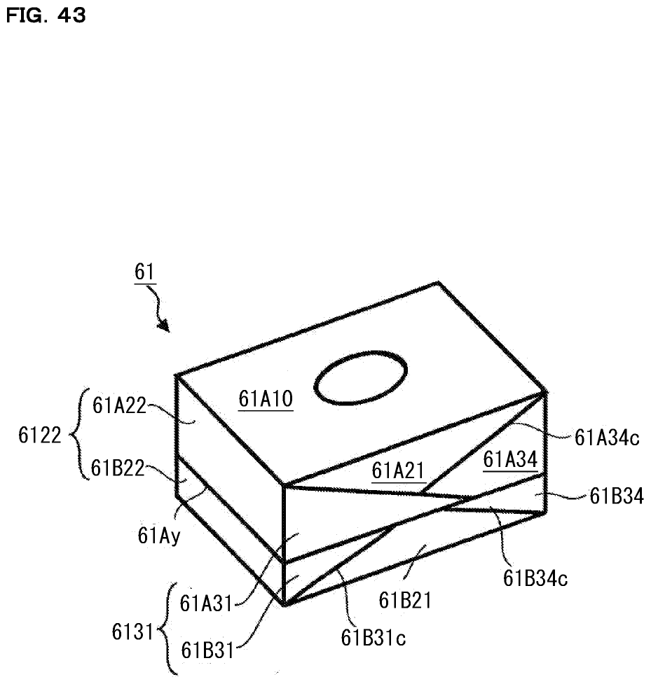

Next, a method for transforming the packaging container 61 in the flat state into the box state will be described. FIG. 43 shows the packaging container 61 in a state where the packaging container 61 is transformed into the box state and the respective connection pieces 61A31 to 61A34 and 61B31 to 61B34 are bent onto the outer surface.

To transform the packaging container 61 in the flat state into the box state, the top-side connection pieces 61A31 to 61A34 and the bottom-side connection pieces 61B31 to 61B34 may be folded double such that a mountain fold is made with respect to the container outer surface at each of the top-side double-folding ruled lines 61A31c to 61A34c and the bottom-side double-folding ruled lines 61B31c to 61B34c, which are located at the centers of the top-side connection pieces 61A31 to 61A34 and the bottom-side connection pieces 61B31 to 61B34. As a result of the double folding, the sides forming the side surfaces adjacent to each other, among the top-side side surfaces 61A21 to 61A24 of the top-side sheet 61A, are placed on each other. Describing the top-side connection piece 61A33 with reference to the enlarged view of FIG. 40, by folding double the top-side connection piece 61A33 at the top-side double-folding ruled line 61A33c, the side 61A23b of the top-side side surface 61A23 and the side 61A24b of the top-side side surface 61A24, which are located at both sides of the top-side connection piece 61A33, are placed on each other.

Meanwhile, in the packaging container 61 in the flat state, the top-side connection piece 61A33 of the top-side sheet 61A and the bottom-side connection piece 61B33 of the bottom-side sheet 61B are exactly placed on each other, and the top-side double-folding ruled line 61A33c and the bottom-side double-folding ruled line 61B33c thereof are also exactly placed on each other, and, even if a positional displacement is present, the positional displacement is a slight positional displacement. Thus, when the top-side connection piece 61A33 of the top-side sheet 61A is folded double at the top-side double-folding ruled line 61A33c, the bottom-side connection piece 61B33 of the bottom-side sheet 61B is also folded double at the bottom-side double-folding ruled line 61B33c. Therefore, the side 61B23b of the bottom-side side surface 61B23 and the side 61B24b of the bottom-side side surface 61B24, which are located at both sides of the bottom-side connection piece 61B33, are also placed on each other.

Since the top-side side surface 61A23 of the top-side sheet 61A and the bottom-side side surface 61B23 of the bottom-side sheet 61B are contiguous to each other via the container fixed portion 6140, a side surface 6123 of the packaging container 61 in the box state is formed by both side surfaces 61A23 and 61B23.

Moreover, since the top-side connection piece 61A33 of the top-side sheet 61A and the bottom-side connection piece 61B33 of the bottom-side sheet 61B are also contiguous to each other via the container fixed portion 6140, when a portion composed of both connection pieces 61A33 and 61B33 is referred to as a container connection piece 6133, the above side surfaces are connected to each other and also closed by the container connection piece 6133. That is, the side surface 6123 composed of the top-side side surface 61A23 and the bottom-side side surface 61B23 and a side surface 6124 composed of the top-side side surface 61A24 and the bottom-side side surface 61B24 are connected to each other and further closed by the container connection piece 6133 without any gap being formed therebetween.

Although the case of folding double the container connection piece 6133 composed of the top-side connection piece 61A33 and the bottom-side connection piece 61B33 has been described above as an example, the same applies to the other connection pieces. Specifically, a side surface 6121 composed of the top-side side surface 61A21 and the bottom-side side surface 61B21 and a side surface 6122 composed of the top-side side surface 61A22 and the bottom-side side surface 61B22 are formed by folding double a container connection piece 6131, composed of the top-side connection piece 61A31 and the bottom-side connection piece 61B31, such that a mountain fold is made with respect to the container outer surface at each of the top-side double-folding ruled line 61A31c and the bottom-side double-folding ruled line 61B31c, which are located at the centers of the top-side connection piece 61A31 and the bottom-side connection piece 61B31, and the side surface 6121 and the side surface 6122 are connected to each other and closed by the container connection piece 6131. In addition, the side surface 6123 composed of the top-side side surface 61A22 and the bottom-side side surface 61B22 and a side surface 6123 composed of the top-side side surface 61A23 and the bottom-side side surface 61B23 are formed by folding double a container connection piece 6132, composed of the top-side connection piece 61A32 and the bottom-side connection piece 61B32, such that a mountain fold is made with respect to the container outer surface at each of the top-side double-folding ruled line 61A32c and the bottom-side double-folding ruled line 61B32c, which are located at the centers of the top-side connection piece 61A32 and the bottom-side connection piece 61B32, and the side surface 6122 and the side surface 6122 are connected to each other and closed by the container connection piece 6132. Moreover, a side surface 6124 composed of the top-side side surface 61A24 and the bottom-side side surface 61B24 and the side surface 6121 composed of the top-side side surface 61A21 and the bottom-side side surface 61B21 are formed by folding double a connection piece 6134, composed of the top-side connection piece 61A34 and the bottom-side connection piece 61B34, such that a mountain fold is made with respect to the container outer surface at each of the top-side double-folding ruled line 61A34c and the bottom-side double-folding ruled line 61B34c, which are located at the centers of the e top-side connection piece 61A34 and the bottom-side connection piece 61B34, and the side surface 6124 and the side surface 6121 are connected to each other and closed by the container connection piece 6134.

By folding double all the container connection pieces 6131 to 6134, the respective side surfaces 6121 to 6124 are formed. Accordingly, bending is performed at predetermined bending ruled lines, so that the packaging container 61 in the box state can be produced. The packaging container 61 in the box state has the top surface 61A10 and the bottom surface 61B10, the side surfaces 6121 to 6124 are provided at the peripheries thereof, and the gaps between the side surfaces 6121 to 6124 are closed by the container connection pieces 6131 to 6134. Thus, the packaging container 61 is in a hermetically sealed state except for the opening 61A11.

The bending ruled line is provided at the boundary 61Bx of the bottom-side fixing portion 61B40 of the bottom-side sheet 61B, and no bending ruled line is provided at the boundary 61Ax of the top-side fixing portion 61A40 of the top-side sheet 61A. Thus, the container fixed portion 6140, which is formed by heat-sealing both fixing portions 61A40 and 61B40, is bent toward the bottom-side sheet 61B. That is, the bottom-side fixing portion 61B40 is bent toward the bottom-side sheet 61B at the bending ruled line provided at the boundary 61Bx, and the top-side fixing portion 61A40 of the top-side sheet 61A is overlaid on the outer surface side of the bottom-side fixing portion 61B40 of the bottom-side sheet 61B without being bent at the boundary 61Ax. Therefore, the edge 61By of the bottom-side sheet 61B is covered with the top-side fixing portion 61A40 of the top-side sheet 61A and is not exposed on the outer surface. Even when a positional displacement is present between the top-side sheet 61A and the bottom-side sheet 61B, if the displacement is within 0.3 mm, the edge 61By of the bottom-side sheet 61B does not protrude from the top-side sheet 61A to become exposed.

When folding double the connection pieces 6131 to 6134 to produce the packaging container 61 in the box state as described above, the connection pieces 6131 to 6134 are desirably folded double while air or the like is blown in through the opening 61A11.

Next, in a state of being transformed into the box state as described above, the double-folded connection pieces 6131 to 6134 protrude on the outer surface of the packaging container 1. Therefore, the appearance of the packaging container 61 is desirably made neat by bending and overlaying the connection pieces 6131 to 6134 onto the respective side surfaces 6121 to 6124 of the packaging container 61. FIG. 43 shows the packaging container 61 in a state where the connection pieces 6131 to 6134 are bent and overlaid on the respective side surfaces 6121 to 6124 of the packaging container 1 as described above. The connection pieces 6131 to 6134 can be detachably fixed to the respective side surfaces 6121 to 6124 by means of an adhesive, an adhesive tape, or a joining member such as a hook and loop fastener and a snap button.

Next, to transform the packaging container 61 in the box state into the flat state, the container fixed portion 6140 may be held and pulled outward of the packaging container 61. By pulling the container fixed portion 6140 outward, the double-folded connection pieces 6131 to 6134 are unfolded, and the packaging container 61 is transformed into the flat state.

The packaging container 61 can be used as described below.

Specifically, first, desirably, the packaging container 61 is produced in the flat state, stored in this state, and transferred to a contents filling step. Then, in the contents filling step, the packaging container 61 is transformed into the box state, then contents are filled thereinto through the opening 61A11, and the opening 61A11 is closed, whereby a package containing the contents can be prepared.

The package in the box state containing the contents as described above can be returned to the flat state again after the contents are discharged. It is possible to repeatedly transform the package between the box state and the flat state as described above.

As the top-side sheet 61A or the bottom-side sheet 61B, for example, a laminated film having a thermoplastic resin layer or a sealant layer layered on a base material layer made of paper can be suitably used. In addition to this, a barrier layer, a functional film, or the like may be added as appropriate according to a required function. Moreover, the end surface of the end portion of the top-side sheet 61A or the bottom-side sheet 61B may be protected by a known method.

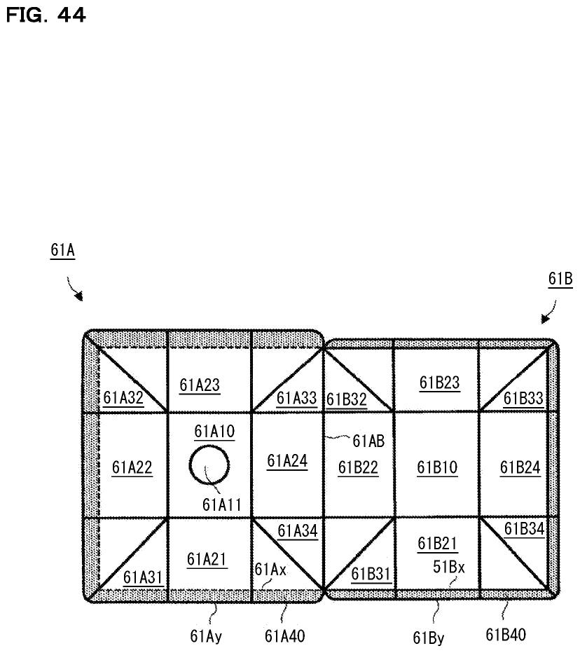

Next, a first modification of the packaging container 61 will be described with reference to FIG. 44. In the packaging container 61, both the top-side sheet 61A and the bottom-side sheet 61B are formed by one sheet, and the top-side sheet 61A and the bottom-side sheet 61B are partitioned by the bending ruled line 61AB, and the others are the same as the first example. Thus, the top-side fixing portion of the top-side sheet 61A is composed of the bending ruled line 61AB and a heat-seal region and configured to surround the entire periphery of the top-side sheet 61A with a combination of the bending ruled line 61AB and the heat-seal region. Similarly, the bottom-side fixing portion of the bottom-side sheet 61B is composed of the bending ruled line 61AB and a heat-seal region and configured to surround the entire periphery of the bottom-side sheet 61B with a combination of the bending ruled line 61AB and the heat-seal region. By bending at the bending ruled line 61AB, the top-side sheet 61A and the bottom-side sheet 61B can be overlaid on each other.

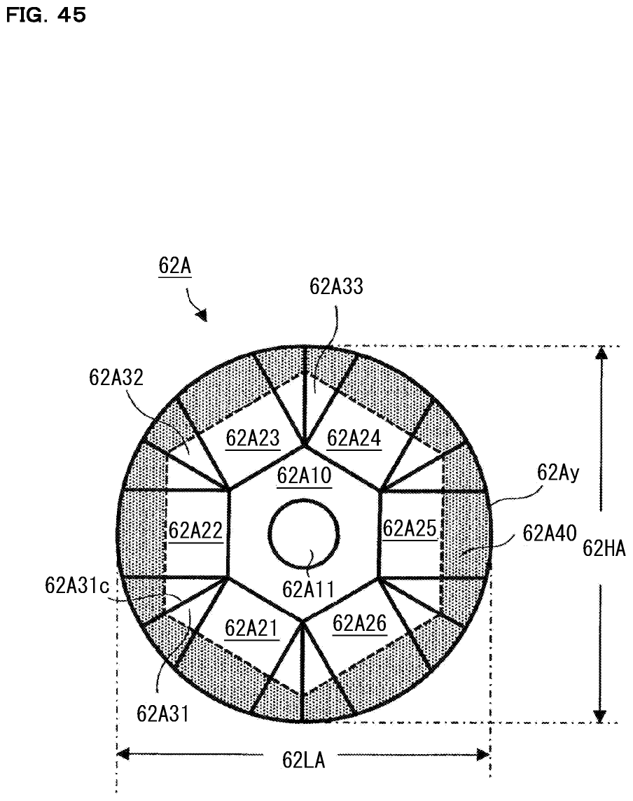

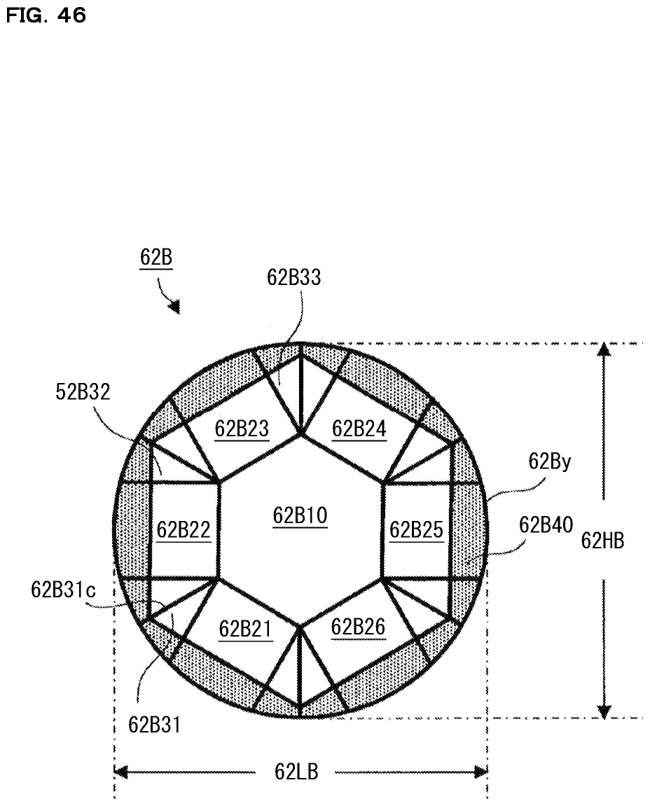

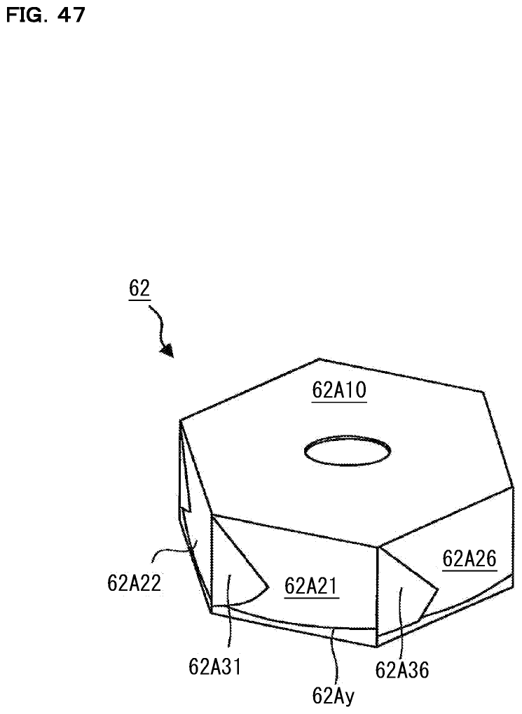

Next, a second modification will be described with reference to FIG. 45 to FIG. 47. In a packaging container 62 thereof, a top surface 62A10 of a top-side sheet 62A is formed in a regular hexagon shape, and a bottom surface 62B10 of a bottom-side sheet 62B is formed in a regular hexagon shape that is the same in shape and size as that of the top surface 62A10. In addition, each of the edge 62Ay of the top-side sheet 62A and the edge 62By of the bottom-side sheet 62B is circular, a length 62LA in the horizontal direction of the top-side sheet 62A is longer than a length 62LB in the horizontal direction of the bottom-side sheet 62B, and the difference therebetween is not less than 0.3 mm. Moreover, a length 62HA in the vertical direction of the top-side sheet 62A is also longer than a length 62HB in the vertical direction of the bottom-side sheet 62B, and the difference therebetween is also not less than 0.3 mm. Thus, the length of the top-side sheet 62A is longer than the length of the bottom-side sheet 62B in any direction by 0.3 mm or greater. Therefore, when the packaging container 62 is in any of the box state and the flat state, the edge 62By of the bottom-side sheet 62B is covered with the top-side sheet 62A and is not exposed. The packaging container 62 can also be repeatedly transformed between the box state and the flat state by the same method as in the first modification.

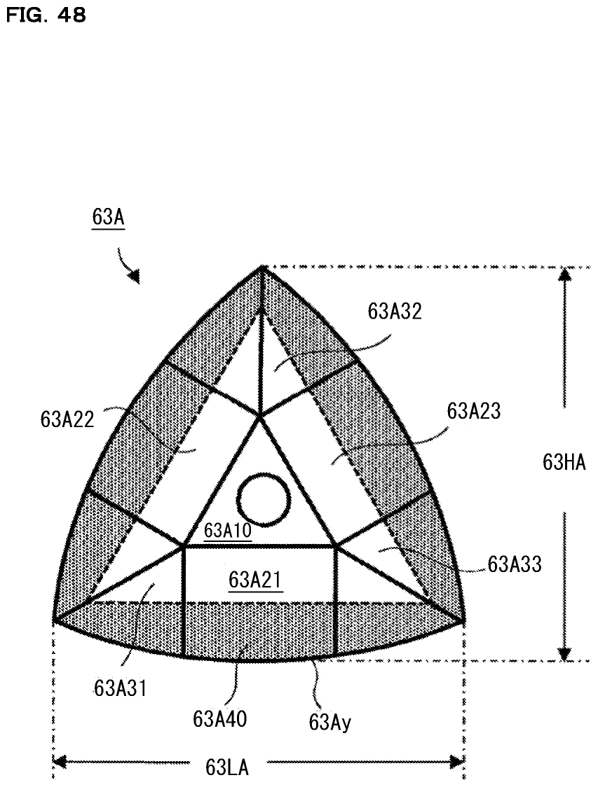

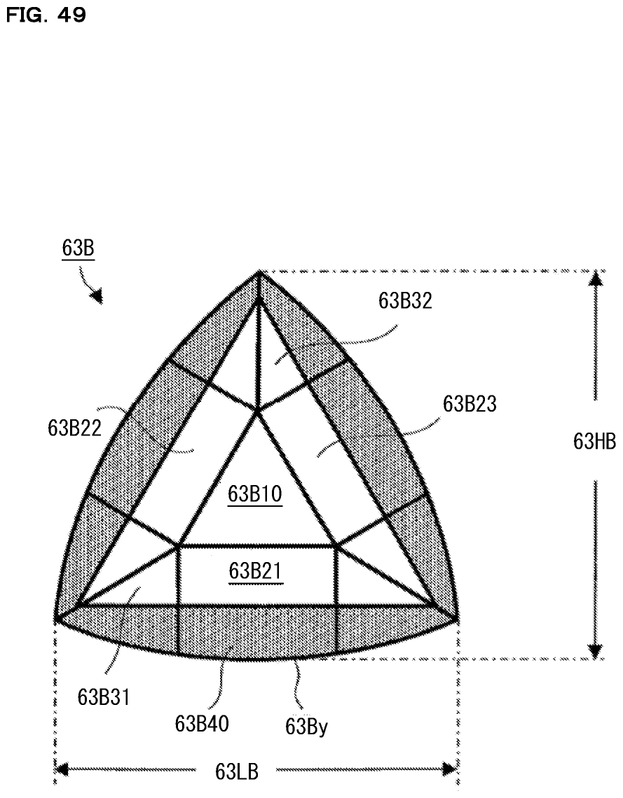

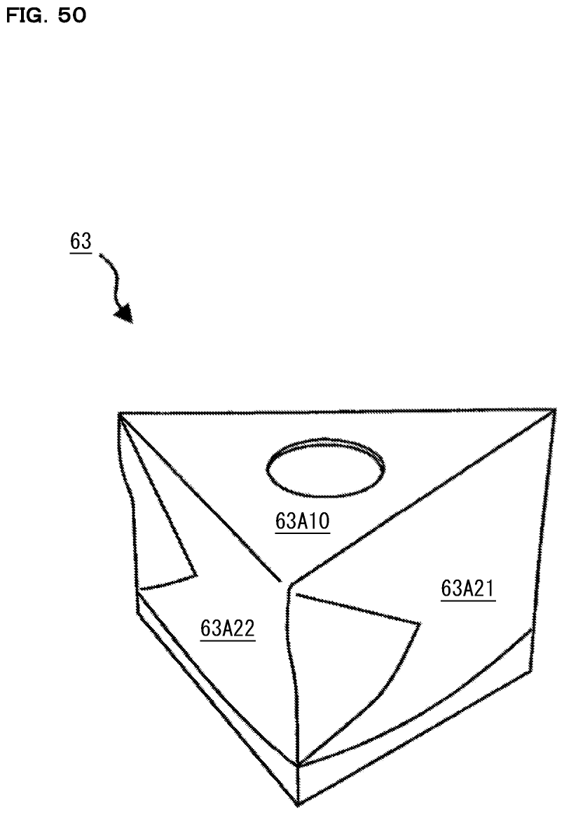

Next, a third modification will be described with reference to FIG. 48 to FIG. 50. In a packaging container 63 thereof, a top surface 63A10 of a top-side sheet 63A is formed in a regular triangle shape, and a bottom surface 63B10 of a bottom-side sheet 63B is formed in a regular triangle shape that is the same in shape and size as that of the top surface 63A10. In addition, each of the contour line 63Ay of the top-side sheet 63A and the edge 63By of the bottom-side sheet 63B is formed by connecting three circular arcs, a length 63LA in the horizontal direction of the top-side sheet 63A is longer than a length 63LB in the horizontal direction of the bottom-side sheet 63B, and the difference therebetween is not less than 0.3 mm. Therefore, the length of the top-side sheet 63A is longer than the length of the bottom-side sheet 63B in any direction by 0.3 mm or greater, and, when the packaging container 63 is in any of the box state and the flat state, the edge 63By of the bottom-side sheet 63B is covered with the top-side sheet 63A and is not exposed. The packaging container 63 can also be repeatedly transformed between the box state and the flat state by the same method as in the first modification and the second modification.

### EXAMPLES

### Example 6-1

The top-side sheet 61A and the bottom-side sheet 61B, which are substantially rectangular as shown in FIG. 40 and FIG. 41, were used. The length 61LA in the horizontal direction of the top-side sheet 61A is 180.0 mm, and the length 61HA in the vertical direction of the top-side sheet 61A is 200.0 mm. In addition, the length 61LB in the horizontal direction of the bottom-side sheet 61B is 179.4 mm, and the length 61HB in the vertical direction of the bottom-side sheet 61B is 199.4 mm. The top-side sheet 61A is longer than the bottom-side sheet 61B by 0.6 mm in any of the vertical direction and the horizontal direction. Thus, when both sheets 61A and 61B are accurately overlaid on each other without being positionally displaced relative to each other, the distance between the edge 61Ay of the top-side sheet 61A and the edge 61By of the bottom-side sheet 61B is 0.3 mm.

Then, the top-side sheet 61A and the bottom-side sheet 61B described above were overlaid on each other, and the fixing portions 61A40 and 61B40 at the peripheries were heat-sealed to each other, thereby producing a packaging container 61 in a flat state.

Subsequently, a packaging container 61 in a box state is produced by folding double all the connection pieces 6131 to 6134. Finally, the connection pieces 6131 to 6134 are bent and overlaid onto the respective side surfaces 6121 to 6124 of the packaging container 61.

A total of ten packaging containers 61 in a box state were produced in this manner. When the number of packaging containers 61 in which the edge 61By of the bottom-side sheet 61B protruded from the edge 61Ay of the top-side sheet 61A and was exposed on the outer surface was counted, the edge 61By of the bottom-side sheet 61B protruded from the edge 61Ay of the top-side sheet 61A and was exposed on the outer surface in two packaging containers 61 out of these ten packaging containers 61. In the other eight packaging containers 61, the edge 61By was covered with the top-side sheet 61A and was not exposed on the outer surface.

### Example 6-2

Packaging containers 61 in a box state were produced in the same manner as Example 6-1, except that the length 61LB in the horizontal direction of the bottom-side sheet 61B was 178.0 mm and the length 61HB in the vertical direction of the bottom-side sheet 61B was 198.0 mm. When the number of packaging containers 61 in which the edge 61By of the bottom-side sheet 61B protruded from the edge 61Ay of the top-side sheet 61A and was exposed on the outer surface was counted, the edge 61By was covered with the top-side sheet 61A and was not exposed on the outer surface in all (ten) of these ten packaging containers 61. When both sheets 61A and 61B are accurately overlaid on each other without being positionally displaced relative to each other, the distance between the edge 61Ay of the top-side sheet 61A and the edge 61By of the bottom-side sheet 61B is 0.5 mm.

### Example 6-3

Packaging containers 61 in a box state were produced in the same manner as Example 6-1, except that the length 61LB in the horizontal direction of the bottom-side sheet 61B was 174.0 mm and the length 61HB in the vertical direction of the bottom-side sheet 61B was 194.0 mm. When the number of packaging containers 61 in which the edge 61By of the bottom-side sheet 61B protruded from the edge 61Ay of the top-side sheet 61A and was exposed on the outer surface was counted, the edge 61By was covered with the top-side sheet 61A and was not exposed on the outer surface in all (ten) of these ten packaging containers 61. When both sheets 61A and 61B are accurately overlaid on each other without being positionally displaced relative to each other, the distance between the edge 61Ay of the top-side sheet 61A and the edge 61By of the bottom-side sheet 61B is 3.0 mm.

### Example 6-4

Packaging containers 61 in a box state were produced in the same manner as Example 6-1, except that the length 61LB in the horizontal direction of the bottom-side sheet 61B was 180.0 mm and the length 61HB in the vertical direction of the bottom-side sheet 61B was 200.0 mm. When the number of packaging containers 61 in which the edge 61By of the bottom-side sheet 61B protruded from the edge 61Ay of the top-side sheet 61A and was exposed on the outer surface was counted, the edge 61By of the bottom-side sheet 61B protruded from the edge 61Ay of the top-side sheet 61A and was exposed on the outer surface in all (ten) of these ten packaging containers 61. The bottom-side sheet 61B has the same shape and the same size as the top-side sheet 61A. When both sheets 61A and 61B are accurately overlaid on each other without being positionally displaced relative to each other, the distance between the edge 61Ay of the top-side sheet 61A and the edge 61By of the bottom-side sheet 61B is 0.0 mm.

As seen from the results, when the top-side sheet 61A and the bottom-side sheet 61B are overlaid on each other, a slight positional displacement easily occurs between both sheets 61A and 61B. Thus, when the top-side sheet 61A and the bottom-side sheet 61B having the same shape and the same size are used, the edge 61By of the bottom-side sheet 61B protrudes from the edge 61Ay of the top-side sheet 61A and becomes exposed on the outer surface almost without exception.

On the other hand, when a sheet smaller than the top-side sheet 61A is used as the bottom-side sheet 61B (Examples 6-1 to 6-3), even if a slight positional displacement occurs, the edge 61By of the bottom-side sheet 61B is covered with the top-side sheet 61A and does not become exposed on the outer surface. As a matter of course, if a positional displacement is great, the edge 61By of the bottom-side sheet 61B may protrude from the edge 61Ay of the top-side sheet 61A and become exposed on the outer surface (Example 6-1). Thus, the distance between the edge 61Ay of the top-side sheet 61A and the edge 61By of the bottom-side sheet 61B is desirably not less than 0.5 mm. In this case (Examples 6-2 and 6-3), without exception, the edge 61By of the bottom-side sheet 61B does not become exposed on the outer surface.

As described above, in the packaging container 61, one of the outer shape of the top-side sheet 61A and the outer shape of the bottom-side sheet 61B is larger than the other. Thus, when these sheets are overlaid on each other and fixed to each other over the entire peripheries thereof, the edge of the sheet having a smaller outer shape can be covered with the sheet having a larger outer shape. Since the edge of the sheet having a smaller outer shape does not become exposed on the outer surface of the packaging container 61 as described above, the packaging container 61 can have a neat appearance.

The packaging container 61 can be transformed between the box state and the flat state, and when the packaging container 61 is in any of these states, the edge of the sheet having a smaller outer shape is not exposed on the packaging container outer surface.

### Seventh Embodiment

Hereinafter, a packaging container 71 according to a seventh embodiment of the present invention in which the peeling strength of a container fixed portion is specified within a predetermined range will be described with the packaging container 61 as an example.

In the packaging container 71, a heat-seal region formed by heat-sealing the fixing portion 61A40 of the top-side sheet 61A and the fixing portion 61B40 of the bottom-side sheet 61B (corresponding to the side seal portions of the packaging containers 1100 and 2100), that is, the container fixed portion 6140, has a peeling strength not less than 9 N. When the peeling strength is not less than 9 N, even if the packaging container 71 is transformed from a flat state into a box state while a fluid such as air is blown thereinto as described later, no pinhole occurs in the container fixed portion 6140. On the other hand, when the peeling strength is less than 9 N, if the packaging container 71 is transformed from the flat state into the box state while the fluid such as air is blown thereinto, a pinhole may occur in the packaging container 71.

The peeling strength of the heat-seal region, that is, the container fixed portion 6140 is desirably not less than 20 N. When the peeling strength is not less than 20 N, no pinhole occurs in the packaging container 71 even if the packaging container 71 is returned to the flat state and then transformed into the box state again while the fluid such as air is blown thereinto after the packaging container 71 is transformed from the flat state into the box state while the fluid such as air is blown thereinto.

It is possible to adjust the peeling strength by adjusting heat-sealing conditions such as temperature, pressure, and time when heat-sealing both fixing portions 61A40 and 61B40.

Similar to the packaging container 61, when transforming the packaging container 71 from the flat state into the box state by folding double the connection pieces 6131 to 6134, the internal volume of the packaging container 71 rapidly increases, and thus the double folding is desirably carried out while a fluid such as air is pressurized and blown in through the opening 61A11. Other than air, an optional gas may be used. In addition, when contents to be contained are a liquid, the packaging container 71 can be transformed into the box state by folding double the connection pieces 6131 to 6134 while expanding the packaging container 71 by pressurizing the liquid contents and filling the liquid contents through the opening 11 into the packaging container 71. Even if a gas or a liquid is pressurized and blown in as described above, when the peeling strength of the container fixed portion 6140 is not less than 9 N, no pinhole occurs in the packaging container 71.

Moreover, when the packaging container 71 is repeatedly transformed between the box state and the flat state, the peeling strength of the container fixed portion 6140 is desirably not less than 20 N. When the peeling strength is not less than 20 N, no pinhole occurs in the packaging container 71 even if the packaging container 71 is returned to the flat state and then transformed into the box state again while the fluid such as air is blown thereinto after the packaging container 71 is transformed from the flat state into the box state while the fluid such as air is blown thereinto.

Furthermore, in the first modification of the packaging container 61 shown in FIG. 44, the container fixed portion 6140 is composed of the bending ruled line 61AB and the heat-seal region formed by heat-sealing the top-side sheet 61A and the bottom-side sheet 61B. Since no pinhole occurs at the position of the bending ruled line 61AB, when the peeling strength of the heat-seal region of the container fixed portion 6140 excluding the bending ruled line 61AB is not less than 9 N, no pinhole occurs in the packaging container 71 even if the packaging container 71 is transformed from the flat state into the box state while the fluid such as air is blown thereinto. In this case as well, the peeling strength is desirably not less than 20 N.

### EXAMPLES

### Example 7-1

The top-side sheet 61A and the bottom-side sheet 61B, which are substantially rectangular as shown in FIG. 40 and FIG. 41, were used. Each of the top-side sheet 61A and the bottom-side sheet 61B has a layer configuration including, from the packaging container outer surface side, a polyethylene resin layer (thickness 25 μm), paper (basis weight 250 g/mm²), a polyethylene resin layer (thickness 25 μm), aluminum foil (thickness 6 μm), a polyester film (thickness 12 μm), and a polyethylene resin layer (thickness 40 μm). In addition, as shown in FIG. 40 and FIG. 41, the top-side sheet 61A has, at two locations on the edge 61Ay thereof, alignment marks 61Ay1 and 61Ay2 formed by recesses that are recessed inward, and the bottom-side sheet 61B also has, at the positions, on the edge 61By, corresponding to the alignment marks 61Ay1 and 61Ay2, two alignment marks 61By1 and 61By2 formed by recesses that are recessed inward.

The length 61LA in the horizontal direction of the top-side sheet 61A is 180.0 mm, and the length 61HA in the vertical direction of the top-side sheet 61A is 200.0 mm. In addition, the length 61LB in the horizontal direction of the bottom-side sheet 61B is 177.0 mm, and the length 61HB in the vertical direction of the bottom-side sheet 61B is 197.0 mm. The top-side sheet 61A is longer than the bottom-side sheet 61B by 3.0 mm in any of the vertical direction and the horizontal direction. Thus, when both sheets 61A and 61B are accurately overlaid on each other without being positionally displaced relative to each other, the distance between the edge 61Ay of the top-side sheet 61A and the edge 61By of the bottom-side sheet 61B is 1.5 mm.

Then, the top-side sheet 61A and the bottom-side sheet 61B described above were overlaid and aligned with each other using the alignment marks 61Ay1, 61Ay2, 61By1, and 61By2, and then the fixing portions 61A40 and 61B40 at the peripheries were heat-sealed to each other, thereby producing a packaging container 71 in a flat state. When the peeling strength of the container fixed portion 6140 formed by heat-sealing was measured at five points on each side of the packaging container 71 (20 points on the packaging container 71), the average was 30 N. The peeling strength was measured according to “Heat seal strength test for bags” in JIS Z0238 “Testing methods for heat sealed flexible packages”.

Subsequently, a packaging container 71 in a box state is produced by folding double all the connection pieces 6131 to 6134 while pressurizing air and blowing the air thereinto. Finally, the connection pieces 6131 to 6134 are bent and overlaid onto the respective side surfaces 6121 to 6124 of the packaging container 71.

A total of ten packaging containers 71 in a box state were produced in this manner, and the number of packaging containers 71 in which any pinhole had occurred in the container fixed portion 6140 formed by heat-sealing was counted. The results are shown in Table 2 as the number of packaging containers 71 in which any pinhole had occurred in the box state for the first time.

Next, the container fixed portion 6140 of each packaging container 71 that had been brought into the box state as described above was pulled to return the packaging container 71 to the flat state, and then the packaging container 71 was transformed into the box state again by folding double all the connection pieces 6131 to 6134 while pressurizing air and blowing the air thereinto. After each packaging container 71 was brought into the box state again in this manner, the number of packaging containers 71 in which any pinhole had occurred in the container fixed portion 6140 was counted. The results are shown together in Table 2 as the number of packaging containers 71 in which any pinhole had occurred in the box state for the second time.

### Example 7-2

Packaging containers 71 in a box state were produced in the same manner as Example 7-1, except that the peeling strength of the container fixed portion 6140 formed by heat-sealing was 20 N as an average, and the number (for the first time) of packaging containers 71 in which any pinhole had occurred in the container fixed portion 6140 was counted. In addition, after returning each packaging container 71 to the flat state, the packaging container 71 was brought into the box state again, and the number (for the second time) of packaging containers 71 in which any pinhole had occurred in the container fixed portion 6140 was counted. The results are shown in Table 2.

### Example 7-3

Packaging containers 71 in a box state were produced in the same manner as Example 7-1, except that the peeling strength of the container fixed portion 6140 formed by heat-sealing was 15 N as an average, and the number (for the first time) of packaging containers 71 in which any pinhole had occurred in the container fixed portion 6140 was counted. In addition, after returning each packaging container 71 to the flat state, the packaging container 71 was brought into the box state again, and the number (for the second time) of packaging containers 71 in which any pinhole had occurred in the container fixed portion 6140 was counted. The results are shown in Table 2.

### Example 7-4

Packaging containers 71 in a box state were produced in the same manner as Example 7-1, except that the peeling strength of the container fixed portion 6140 formed by heat-sealing was 10 N as an average, and the number (for the first time) of packaging containers 71 in which any pinhole had occurred in the container fixed portion 6140 was counted. In addition, after returning each packaging container 71 to the flat state, the packaging container 71 was brought into the box state again, and the number (for the second time) of packaging containers 71 in which any pinhole had occurred in the container fixed portion 6140 was counted. The results are shown in Table 2.

### Example 7-5

Packaging containers 71 in a box state were produced in the same manner as Example 7-1, except that the peeling strength of the container fixed portion 6140 formed by heat-sealing was 9 N as an average, and the number (for the first time) of packaging containers 71 in which any pinhole had occurred in the container fixed portion 6140 was counted. In addition, after returning each packaging container 71 to the flat state, the packaging container 71 was brought into the box state again, and the number (for the second time) of packaging containers 71 in which any pinhole had occurred in the container fixed portion 6140 was counted. The results are shown in Table 2.

### Example 7-6

Packaging containers 61 in a box state were produced in the same manner as Example 7-1, except that the peeling strength of the container fixed portion 6140 formed by heat-sealing was 8 N as an average, and the number (for the first time) of packaging containers 61 in which any pinhole had occurred in the container fixed portion 6140 was counted. In addition, after returning each packaging container 71 to the flat state, the packaging container 71 was brought into the box state again, and the number (for the second time) of packaging containers 71 in which any pinhole had occurred in the container fixed portion 6140 was counted. The results are shown in Table 2.

### Example 7-7

A laminated sheet having a layer configuration including, from the packaging container outer surface side, a polyethylene resin layer (thickness 25 μm), paper (basis weight 250 g/mm²), and a polyethylene resin layer (thickness 40 μm) was used as each of the top-side sheet 61A and the bottom-side sheet 61B. Then, packaging containers 71 in a box state were produced in the same manner as Example 7-1, except that the peeling strength of the container fixed portion 6140 formed by heat-sealing was 8 N as an average, and the number (for the first time) of packaging containers 71 in which any pinhole had occurred in the container fixed portion 6140 was counted. In addition, after returning each packaging container 71 to the flat state, the packaging container 71 was brought into the box state again, and the number (for the second time) of packaging containers 71 in which any pinhole had occurred in the container fixed portion 6140 was counted. The results are shown in Table 2.

TABLE 2

| | Number of | |
|---|---|---|
| | occurrences | |
| | of pinhole | |
| | First | Second |
| | time | time |
| Example 7-1 | 0/10 | 0/10 |
| Example 7-2 | 0/10 | 0/10 |
| Example 7-3 | 0/10 | 1/10 |
| Example 7-4 | 0/10 | 3/10 |
| Example 7-5 | 0/10 | 4/10 |
| Example 7-6 | 3/10 | 8/10 |
| Example 7-7 | 4/10 | 10/10 |

As seen from comparison between Examples 7-1 to 7-5 and Examples 7-6 and 7-7, when the peeling strength of the container fixed portion 6140 formed by heat-sealing is not less than 9 N, even if the packaging container is transformed from the flat state into the box state while air is pressurized and blown thereinto, no pinhole occurs in the container fixed portion 6140. On the other hand, when the peeling strength is less than 9 N, any pinhole may occur if this transformation is repeated, so that stable transformation is not possible.

Moreover, when Example 7-6 and Example 7-7 are compared to each other, it can be understood that the results do not depend on the materials of the top-side sheet 61A and the bottom-side sheet 61B.

As a result of comparison between Examples 7-1 and 7-2 and Examples 7-3 to 7-5, it is found that when the peeling strength is not less than 20 N, no pinhole occurs even if transformation between the box state and the flat state is repeated.

As described above, the method for transforming the packaging container of the present invention is not limited, but the packaging container can be transformed by blowing the fluid such as air into the packaging container to expand the packaging container. When the peeling strength of the heat-seal region formed by heat-sealing the top-side sheet 61A and the bottom-side sheet 61B is not less than 9 N (Examples 7-1 to 7-5), no pinhole occurs in the packaging container even if the packaging container is transformed from the flat state into the box state while the fluid such as air is blown thereinto.

When the peeling strength of the heat-seal region is not less than 20 N (Examples 7-1 and 7-2), no pinhole occurs in the packaging container even if the packaging container is returned to the flat state and then transformed into the box state again while the fluid such as air is blown thereinto after the packaging container is transformed from the flat state into the box state while the fluid such as air is blown thereinto.

<Production Method for Packaging Container>

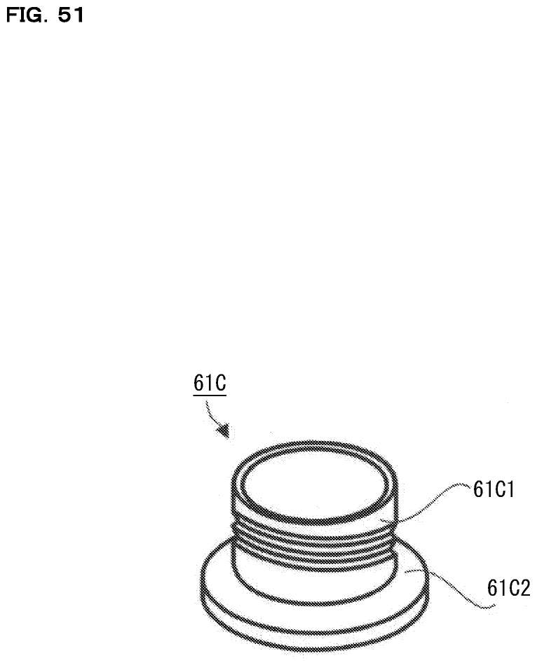

Hereinafter, an example of the production methods for the packaging containers described above with reference to the drawings will be described with the packaging container 61 as an example. In the production method described below, at least three components, that is, the top-side sheet 61A (corresponding to the first portions of the packaging containers 1100 and 2100), the bottom-side sheet 61B (corresponding to the second portions of the packaging containers 1100 and 2100), and a spout 61C, are used. FIG. 51 is a perspective view of the spout 61C.

Although the top-side sheet 61A can be formed from an optional material, the top-side sheet 61A desirably has a heat-sealable resin layer at a surface (interior surface) thereof that is to be at the inner surface side of the packaging container 61. The heat-sealable resin layer at the interior surface performs two functions. Specifically, first, the heat-sealable resin layer serves to be welded with a later-described flange portion 61C2 of the spout 61C to fix the flange portion 61C2. Second, the heat-sealable resin layer serves to heat-seal the top-side fixing portion 61A40 of the top-side sheet 61A and the bottom-side fixing portion 61B40 of the bottom-side sheet 61B to each other to form the fixed portion 6140 of the packaging container 61. As the heat-sealable resin, polyolefin resins such as a polyethylene resin and a polypropylene resin can be adopted.

For example, as the top-side sheet 61A, a laminated film having a thermoplastic resin layer or a heat-sealable resin layer layered on a base material layer made of paper can be suitably used. In addition to this, a barrier layer, a functional film, or the like may be added as appropriate according to a required function. The top-side sheet 61A is, for example, a sheet in which a polyethylene resin layer is layered on the outer surface side of paper, a polyethylene resin layer, aluminum foil, a polyester resin film, and a polyethylene resin layer are sequentially layered on the inner surface side of the paper, and the interior surface is formed by the polyethylene resin layer. The end surface of the end portion of the top-side sheet 61A may be protected by a known method.

Although the bottom-side sheet 61B can also be formed from an optional material, the bottom-side sheet 61B desirably has a heat-sealable resin layer at a surface (interior surface) thereof that is to be at the inner surface side of the packaging container 61. The heat-sealable resin layer at the interior surface has a roll in heat-sealing the top-side fixing portion 61A40 of the top-side sheet 61A and the bottom-side fixing portion 61B40 of the bottom-side sheet 61B to each other to form the fixed portion 6140 of the packaging container 61.

For example, as the bottom-side sheet 61B, similar to the top-side sheet 61A, a laminated film having a thermoplastic resin layer or a heat-sealable resin layer layered on a base material layer made of paper can be suitably used. In addition to this, a barrier layer, a functional film, or the like may be added as appropriate according to a required function. In addition, the end surface of the end portion of the bottom-side sheet 61B may also be protected by a known method.

(Spout 61C)

The spout 61C is configured to include a tubular trunk portion 61C1 and the flange portion 61C2.

The tubular trunk portion 61C1 is inserted into the opening 61A11 of the top-side sheet 61A, and a flow passage is provided at the center thereof so as to penetrate in the up-down direction. Contents can be filled through the flow passage into the packaging container 61, or contents within the packaging container 61 can be discharged through the flow passage.

Moreover, the flange portion 61C2 projects outward from an end portion of the tubular trunk portion 61C1, and the spout 61C can be fixed to the top-side sheet 61A by welding the flange portion 61C2 to the periphery of the opening 61A11 of the top-side sheet 61A.

This production method includes a spout-equipped top-side sheet production step, and a fixing step.

(Spout-Equipped Top-Side Sheet Production Step)

The spout-equipped top-side sheet production step is a step of producing a spout-equipped top-side sheet by mounting the spout 61C to the opening 61A11 of the top-side sheet 61A.

After the top-side sheet 61A is produced, the spout 61C may be mounted thereto. However, a spout-equipped top-side sheet can also be produced by the following method.

Specifically, first, a spout-equipped top-side sheet can be produced by providing the opening 61A11 at a predetermined position in a sheet paper-like or rolled sheet for forming the top-side sheet 61A, mounting the spout 61C to the opening 61A11, and then stamping the sheet. In addition, each bending ruled line can be formed in an optional step. For example, each bending ruled line can be formed simultaneously when the opening 61A11 is provided in the sheet paper-like or rolled sheet, or each bending ruled line can be formed after the spout 61C is mounted, and then the sheet can be stamped to produce the top-side sheet 61A equipped with the spout 61C. Alternatively, each bending ruled line may be formed simultaneously when the sheet is stamped to produce the top-side sheet 61A equipped with the spout 61C. Still alternatively, each bending ruled line may be formed between the step of mounting the spout 61C and the step of stamping the sheet, or each bending ruled line may be formed after the sheet is stamped.

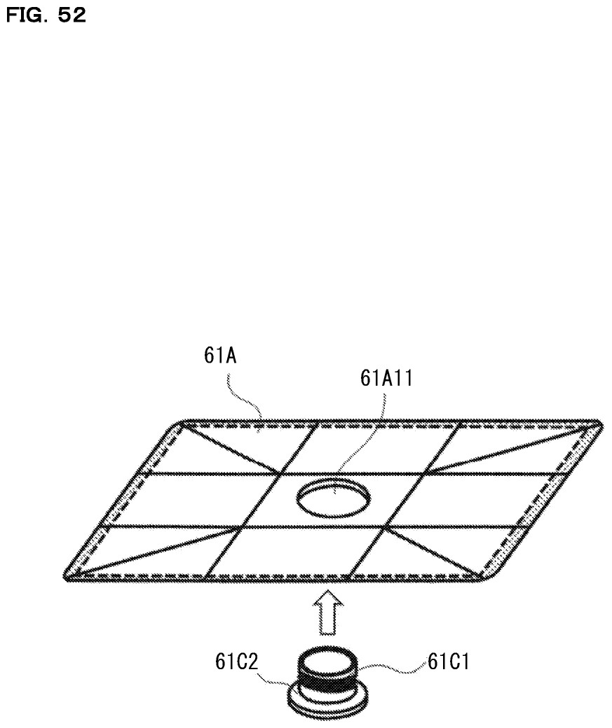

As an example, describing the case of mounting the spout 61C after the top-side sheet 61A is produced, this step can be carried out by inserting the tubular trunk portion 61C1 of the spout 61C from the surface (interior surface) side that is to be the inner surface side of the packaging container 61, of both surfaces of the top-side sheet 61A, as shown in FIG. 52, and welding the flange portion 61C2 to the opening 61A11. The top-side sheet 61A and the tubular trunk portion 61C1 can be welded to each other by hot-pressing either one of or both the top-side sheet 61A and the tubular trunk portion 61C1, or can be ultrasonically welded to each other.

(Fixing Step)

The fixing step is a step of fixing the top-side fixing portion 61A40 of the top-side sheet 61A and the bottom-side fixing portion 61B40 of the bottom-side sheet 61B to each other. This step needs to be carried out after the spout-equipped top-side sheet production step. That is, the top-side sheet 61A to be used in this step is equipped with the spout 61C.

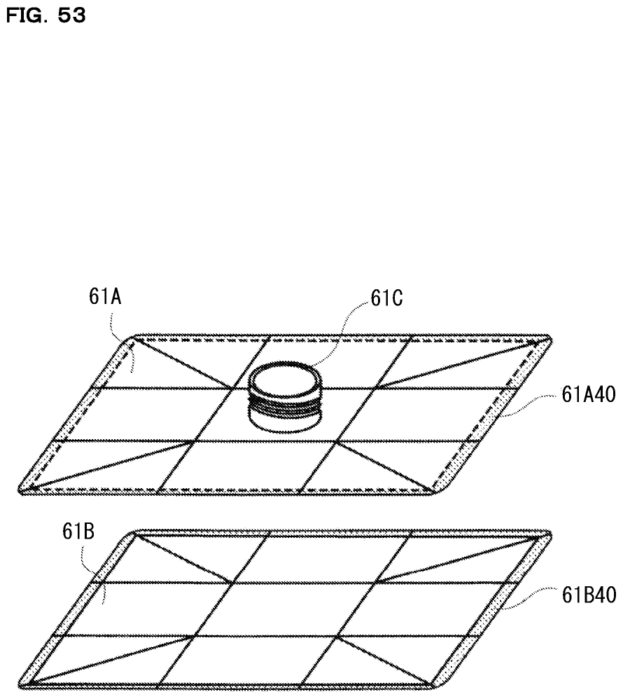

The fixing step can be carried out by aligning and overlaying the top-side sheet 61A and the bottom-side sheet 61B on each other as shown in FIG. 53 and heat-sealing both fixing portions 61A40 and 61B40 to each other. The top-side sheet 61A and the bottom-side sheet 61B can be welded to each other by hot-pressing either one of or both the top-side sheet 61A and the bottom-side sheet 61B, or can be heat-sealed by ultrasonic irradiation. Both fixing portions 61A40 and 61B40 do not need to be heat-sealed over the entire width thereof, but need to be heat-sealed such that both sheets 61A and 61B can be fixed to each other over the entire periphery. The peeling strength of the fixing portions 61A40 and 61B40 is desirably not less than 9 N.

As a result of this step, the packaging container 61 in a flat state can be produced. A plan view of the packaging container 61 is the same as a plan view (FIG. 40) of the top-side sheet 61A.

In this production method, after the spout 61C is mounted to the opening 61A11 of the top-side sheet 61A, the top-side sheet 61A and the bottom-side sheet 61B are fixed to each other. Thus, the formed packaging container 61 can be transformed between the box state and the flat state, and it is possible to produce the packaging container 61 equipped with the spout 61C.

The present invention can be suitably used for a packaging container to be filled with a liquid.

1-21. (canceled)

22. A packaging container transformable between a box state and a flat state, the packaging container comprising:
a rectangular first sheet material having an opening formed therein and a rectangular second sheet material, wherein
the first sheet material and the second sheet material are sealed to each other at a portion along an outer peripheral edge of the second sheet material, and
in the box state,
the packaging container has an upper surface including the opening, a lower surface opposing the upper surface, and four side surfaces, and
peripheral portions including seal portions of the first sheet material and the second sheet material are overlaid along the side surfaces of the packaging container.

23. The packaging container according to claim 22, wherein
each of the first sheet material and the second sheet material has a projection polygonal surface having a projection polygonal shape, side portion polygonal surfaces extending from respective sides of the projection polygonal surface, a plurality of to-be-folded surfaces provided between the respective adjacent side portion polygonal surfaces, and the peripheral portions extending over an entirety of an outer edge,
the first sheet material and the second sheet material are connected to each other at the peripheral portions by the seal portions obtained by sealing the peripheral portions to each other and have air-tightness except for the opening,
in the flat state,
by bending the sheet material at the peripheral portions, a cavity is formed between the first sheet material and the second sheet material, and the upper surface that is the projection polygonal surface of the first sheet material including the opening, the lower surface that is the projection polygonal surface of the second sheet material and that opposes the upper surface, the four side surfaces formed by the side portion polygonal surfaces, and folded pieces obtained by folding the to-be-folded surfaces and the peripheral portions are formed, and
the respective folded pieces are overlaid on and along the side surfaces, whereby the packaging container can be transformed into the box state, and
in the box state,
the folded pieces are separated from the side surfaces,
the cavity between the first sheet material and the second sheet material is eliminated by unfolding the sheet material at the peripheral portions, and
the first sheet material and the second sheet material are overlaid on each other, whereby the packaging container can be transformed into the flat state.

24. The packaging container according to claim 23, wherein
each of the side portion polygonal surfaces is an isosceles trapezoidal surface having an isosceles trapezoidal shape,
each of the plurality of to-be-folded surfaces and the peripheral portions includes a folding ruled line that extends from a vertex of the projection polygonal surface toward the peripheral portion so as to bisect an angle formed by a first lateral side and a second lateral side shared by the to-be-folded surface and the isosceles trapezoidal surface adjacent to the to-be-folded surface,
each of lengths of the folding ruled lines is shorter in the flat state than a line that is obtained by axis-symmetrically reversing the folding ruled line about, as an axis side, a lateral side adjacent thereto in a predetermined direction of the first lateral side and the second lateral side and that is extended until intersecting a straight line including an opposite side, opposite to the axis side, of the isosceles trapezoidal surface adjacent thereto in the predetermined direction, and
when the packaging container is transformed into the box state, an end of the folded piece does not protrude from the opposite side.

25. The packaging container according to claim 22, wherein at least a part of a portion of the first sheet material or the second sheet material that is the side surface in the box state, and a portion to be overlaid thereon have joining members that are attachable to/detachable from each other.

26. The packaging container according to claim 22, wherein an end surface of the sheet material is not present within a height of 3 mm from the lower surface in the box state.

27. The packaging container according to claim 26, wherein the opening is closed by a pump dispenser.

28. The packaging container according to claim 26, wherein the sheet material includes a barrier layer that prevents permeation of water vapor and oxygen.

29. The packaging container according to claim 26, wherein the end surface of the sheet material has a portion inclined relative to the lower surface.

30. The packaging container according to claim 29, wherein an entirety of the end surface of the sheet material is inclined relative to the lower surface.

31. The packaging container according to claim 22, wherein
two or more alignment marks are provided at each of the edge of the first sheet material and the edge of the second sheet material, and the alignment marks of the first sheet material and the alignment marks of the second sheet material are located at positions corresponding to each other, and
each of the alignment marks of the first sheet material and the alignment marks of the second sheet material is formed by a recess that is recessed from the edge of the first sheet material or the second sheet material, or by a projection that projects from the edge of the first sheet material or the second sheet material, and has a depth or a height of 0.5 mm or greater.

32. The packaging container according to claim 31, wherein the depth of the recess or the height of the projection is not less than 1.0 mm.

33. The packaging container according to claim 22, wherein one of an outer shape of the first sheet material and an outer shape of the second sheet material is larger than the other thereof.

34. The packaging container according to claim 33, wherein a difference between the outer shape of the first sheet material and the outer shape of the second sheet material is not less than 0.6 mm.

35. The packaging container according to claim 22, wherein a peeling strength of the side seal portion is not less than 9 N.

36. The packaging container according to claim 35, wherein the peeling strength of the side seal portion is not less than 20 N.

37. A filling method of contents for the packaging container according to claim 22, the method comprising:
when the packaging container is in the flat state,
a step of pulling the first sheet material and the second sheet material apart from each other to form a cavity between the first sheet material and the second sheet material;
a step of overlaying the side seal portion on and along the side surface;
a step of filling the contents into the cavity through the opening; and
a step of closing the opening.

38. The filling method of the contents for the packaging container according to claim 37, wherein
a spout is attached to the opening of the packaging container, and
in the step of closing the opening, the opening is closed by a cap attachable to the spout or a pump dispenser.

39. A manufacturing method for a packaging container including the packaging container according to claim 22 and a spout attached to the opening of the packaging container, the method comprising:
a spout-equipped first sheet material production step of producing a first sheet material equipped with the spout in which the spout is mounted on the opening of the first sheet material; and
a fixing step of fixing the edge of the first sheet material equipped with the spout and the edge of the second sheet material of the packaging container to each other.

40. The manufacturing method according to claim 39, wherein, in the spout-equipped first sheet material production step, after the first sheet material is formed using a sheet material, the spout is mounted to the formed first sheet material to form the first sheet material equipped with the spout.

41. The manufacturing method according to claim 39, wherein, in the spout-equipped first sheet material production step, after the spout is mounted to a sheet material provided with the opening, the sheet material is stamped to form the first sheet material equipped with the spout.

42. The manufacturing method according to claim 39, wherein
the spout has a tubular trunk portion and a flange portion that projects outward from an end portion of the tubular trunk portion, and
in the spout-equipped first sheet material production step, the flange portion of the spout is welded to an inner surface side of the packaging container.
